(19) United States
(12) Patent Application Publication
(10) Pub. No.: US 2022/0110181 A1
(43) Pub. Date: Apr. 7, 2022

(54) APPARATUS AND METHOD FOR ENHANCED BEAM RECOVERY

(71) Applicant: Apple Inc., Cupertino, CA (US)

(72) Inventor: Honglei MIAO, Munich (DE)

(73) Assignee: Apple Inc., Cupertino, CA (US)

(21) Appl. No.: 17/429,870

(22) PCT Filed: Feb. 11, 2020
(86) PCT No.: PCT/US2020/017779

§ 371 Date: Aug. 10, 2021

Related U.S. Application Data
(60) Provisional application No. 62/804,000, filed on Feb. 11, 2019.

(51) Int. Cl. H04W 76/19; H04B 7/06; H04B 7/08; H04L 1/18

(52) U.S. Cl. CPC H04W 76/19; H04L 1/1812; H04B 7/088; H04B 7/0695

(57) ABSTRACT

Some embodiments of this disclosure include systems, apparatuses, methods, and computer-readable media for use in a wireless network for facilitating beam failure recovery procedure. Some embodiments are directed to a method, the method including detecting a beam failure instance. The method further including initiating a beam failure recovery procedure by dynamically activating or deactivating candidate beams per uplink bandwidth part (BWP) associated with a user equipment (UE). Moreover, the method further includes generating a control signal to identify the one or more activated or deactivated candidate beams for at least one BWP associated with the UE. The method also includes transmitting the control signal to the UE.

### CROSS REFERENCE TO RELATED APPLICATIONS

This application claims the benefit under 35 U.S.C. § 119(e) of U.S. Provisional Application No. 62/804,000, filed Feb. 11, 2019, which is hereby incorporated by reference in its entirety.

### FIELD

Various embodiments generally may relate to the field of wireless communications.

### SUMMARY

Some embodiments of this disclosure include systems, apparatuses, methods, and computer-readable media for use in a wireless network for configuring the operations of base station (BS) and a user equipment (UE).

Some embodiments are directed to a method, the method including detecting a beam failure instance. The method further including initiating a beam failure recovery procedure by activating or deactivating candidate beams for at least one uplink bandwidth part (BWP) associated with a user equipment (UE). Moreover, the method further includes generating a control signal to identify the one or more activated or deactivated candidate beams for the at least one BWP associated with the UE. The method also includes transmitting the control signal to the UE.

Some embodiments are directed to an apparatus (e.g. a network apparatus, a base station, eNB, etc.) including radio front end circuitry and processor circuitry coupled to the radio front end circuitry and configured to detect a beam failure instance. The processor circuitry may be further configured to initiate a beam failure recovery procedure by activating or deactivating candidate beams for at least one uplink bandwidth part (BWP) associated with a user equipment (UE). According to some embodiments, the processor circuitry may be further configured to generate a control signal to identify the one or more activated or deactivated candidate beams for the at least one BWP associated with the UE. The processor circuitry may be further configured to transmit the control signal to the UE using the radio front end circuitry.

Some embodiments are directed to a non-transitory computer-readable medium comprising instructions to cause an apparatus, upon execution of the instructions by one or more processors of the apparatus, to perform one or more operations, the operations including detecting a beam failure instance. The operations further including initiating a beam failure recovery procedure by activating or deactivating candidate beams for at least one uplink bandwidth part (BWP) associated with a user equipment (UE). According to some embodiments, the operations further include generating a control signal to identify the one or more activated or deactivated candidate beams for the at least one BWP associated with the UE. Moreover, the operations further include transmitting the control signal to the UE.

In embodiments, the control signal can be one of a media access (MAC) control element (CE) or a physical random access channel (PRACH) information element (IE).

In embodiments, when the control signal is a MAC CE, the one or more activated or deactivated candidate beams can be identified in a media access control (MAC) protocol data unit (PDU) subheader with a new logical channel ID (LCID) in the MAC CE.

In embodiments, when the control signal is a PRACH IE, a subset of cell-specific candidate beams can be identified in the PRACH IE by including indices associated with the subset of candidate beams in a cell-specific uplink configuration message.

### BRIEF DESCRIPTION OF THE DRAWINGS/FIGURES

FIG. 1 illustrates a MAC CE activation/deactivation of candidate beams for BFR, according to some embodiments;

FIG. 2 illustrates a measurement model, according to some embodiments;

FIG. 3 depicts an architecture of a system of a network, in accordance with some embodiments;

FIG. 4 depicts an architecture of a system including a first core network, in accordance with some embodiments;

FIG. 5 depicts an architecture of a system including a second core network in accordance with some embodiments;

FIG. 6 depicts an example of infrastructure equipment, in accordance with various embodiments;

FIG. 7 depicts example components of a computer platform, in accordance with various embodiments;

FIG. 8 depicts example components of baseband circuitry and radio frequency circuitry, in accordance with various embodiments;

FIG. 9 is an illustration of various protocol functions that may be used for various protocol stacks, in accordance with various embodiments;

FIG. 10 illustrates components of a core network, in accordance with various embodiments;

FIG. 11 illustrates a flow diagram of a beam failure recovery method, according to some embodiments; and

FIG. 12 illustrates a flow diagram of a beam failure recovery method, according to some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

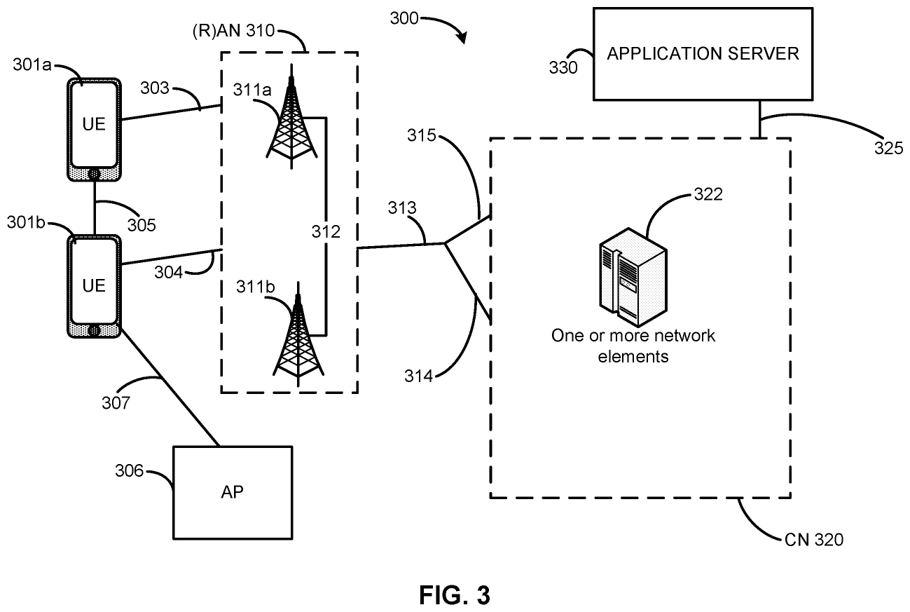

Beam failure recovery (BFR) was specified in new radio (NR) Release-15. The main concept was that a UE (e.g., UE 301 of FIG. 3 infra) detects that the beams at the next generation Node B (gNB) (e.g., a RAN node 311 of FIG. 3) and/or the UE have been misaligned, and consequently the network (NW) may not be able to reach the UE. In this situation, the UE searches for a new reference signal (RS) among candidate beams configured by RRC for BFR procedure, which fulfils a certain criterion (e.g., requiring the RSRP of new beam is above the signalled RSRP threshold). If such an RS is found, the UE uses that RS as a quasi-collocated (QCLed) RS to perform contention-free (via random access preamble associated with the selected beam reference signal) or contention-based random access to the cell. The NW then proceeds to re-configure the transmission configuration indication (TCI) states of control channel resource sets (CORESET) by transmitting a corresponding MAC CE scheduled by control channel in the configured beam failure recovery search space to the UE so that beam failure recovery is completed. This procedure is also known as link recovery.

Although link failure recovery is much faster than the RRC re-establishment that follows radio link failure, the procedure may not be extremely fast when a UE moves out of coverage, it will take ˜150 ms before the UE has completed a successful link recovery. Note that a number of candidate beams are configured by RRC signaling for beam failure recovery. Since the set of candidate beams can only be (re)configured by RRC signaling, if all the candidate beams are not able to provide sufficiently good link quality, the UE needs to perform the normal contention based random access followed by RRC reestablishment procedure. This would naturally be a time consuming procedure. In order to achieve a fast link recovery, it would be beneficial for gNB to be able to more dynamically update the set of candidate beams to always incorporate those strong beams in the candidate set.

The present disclosure provides embodiments to enable gNB to dynamically reconfigure the candidate beam set so that whenever beam failure is detected, the UE can find a candidate beam through which the fast link recovery can be accomplished. A first embodiment (Embodiment-1) involves RRC signaling candidate beam set for BFR per serving cell. In this embodiment, a physical random access channel (PRACH) resource configuration for BFR, defined as PRACH-ResourceConfigBFR, can be configured on serving cell basis. For each uplink BWP, the subset of cell-specific candidate beams can be configured for BFR by including the indices of candidate beam from the set of candidate beams in cell-specific UplinkConfig. A second embodiment (Embodiment-2) involves MAC CE activation/deactivation of candidate beams for BFR per uplink BWP. In this embodiment, MAC CE is proposed to dynamically activate/deactivate the candidate beams for BFR per uplink BWP. According to some embodiments, the network can activate/deactivate the candidate beams for BFR of a UE in a particular BWP by sending the proposed MAC CE to the UE. The embodiments herein enable dynamic activation/deactivation of BFR candidate beams to UE on BWP basis. Moreover, the cell-specific BFR PRACH resource configuration can further reduce the signaling overhead.

### Embodiment-1: RRC Signaling Candidate Beam Set for BFR Per Serving Cell

The BeamFailureRecoveryConfig IE is used to configure the UE with RACH resources and candidate beams for beam failure recovery in case of beam failure detection. Table 1 shows an example BeamFailureRecoveryConfig IE and table 2 shows field descriptions for the BeamFailureRecoveryConfig.

TABLE 1
BeamFailureRecoveryConfig information element

-- ASN1START
-- TAG-BEAM-FAILURE-RECOVERY-CONFIG-START

| | |
|---|---|
| BeamFailureRecoveryConfig ::= | SEQUENCE { |

| | |
|---|---|
| rootSequenceIndex-BFR | INTEGER (0..137) |

| | |
|---|---|
| OPTIONAL, | -- Need M |

| | |
|---|---|
| rach-ConfigBFR | RACH-ConfigGeneric |

| | |
|---|---|
| OPTIONAL, | -- Need M |

| | |
|---|---|
| rsrp-ThresholdSSB | RSRP-Range |

| | |
|---|---|
| OPTIONAL, | -- Need M |

| | |
|---|---|
| candidateBeamRSList | SEQUENCE (SIZE(1..maxNrofCandidateBeams)) OF PRACH- |

| | |
|---|---|
| ResourceDedicatedBFR | OPTIONAL, -- Need M |

| | |
|---|---|
| ssb-perRACH-Occasion | ENUMERATED {oneEighth, oneFourth, oneHalf, one, two, |

four, eight, sixteen} OPTIONAL, -- Need M

| | |
|---|---|
| ra-ssb-OccasionMaskIndex | INTEGER (0..15) |

| | |
|---|---|
| OPTIONAL, | -- Need M |

| | |
|---|---|
| recoverySearchSpaceId | SearchspaceId |

| | |
|---|---|
| OPTIONAL, | -- Cond CF-BFR |

| | |
|---|---|
| ra-Prioritization | RA-Prioritization |

| | |
|---|---|
| OPTIONAL, | -- Need R |

| | |
|---|---|
| beamFailureRecoveryTimer | ENUMERATED {ms10, ms20, ms40, ms60, ms80, ms100, ms150, |

| | |
|---|---|
| ms200} | OPTIONAL, -- Need M |

| ..., | |
|---|---|
| [[ | |
| msg1-Subcarrierspacing-v1530 | Subcarrierspacing |

| | |
|---|---|
| OPTIONAL | -- Need M |

]]

}

| | |
|---|---|
| PRACH-ResourceDedicatedBFR ::= | CHOICE { |

| | |
|---|---|
| ssb | BFR-SSB-Resource, |
| csi-RS | BFR-CSIRS-Resource |

}

| | |
|---|---|
| BFR-SSB-Resource ::= | SEQUENCE { |

| | |
|---|---|
| ssb | SSB-Index, |
| ra-PreambleIndex | INTEGER (0..63), |

...

}

| | |
|---|---|
| BFR-CSIRS-Resource ::= | SEQUENCE { |

| | |
|---|---|
| csi-RS | NZP-CSI-RS-ResourceId, |
| ra-OccasionList | SEQUENCE (SIZE(1..maxRA-OccasionsPerCSIRS)) OF INTEGER |

| | |
|---|---|
| (0..maxRA-Occasions-1) | OPTIONAL, -- Need R |

| | |
|---|---|
| ra-PreambleIndex | INTEGER (0..63) |

| | |
|---|---|
| OPTIONAL, | -- Need R |

...

}
-- TAG-BEAM-FAILURE-RECOVERY-CONFIG-STOP
-- ASN1STOP

TABLE 2
BeamFailureRecoveryConfig field descriptions

beamFailureRecoveryTimer
Timer for beam failure recovery timer. Upon expiration of the timer the UE does not use CFRA
for BFR. Value in ms. ms10 corresponds to 10 ms, ms20 to 20 ms, and so on.
candidateBeamRSList
A list of reference signals (CSI-RS and/or SSB) identifying the candidate beams for recovery
and the associated RA parameters. The network configures these reference signals to be within
the linked DL BWP (i.e., within the DL BWP with the same bwp-Id) of the UL BWP in which
the BeamFailureRecoveryConfig is provided.
msg1-SubcarrierSpacing
Subcarrier spacing for contention free beam failure recovery. Only the values 15 or 30 kHz
(<6 GHz), 60 or 120 kHz (>6 GHz) are applicable. See TS 38.211 [16], clause 5.3.2.
rsrp-ThresholdSSB
L1-RSRP threshold used for determining whether a candidate beam may be used by the UE to
attempt contention free Random Access to recover from beam failure, (see TS 38.213 [13],
clause 6)
ra-prioritization
Parameters which apply for prioritized random access procedure for BFR (see TS 38.321 [3],
clause 5.1.1).
ra-ssb-OccasionMaskIndex
Explicitly signalled PRACH Mask Index for RA Resource selection in TS 38.321 [3]. The mask
is valid for all SSB resources
rack-ConfigBFR
Configuration of contention free random access occasions for BFR
recoverySearchSpaceId
Search space to use for BFR RAR. The network configures this search space to be within the
linked DL BWP (i.e., within the DL BWP with the same bwp-Id) of the UL BWP in which the
BeamFailureRecoveryConfig is provided. The CORESET associated with the recovery search
space cannot be associated with another search space.
ssb-perRACH-Occasion
Number of SSBs per RACH occasion for CF-BFR (L1 parameter ‘SSB-per-rach-occasion’)
BFR-CSIRS-Resource field descriptions
csi-RS
The ID of a NZP-CSI-RS-Resource configured in the CSI-MeasConfig of this serving cell. This
reference signal determines a candidate beam for beam failure recovery (BFR).
ra-OccasionList
RA occasions that the UE shall use when performing BFR upon selecting the candidate beam
identified by this CSI-RS. The network ensures that the RA occasion indexes provided herein
are also configured by prach-ConfigurationIndex and msg1-FDM. Each RACH occasion is
sequentially numbered, first, in increasing order of frequency resource indexes for frequency
multiplexed PRACH occasions; second, in increasing order of time resource indexes for time
multiplexed PRACH occasions within a PRACH slot and Third, in increasing order of indexes
for PRACH slots.
If the field is absent the UE uses the RA occasion associated with the SSB that is QCLed with
this CSI-RS.
ra-Preamble Index
The RA preamble index to use in the RA occasions associated with this CSI-RS. If the field is
absent, the UE uses the preamble index associated with the SSB that is QCLed with this CSI-
RS.
BFR-SSB-Resource field descriptions
ra-Preamble Index
The preamble index that the UE shall use when performing BFR upon selecting the candidate
beams identified by this SSB.
ssb
The ID of an SSB transmitted by this serving cell. It determines a candidate beam for beam
failure recovery (BFR)
Conditional Presence
CF-BFR
The field is mandatory present, Need R, if contention free random access resources for BFR are
configured. It is optionally present otherwise

In the first embodiment, the PRACH resource configuration for BFR, defined as PRACH-ResourceConfigBFR IE, can be configured on serving cell basis. Table 3 shows an example RRC configuration can be used to realize the function.

TABLE 3
-- ASN1START

| | |
|---|---|
| UplinkConfig ::= | SEQUENCE { |

| initialUplinkBWP | BWP-UplinkDedicated OPTIONAL, -- Need M | |
|---|---|---|
| uplinkBWP-ToReleaseList | SEQUENCE (SIZE (1..maxNrofBWPs)) OF BWP-Id | OPTIONAL, -- Need N |
| uplinkBWP-ToAddModList | SEQUENCE (SIZE (1..maxNrofBWPs)) OF BWP-Uplink | OPTIONAL, -- Need N |

| firstActiveUplinkBWP-Id | BWP-Id OPTIONAL, -- Cond SyncAndCellAdd | |
|---|---|---|
| pusch-ServingCellConfig | SetupRelease { PUSCH-ServingCellConfig } | OPTIONAL, -- Need M |
| carrierswitching | SetupRelease { SRS-CarrierSwitching } | OPTIONAL, -- Need M |

| | |
|---|---|
| candidateBeamsBFR-ToAddModList | SEQUENCE SIZE(1..maxNrofCandidateBeamsPerServingCell)) |

| | |
|---|---|
| OF PRACH-ResourceDedicatedBFR | OPTIONAL, -- Need N |

| | |
|---|---|
| candidateBeamsBFR-ToReleaseList | SEQUENCE SIZE(1..maxNrofCandidateBeamsPerServingCell)) |

OF INTEGER (1.. maxNrofCandidateBeamsPerServingCell)

OPTIONAL, -- Need N

...
}

| | |
|---|---|
| PRACH-ResourceDedicatedBFR ::= | SEQUENCE { |

| | |
|---|---|
| resourceId | INTEGER (1..maxNrofCandidateBeamsPerServingCell), |

| | |
|---|---|
| beamResourceBFR | CHOICE { |

| | |
|---|---|
| ssb | BFR-SSB-Resource, |
| csi-RS | BFR-CSIRS-Resource |

}

}
-- ASN1STOP

In various embodiments, the set of candidate beams for BFR, namely, candidateBeamsBFR-ToAddModList, is to be included in UplinkConfig configured per serving cell, ServingCellConfig (see e.g., tables 5 and 6 infra). The parameter maxNrofCandidateBeamsPerServingCell defines the maximum number of candidate beams for BFR per serving cell, and as an example, can be set to 128. The invalid candidate beams for BFR to be removed, which are identified by resourceId of each PRACH-ResourceDedicatedBFR, shall be added to the list candidateBeamsBFR-ToReleaseList. The resourceId of PRACH-ResourceDedicatedBFR shall be ordered uniquely over the whole serving cell. As a result, all the valid candidate beams for BFR are configured in a serving cell specific manner. For each uplink BWP, the subset of cell-specific candidate beams can be configured for BFR as shown by table 4.

TABLE 4

| | |
|---|---|
| BeamFailureRecoveryConfig ::= | SEQUENCE { |

| ... | |
|---|---|
| candidateBeamRSList | SEQUENCE (SIZE(1..maxNrofCandidateBeams)) OF |

| | |
|---|---|
| INTEGER (1..maxNrofCandidateBeamsPerServingCell) | OPTIONAL, -- Need M |

...,

}

According to some embodiments, the BeamFailureRecoveryConfig is configured per uplink BWP. Instead of being comprised of BFR beam RS resources, the candidateBeamRSList may be configured to include the indices of candidate beams from the set of candidate beams in cell-specific UplinkConfig. This would reduce signaling overhead.

According to some embodiments, the ServingCellConfig IE is used to configure (add or modify) the UE with a serving cell, which may be the SpCell or an SCell of an MCG or SCG. The parameters herein are mostly UE specific but partly also cell specific (e.g. in additionally configured bandwidth parts). Table 5 shows an example ServingCellConfig IE and table 6 shows field descriptions for the ServingCellConfig IE.

TABLE 5
ServingCellConfig information element

-- ASN1START
-- TAG-SERVING-CELL-CONFIG-START

| | |
|---|---|
| ServingCellConfig ::= | SEQUENCE { |

| | |
|---|---|
| tdd-UL-DL-ConfigurationDedicated | TDD-UL-DL-ConfigDedicated |

| | |
|---|---|
| OPTIONAL, | -- Cond TDD |

| | |
|---|---|
| initialDownlinkBWP | BWP-DownlinkDedicated |

| | |
|---|---|
| OPTIONAL, | -- Need M |

| | |
|---|---|
| downlinkBWP-ToReleaseList | SEQUENCE (SIZE (1..maxNrofBWPs)) OF BWP-Id |

| | |
|---|---|
| OPTIONAL, | -- Need N |

| | |
|---|---|
| downlinkBWP-ToAddModList | SEQUENCE (SIZE (1..maxNrofBWPs)) OF BWP-Downlink |

| | |
|---|---|
| OPTIONAL, | -- Need N |

| | |
|---|---|
| firstActiveDownlinkBWP-Id | BWP-Id |

| | |
|---|---|
| OPTIONAL, | -- Cond SyncAndCellAdd |

| | |
|---|---|
| bwp-InactivityTimer | ENUMERATED {ms2, ms3, ms4, ms5, ms6, ms8, ms10, ms20, |

ms30,

ms40,ms50, ms60, ms80,ms100, ms200,ms300,

ms500,

ms750, ms1280, ms1920, ms2560, spare10,

spare9, spare8,

spare7, spare6, spare5, spare4, spare3,

spare2, spare1 } OPTIONAL, --Need R

| | |
|---|---|
| defaultDownlinkBWP-Id | BWP-Id |

| | |
|---|---|
| OPTIONAL, | -- Need S |

| | |
|---|---|
| uplinkConfig | UplinkConfig |

| | |
|---|---|
| OPTIONAL, | -- Need M |

| | |
|---|---|
| supplementaryUplink | UplinkConfig |

| | |
|---|---|
| OPTIONAL, | -- Need M |

| | |
|---|---|
| pdcch-ServingCellConfig | SetupRelease { PDCCH-ServingCellConfig } |

| | |
|---|---|
| OPTIONAL, | -- Need M |

| | |
|---|---|
| pdsch-ServingCellConfig | SetupRelease { PDSCH-ServingCellConfig } |

| | |
|---|---|
| OPTIONAL, | -- Need M |

| | |
|---|---|
| csi-MeasConfig | SetupRelease { CSI-MeasConfig } |

| | |
|---|---|
| OPTIONAL, | -- Need M |

| | |
|---|---|
| sCellDeactivationTimer | ENUMERATED {ms20, ms40, ms80, ms160, ms200, ms240, |

ms320, ms400, ms480, ms520, ms640, ms720,
ms840, ms1280, spare2,spare1}

| | |
|---|---|
| OPTIONAL, | -- Cond ServingCellWithoutPUCCH |

| | |
|---|---|
| crossCarrierSchedulingConfig | CrossCarrierSchedulingConfig |

| | |
|---|---|
| OPTIONAL, | -- Need M |

| | |
|---|---|
| tag-Id | TAG-Id, |
| ue-BeamLockFunction | ENUMERATED {enabled} |

| | |
|---|---|
| OPTIONAL, | -- Need R |

| | |
|---|---|
| pathlossReferenceLinking | ENUMERATED {pCell, sCell} |

| | |
|---|---|
| OPTIONAL, | -- Cond SCellOnly |

| | |
|---|---|
| servingCellMO | MeasObjectId |

| | |
|---|---|
| OPTIONAL, | -- Cond MeasObject |

| ..., | |
|---|---|
| [[ | |
| lte-CRS-ToMatchAround | SetupRelease { RateMatchPatternLTE-CRS } |

| | |
|---|---|
| OPTIONAL, | -- Need M |

| | |
|---|---|
| rateMatchPatternToAddModList | SEQUENCE (SIZE (1..maxNrofRateMatchPatterns)) OF |

| | |
|---|---|
| RateMatchPattern | OPTIONAL, -- Need N |

| | |
|---|---|
| rateMatchPatternToReleaseList | SEQUENCE (SIZE (1..maxNrofRateMatchPatterns)) OF |

| | |
|---|---|
| RateMatchPatternId | OPTIONAL, -- Need N |

| | |
|---|---|
| downlinkChannelBW-PerSCS-List | SEQUENCE (SIZE (1..maxSCSs)) OF SCS-SpecificCarrier |

| | |
|---|---|
| OPTIONAL | -- Need S |

]]

}

| | |
|---|---|
| UplinkConfig ::= | SEQUENCE { |

| | |
|---|---|
| initialUplinkBWP | BWP-UplinkDedicated |

| | |
|---|---|
| OPTIONAL, | -- Need M |

| | |
|---|---|
| uplinkBWP-ToReleaseList | SEQUENCE (SIZE (1..maxNrofBWPs)) OF BWP-Id |

| | |
|---|---|
| OPTIONAL, | -- Need N |

| | |
|---|---|
| uplinkBWP-ToAddModList | SEQUENCE (SIZE (1..maxNrofBWPs)) OF BWP-Uplink |

| | |
|---|---|
| OPTIONAL, | -- Need N |

| | |
|---|---|
| firstActiveUplinkBWP-Id | BWP-Id |

| | |
|---|---|
| OPTIONAL, | -- Cond SyncAndCellAdd |

| | |
|---|---|
| pusch-ServingCellConfig | SetupRelease { PUSCH-ServingCellConfig } |

| | |
|---|---|
| OPTIONAL, | -- Need M |

| | |
|---|---|
| carrierswitching | SetupRelease { SRS-CarrierSwitching } |

| | |
|---|---|
| OPTIONAL, | -- Need M |

| ..., | |
|---|---|
| [[ | |
| powerBoostPi2BPSK | BOOLEAN |

| | |
|---|---|
| OPTIONAL, | -- Need M |

| | |
|---|---|
| uplinkChannelBW-PerSCS-List | SEQUENCE (SIZE (1..maxSCSs)) OF SCS-SpecificCarrier |

| | |
|---|---|
| OPTIONAL | -- Need S |

]]

}
-- TAG-SERVING-CELL-CONFIG-STOP
-- ASN1STOP

TABLE 6
ServingCellConfig field descriptions

bwp-InactivityTimer
The duration in ms after which the UE falls back to the default Bandwidth Part, (see TS 38.321
[3], clause 5.15) The value 0.5 ms is only applicable for carriers >6 GHz. When the network
releases the timer configuration, the UE stops the timer without switching to the default BWP.
crossCarrierSchedulingConfig
Indicates whether this serving cell is cross-carrier scheduled by another serving cell or whether
it cross-carrier schedules another serving cell.
defaultDownlinkBWP-Id
The initial bandwidth part is referred to by BWP-Id = 0. ID of the downlink bandwidth part to
be used upon expiry of the BWP inactivity timer. This field is UE specific. When the field is
absent the UE uses the initial BWP as default BWP. (see TS 38.213 [13], clause 12 and TS
38.321 [3], clause 5.15).
downlinkBWP-ToAddModList
List of additional downlink bandwidth parts to be added or modified, (see TS 38.213 [13],
clause 12).
downlinkBWP- ToReleaseList
List of additional downlink bandwidth parts to be released, (see TS 38.213 [13], clause 12).
downlinkChannelBW-PerSCS-List
A set of UE specific carrier configurations for different subcarrier spacings (numerologies).
Defined in relation to Point A. Corresponds to L1 parameter ‘offset-pointA-set’ (see 38.211,
clause FFS_clause). If absent, UE uses the configuration indicated in scs-SpecificCarrierList
in DownlinkConfigCommon/DownlinkConfigCommonSIB.
firstActiveDownlinkBWP-Id
If configured for an SpCell, this field contains the ID of the DL BWP to be activated upon
performing the RRC (re-)configuration. If the field is absent, the RRC (re-)configuration does
not impose a BWP switch.
If configured for an SCell, this field contains the ID of the downlink bandwidth part to be used
upon MAC-activation of an SCell. The initial bandwidth part is referred to by BWP-Id = 0.
Upon reconfigurationWithSync (PCell handover, PSCelladdition/change), the network sets the
firstActiveDownlinkBWP-Id and firstActiveUplinkBWP-Id to the same value.
initialDownlinkBWP
The dedicated (UE-specific) configuration for the initial downlink bandwidth-part. If any of
the optional IEs are configured within this IE, the UE considers the initial DL BWP as a RRC
configured DL BWP for the UE. Otherwise, the UE does not consider the initial DL BWP as
RRC configured DL BWP for the UE.
lte-CRS-ToMatchAround
Parameters to determine an LTE CRS pattern that the UE shall rate match around.
pathlossReferenceLinking
Indicates whether UE shall apply as pathloss reference either the downlink of PCell or of SCell
that corresponds with this uplink (see TS 38.213 [13], clause 7)
pdsch-ServingCellConfig
PDSCH related parameters that are not BWP-specific.
rateMatchPatternToAddModList
Resources patterns which the UE should rate match PDSCH around. The UE rate matches
around the union of all resources indicated in the nested bitmaps. Rate match patterns defined
here on cell level apply only to PDSCH of the same numerology. Corresponds to L1 parameter
‘Resource-set-cell’ (see TS 38.214 [19], clause 5.1.2.2.3)
sCellDeactivationTimer
SCell deactivation timer in TS 38.321 [3], If the field is absent, the UE applies the value
infinity.
servingCellMO
measObjectId of the MeasObjectNR in MeasConfig which is associated to the serving cell. For
this MeasObjectNR, the following relationship applies between this MeasObjectNR and
frequencyInfoDL in ServingCellConfigCommon of the serving cell: if ssbFrequency is
configured, its value is the same as the absoluteFrequencySSB and if csi-rs-
ResourceConfigMobility is configured, the value of its subcarrierSpacing is present in one
entry of the scs-SpecificCarrierList, csi-RS-CellListMobility includes an entry corresponding
to the serving cell (with cellId equal to physCellId in ServingCellConfigCommon) and the
frequency range indicated by the csi-rs-MeasurementBW of the entry in csi-RS-
CellListMobility is included in the frequency range indicated by in the entry of the scs-
SpecificCarrierList.
tag-id
Timing Advance Group ID, as specified in TS 38.321 [3], which this cell belongs to.
ue-BeamLockFunction
Enables the “UE beam lock function (UBF)”, which disable changes to the UE beamforming
configuration when in NR_RRC_CONNECTED. FFS: Parameter added preliminary based on
RAN4 LS in R4-1711823. Decide where to place it (maybe ServingCellConfigCommon or in
a BeamManagement IE??)
UplinkConfig field descriptions
carrierSwitching
Includes parameters for configuration of carrier based SRS switching (see TS 38.214 [19],
clause 6.2.1.3.
firstActiveUplinkBWP-Id
If configured for an SpCell, this field contains the ID of the UL BWP to be activated upon
performing the RRC (re-)configuration. If the field is absent, the RRC (re-)configuration does
not impose a BWP switch.
If configured for an SCell, this field contains the ID of the uplink bandwidth part to be used
upon MAC-activation of an SCell. The initial bandwidth part is referred to by
BandiwdthPartId = 0.
initialUplinkBWP
The dedicated (UE-specific) configuration for the initial uplink bandwidth-part. If any of the
optional IEs are configured within this IE as part of the IE uplinkConfig, the UE considers the
initial UL BWP as a RRC configured UL BWP for the UE. Otherwise, the UE does not
consider the initial UL BWP as RRC configured UL BWP for the UE.
powerBoostPi2BPSK
If this field is set to TRUE, the UE determines the maximum output power for
PUCCH/PUSCH transmissions that use pi/2 BPSK modulation according to TS 38.101 [15],
clause 6.2.4.
pusch-ServingCellConfig
PUSCH related parameters that are not BWP-specific.
supplementary Uplink
The field is optionally present if supplementaryUplinkConfig is configured in
ServingCellConfigCommon and absent otherwise.
uplinkBWP-ToReleaseList
The additional bandwidth parts for uplink. In case of TDD uplink- and downlink BWP with
the same bandwidthPartId are considered as a BWP pair and must have the same center
frequency.
uplinkChannelBW-PerSCS-List
A set of UE specific carrier configurations for different subcarrier spacings (numerologies).
Defined in relation to Point A. Corresponds to L1 parameter ‘offset-pointA-set’ (see 38.211,
clause FFS_clause). If absent, UE uses the configuration indicated in scs-SpecificCarrierList
in UplinkConfigCommon/UplinkConfigCommonSIB.
uplinkConfig
The field is optionally present if uplinkConfigCommon is configured in
ServingCellConfigCommon, and absent otherwise.

| Conditional Presence | Explanation |
|---|---|
| MeasObject | This field is mandatory present for the SpCell if the UE has a |
| | measConfig, and it is optionally present, Need M, for SCells. |
| SCellOnly | This field is optionally present, Need R, for SCells. It is absent |
| | otherwise. |
| ServingCellWithoutPUCCH | This field is optionally present, Need S, for SCells except |
| | PUCCH SCells. It is absent otherwise. |
| SyncAndCellAdd | This field is mandatory present, Need N, for a SpCell upon |
| | reconfigurationWithSync (PCell handover, |
| | PSCelladdition/change) and upon RRCsetup/RRCResume. |
| | The field is mandatory present, Need M, for an SCell upon |
| | addition. |
| | For SpCell, the field is optionally present, Need N, upon |
| | reconfiguration without reconfigurationWithSync. |
| | In all other cases the field is absent. |
| TDD | This field is optionally present, Need R, for TDD cells. It is |
| | absent otherwise. |

### Embodiment-2: MAC CE Activation/Deactivation of Candidate Beams for BFR Per Uplink BWP

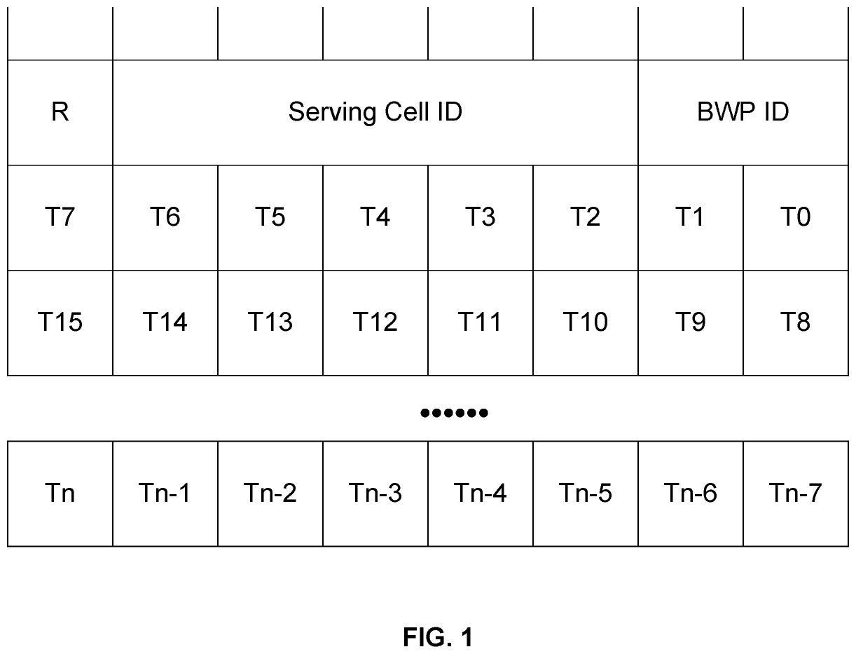

In this embodiment, a MAC CE is used to dynamically activate/deactivate the candidate beams for BFR per uplink BWP. An example MAC CE is illustrated by FIG. 1.

The BFR candidate beam Activation/Deactivation for BWP-specific MAC CE may be identified by a MAC PDU subheader with a new LCID, for example, a new LCID index value for UL-SCH and/or DL-SCH. It has a variable size including the following fields:
Serving Cell ID: This field indicates the identity of the Serving Cell for which the MAC CE applies. The length of the field is 5 bits;
BWP ID: This field indicates a UL BWP for which the MAC CE applies as the codepoint of the DCI bandwidth part indicator field as specified infra. The length of the BWP ID field is 2 bits;
Tᵢ: If there is a PRACH-ResourceDedicatedBFR with resourceId i configured in candidateBeamsBFR-ToAddModList in UplinkConfig, this field indicates the activation/deactivation status of the PRACH-ResourceDedicatedBFR with resourceId i, otherwise MAC entity shall ignore the Tᵢ field. The Tᵢ field is set to “1” to indicate that the PRACH-ResourceDedicatedBFR with resourceId i shall be activated. The Tᵢ field is set to “0” to indicate that the PRACH-ResourceDedicatedBFR with resourceId i shall be deactivated. The maximum number of activated PRACH-ResourceDedicatedBFRs can be 16;
R: Reserved bit, set to “0”.

In various embodiments, the MAC subheader may include some or all of the following fields:
LCID: The Logical Channel ID field identifies the logical channel instance of the corresponding MAC SDU or the type of the corresponding MAC CE or padding for the DL-SCH and UL-SCH respectively. There is one LCID field per MAC subheader. The LCID field size is 6 bits;
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
R: Reserved bit, set to “0”.

According to the second embodiment, the network can activate/deactivate the candidate beams for BFR of a UE in a particular BWP by sending the above MAC CE to the UE. The new set of activated candidate beams becomes valid at x slots after UE sends HARQ-ACK to network for acknowledging the PDSCH carrying the MAC CE.

According to some embodiments, the BWP ID field indicates a UL BWP for which the MAC CE applies as the codepoint of the DCI bandwidth part indicator field. The DCI bandwidth part indicator field may be included in a DCI format 0_1 or DCI format 1_1. The DCI format 0_1 is used for the scheduling of PUSCH in one cell, and the DCI format 1_1 is used for the scheduling of PDSCH in one cell. The DCI bandwidth part indicator field included in DCI format 0_1 may be 0, 1 or 2 bits as determined by the number of UL BWPs n configured by higher layers, excluding the initial UL bandwidth part. The DCI bandwidth part indicator field included in DCI format 1_1 may be 0, 1 or 2 bits as determined by the number of DL BWPs n_{BWP,RRC} configured by higher layers, excluding the initial DL bandwidth part. The bitwidth for this field in either DCI format 0_1 and/or DCI format 1_1 is determined as ┌log₂(n_{BWP})┐ bits, where n_{BWP}=n_{BWP,RRC}+1 if n_{BWP,RRC}≤3, in which case the bandwidth part indicator is equivalent to the ascending order of the higher layer parameter BWP-Id; otherwise n_{BWP}=n_{BWP,RRC}, in which case the bandwidth part indicator is defined in table 7. If the UE does not support active BWP change via DCI, the UE ignores the bandwidth part indicator field.

TABLE 7
Bandwidth part indicator

| Value of BWP indicator field | |
|---|---|
| 2 bits | Bandwidth part |
| 00 | Configured BWP with BWP-Id = 1 |
| 01 | Configured BWP with BWP-Id = 2 |
| 10 | Configured BWP with BWP-Id = 3 |
| 11 | Configured BWP with BWP-Id = 4 |

### Beam Management

Beam management refers to a set of L1/L2 procedures to acquire and maintain a set of transmission/reception point(s) (TRP or TRxP) and/or UE beams that can be used for DL and UL transmission/reception. Beam management includes various operations or procedures, such as beam determination, beam management, beam reporting, and beam sweeping operations/procedures. Beam determination refers to TRxP(s) or UE ability to select of its own Tx/Rx beam(s). Beam measurement refers to TRP or UE ability to measure characteristics of received beamformed signals. Beam reporting refers the UE ability to report information of beamformed signal(s) based on beam measurement. Beam sweeping refers to operation(s) of covering a spatial area, with beams transmitted and/or received during a time interval in a predetermined manner.

Tx/Rx beam correspondence at a TRxP holds if at least one of the following conditions are satisfied: TRxP is able to determine a TRxP Rx beam for the uplink reception based on the UE's (e.g., UE 301 of FIG. 3) downlink measurement on TRxP's one or more Tx beams; and TRxP is able to determine a TRxP Tx beam for the downlink transmission based on TRxP's uplink measurement on TRxP's one or more Rx beams. Tx/Rx beam correspondence at a UE holds if at least one of the following is satisfied: UE is able to determine a UE Tx beam for the uplink transmission based on UE's downlink measurement on UE's one or more Rx beams; UE is able to determine a UE Rx beam for the downlink reception based on TRxP's indication based on uplink measurement on UE's one or more Tx beams; and Capability indication of UE beam correspondence related information to TRxP is supported.

In some implementations, DL beam management includes procedures P-1, P-2, and P-3. Procedure P-1 is used to enable UE measurement on different TRxP Tx beams to support selection of TRxP Tx beams/UE Rx beam(s). For beamforming at TRxP, procedure P-1 typically includes a intra/inter-TRxP Tx beam sweep from a set of different beams. For beamforming at the UE, procedure P-1 typically includes a UE Rx beam sweep from a set of different beams.

Procedure P-2 is used to enable UE measurement on different TRxP Tx beams to possibly change inter/intra-TRxP Tx beam(s). Procedure P-2 may be a special case of procedure P-1 wherein procedure P-2 is used for a possibly smaller set of beams for beam refinement than procedure P-1. Procedure P-3 is used to enable UE measurement on the same TRxP Tx beam to change UE Rx beam in the case UE uses beamforming. Procedures P-1, P-2, and P-3 may be used for aperiodic beam reporting.

UE measurements based on RS for beam management (at least CSI-RS) is composed of K beams (where K is a total number of configured beams), and the UE reports measurement results of N selected Tx beams (where N may or may not be a fixed number). The procedure based on RS for mobility purpose is not precluded. Beam information that is to be reported includes measurement quantities for the N beam(s) and information indicating N DL Tx beam(s), if N<K. Other information or data may be included in or with the beam information. When a UE is configured with K′>1 NZP CSI-RS resources, a UE can report N′ CRIs.

For beam failure detection, the gNB configures the UE with beam failure detection reference signals, and the UE declares beam failure when the number of beam failure instance indications from the physical layer reaches a configured threshold within a configured period. After beam failure is detected, the UE triggers beam failure recovery by initiating a Random Access procedure on the Pcell, and selects a suitable beam to perform beam failure recovery (if the gNB has provided dedicated Random Access resources for certain beams, those will be prioritized by the UE). Upon completion of the Random Access procedure, beam failure recovery is considered complete.

The trigger a mechanism to recover from beam failure, which is referred to a “beam recovery”, “beam failure recovery request procedure”, and/or the like. A beam failure event may occur when the quality of beam pair link(s) of an associated control channel falls below a threshold, when a time-out of an associated timer occurs, or the like. The beam recovery mechanism is triggered when beam failure occurs. The network may explicitly configure the UE with resources for UL transmission of signals for recovery purposes. Configurations of resources are supported where the base station (e.g., a TRP, gNB, or the like) is listening from all or partial directions (e.g., a random access region). The UL transmission/resources to report beam failure can be located in the same time instance as a Physical Random Access Channel (PRACH) or resources orthogonal to PRACH resources, or at a time instance (configurable for a UE) different from PRACH. Transmission of DL signal is supported for allowing the UE to monitor the beams for identifying new potential beams.

A beam failure may be declared if one, multiple, or all serving PDCCH beams fail. The beam failure recovery request procedure is initiated when a beam failure is declared. For example, the beam failure recovery request procedure may be used for indicating to a serving gNB (or TRP) of a new SSB or CSI-RS when beam failure is detected on a serving SSB(s)/CSI-RS(s). A beam failure may be detected by the lower layers and indicated to a Media Access Control (MAC) entity of the UE.

Beam management also includes providing, or not providing, beam-related indications. When beam-related indication is provided, information pertaining to UE-side beamforming/receiving procedure used for CSI-RS-based measurement can be indicated through QCL to the UE. The same or different beams on the control channel and the corresponding data channel transmissions may be supported. DL beam indications are based on a Transmission Configuration Indication (TCI) state(s). The TCI state(s) are indicated in a TCI list that is configured by radio resource control (RRC) and/or Media Access Control (MAC) Control Element (CE).

When the radio link quality on all the configured RS resources in set go is worse than Q_{out_LR}, Layer 1 of the UE shall send a beam failure instance indication for the cell to the higher layers. A Layer 3 filter shall be applied to the beam failure instance indications. The beam failure instance evaluation for the configured RS resources in set q̅₀ is performed. Two successive indications from Layer 1 shall be separated by at least T_{Indication_interval_BFD}. When DRX is not used, T_{Indication_interval_BFD} is max(2 ms, T_{BFD-RS,M}), where T_{BFD-RS,M} is the shortest periodicity of all configured RS resources in set q̅₀ for the accessed cell, which corresponds to T_{SSB} if a RS resource in the set q̅₀ is SSB, or T_{CSI-RS} if a RS resource in the set q̅₀ is CSI-RS. When DRX is used, T_{Indication_interval_BFD} is max(1.5*DRX_cycle_length, 1.5*T_{BFD-RS,M}) if DRX cycle_length is less than or equal to 320 ms, and T_{Indication_interval} is DRX_cycle_length if DRX cycle_length is greater than 320 ms.

A beam failure recovery request could be delivered over dedicated PRACH or PUCCH resources. If the random access procedure is initialized for beam failure recovery and if the contention-free Random Access Resources and the contention-free PRACH occasions for beam failure recovery request associated with any of the SSBs and/or CSI-RSs is configured, UE has the capability to select the Random Access Preamble corresponding to the selected SSB with SS-RSRP above rsrp-ThresholdSSB amongst the associated SSBs or the selected CSI-RS with CSI-RSRP above cfra-csirs-DedicatedRACH-Threshold amongst the associated CSI-RSs, and to transmit Random Access Preamble on the next available PRACH occasion from the PRACH occasions corresponding to the selected SSB permitted by the restrictions given by the ra-ssb-OccasionMaskIndex if configured, or from the PRACH occasions in ra-OccasionList corresponding to the selected CSI-RS, and PRACH occasion shall be randomly selected with equal probability amongst the selected SSB associated PRACH occasions or the selected CSI-RS associated PRACH occasions occurring simultaneously but on different subcarriers. The UE may stop monitoring for Random Access Response(s), if the contention-free Random Access Preamble for beam failure recovery request was transmitted and if the PDCCH addressed to UE's C-RNTI is received.

### Beam Measurement

The UE in the RRC_CONNECTED mode measures one or multiple beams of a cell, and the measurement results (e.g., power values) are averaged to derive the cell quality. In doing so, the UE is configured to consider a subset of the detected beams, such as the N best beams above an absolute threshold. Filtering takes place at the physical layer to derive beam quality and then at the RRC level to derive cell quality from the multiple beams. Cell quality from beam measurements is derived in the same way for the serving cell(s) and for the non-serving cell(s). Measurement reports may contain the measurement results of the X best beams if the UE is configured to do so by the gNB.

The UE derives cell measurement results by measuring one or multiple beams associated per cell as configured by the network. For all cell measurement results in RRC_CONNECTED mode, the UE applies layer 3 filtering before using the measured results for evaluation of reporting criteria and measurement reporting. For cell measurements, the network can configure RSRP, RSRQ, and/or SINR as a trigger quantity. Reporting quantities can be the same as the trigger quantity or combinations of quantities (e.g., RSRP and RSRQ; RSRP and SINR; RSRQ and SINR; RSRP, RSRQ and SINR).

The network may also configure the UE to report measurement information per beam, which can either be measurement results per beam with respective beam identifier(s) or only beam identifier(s)). If beam measurement information is configured to be included in measurement reports, the UE applies the layer 3 beam filtering. However, the exact layer 1 filtering of beam measurements used to derive cell measurement results is implementation dependent.

Measurement reports contain the measurement results of the X best beams if the UE is configured to do so by the gNB. For channel state estimation purposes, the UE may be configured to measure CSI-RS resources and estimate a downlink channel state based on the CSI-RS measurements. The UE feeds the estimated channel state back to the gNB to be used in link adaptation.

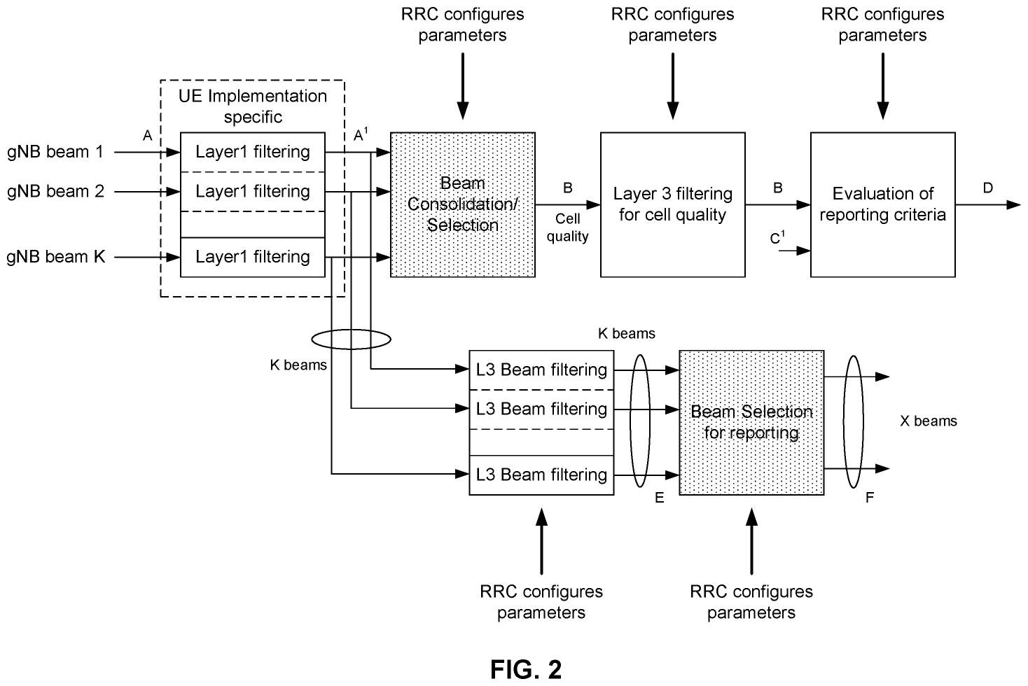

An example measurement model is shown by FIG. 2. In FIG. 2, point A includes measurements (e.g., beam specific samples) internal to the PHY. Layer 1 (L1) filtering includes internal layer 1 filtering circuitry for filtering the inputs measured at point A. The exact filtering mechanisms and how the measurements are actually executed at the PHY may be implementation specific. The measurements (e.g., beam specific measurements) are reported by the L1 filtering to layer 3 (L3) beam filtering circuitry and the beam consolidation/selection circuitry at point A¹.

The Beam Consolidation/Selection circuitry includes circuitry where beam specific measurements are consolidated to derive cell quality. For example, if N>1, else when N=1 the best beam measurement may be selected to derive cell quality. The configuration of the beam is provided by RRC signaling. A measurement (e.g., cell quality) derived from the beam-specific measurements are then be reported to L3 filtering for cell quality circuitry after beam consolidation/selection. In some embodiments, the reporting period at point B may be equal to one measurement period at point A¹.

The L3 filtering for cell quality circuitry is configured to filter the measurements provided at point B. The configuration of the Layer 3 filters is provided by the aforementioned RRC signaling or different/separate RRC signaling. In some embodiments, the filtering reporting period at point C may be equal to one measurement period at point B. A measurement after processing in the layer 3 filter circuitry is provided to the evaluation of reporting criteria circuitry at point C. In some embodiments, the reporting rate may be identical to the reporting rate at point B. This measurement input may be used for one or more evaluation of reporting criteria.

Evaluation of reporting criteria circuitry is configured to check whether actual measurement reporting is necessary at point D. The evaluation can be based on more than one flow of measurements at reference point C. In one example, the evaluation may involve a comparison between different measurements, such as a measurement provided at point C and another measurement provided at point C¹. In embodiments, the UE may evaluate the reporting criteria at least every time a new measurement result is reported at point C, C¹. The reporting criteria configuration is provided by the aforementioned RRC signaling (UE measurements) or different/separate RRC signaling. After the evaluation, measurement report information (e.g., as a message) is sent on the radio interface at point D.

Referring back to point A¹, measurements provided at point A¹ are provided to L3 Beam filtering circuitry, which is configured to perform beam filtering of the provided measurements (e.g., beam specific measurements). The configuration of the beam filters is provided by the aforementioned RRC signaling or different/separate RRC signaling. In embodiments, the filtering reporting period at point E may be equal to one measurement period at A¹. The K beams correspond to the measurements on New Radio (NR)-synchronization signal (SS) block (SSB) or Channel State Information Reference Signal (CSI-RS) resources configured for L3 mobility by a gNB and detected by the UE at L1.

After processing in the beam filter measurement (e.g., beam-specific measurement), a measurement is provided to beam selection for reporting circuitry at point E. This measurement is used as an input for selecting the X measurements to be reported. In embodiments, the reporting rate may be identical to the reporting rate at point A¹. The beam selection for beam reporting circuitry is configured to select the X measurements from the measurements provided at point E. The configuration of this module is provided by the aforementioned RRC signaling or different/separate RRC signaling. The beam measurement information to be included in a measurement report is sent or scheduled for transmission on the radio interface at point F.

L1 filtering introduces a certain level of measurement averaging. Exactly how and when the UE performs the required measurements is implementation specific to the point that the output at B fulfils the predefined performance requirements. L3 filtering for cell quality and related parameters do not introduce any delay in the sample availability between B and C. Measurement at point C, C¹ is the input used in the event evaluation. L3 Beam filtering and related parameters do not introduce any delay in the sample availability between E and F

The measurement reports include a measurement identity of an associated measurement configuration that triggered the reporting; cell and beam measurement quantities to be included in measurement reports are configured by the network (e.g., using RRC signaling); the number of non-serving cells to be reported can be limited through configuration by the network; cells belonging to a blacklist configured by the network are not used in event evaluation and reporting, and conversely when a whitelist is configured by the network, only the cells belonging to the whitelist are used in event evaluation and reporting (by contrast), when a whitelist is configured by the network, only the cells belonging to the whitelist are used in event evaluation and reporting; and beam measurements to be included in measurement reports are configured by the network (beam identifier only, measurement result and beam identifier, or no beam reporting).

Intra-frequency neighbour (cell) measurements and inter-frequency neighbour (cell) measurements include SSB based measurements and CSI-RS based measurements.

For SSB based measurements, one measurement object corresponds to one SSB and the UE considers different SSBs as different cells. An SSB based intra-frequency measurement is a measurement is defined as an SSB based intra-frequency measurement provided the center frequency of the SSB of the serving cell and the center frequency of the SSB of the neighbour cell are the same, and the subcarrier spacing of the two SSBs is also the same.

An SSB based inter-frequency measurement is a measurement is defined as an SSB based inter-frequency measurement provided the center frequency of the SSB of the serving cell and the center frequency of the SSB of the neighbour cell are different, or the subcarrier spacing of the two SSBs is different.

A CSI-RS based intra-frequency measurement is a measurement is defined as a CSI-RS based intra-frequency measurement provided the bandwidth of the CSI-RS resource on the neighbour cell configured for measurement is within the bandwidth of the CSI-RS resource on the serving cell configured for measurement, and the subcarrier spacing of the two CSI-RS resources is the same.

A CSI-RS based inter-frequency measurement is a measurement is defined as a CSI-RS based inter-frequency measurement provided the bandwidth of the CSI-RS resource on the neighbour cell configured for measurement is not within the bandwidth of the CSI-RS resource on the serving cell configured for measurement, or the subcarrier spacing of the two CSI-RS resources is different.

Inter-frequency neighbor (cell) measurements include SSB based inter-frequency measurement(s) and CSI-RS based inter-frequency measurements. SSB based inter-frequency measurements is/are defined as an SSB based inter-frequency measurement provided the center frequency of the SSB of the serving cell and the center frequency of the SSB of the neighbour cell are different, or the subcarrier spacing of the two SSBs is different. For SSB based measurements, one measurement object corresponds to one SSB and the UE considers different SSBs as different cells. CSI-RS based inter-frequency measurements is/are measurement is defined as a CSI-RS based inter-frequency measurement provided the bandwidth of the CSI-RS resource on the neighbour cell configured for measurement is not within the bandwidth of the CSI-RS resource on the serving cell configured for measurement, or the subcarrier spacing of the two CSI-RS resources is different.

Whether a measurement is non-gap-assisted or gap-assisted depends on the capability of the UE, the active BWP of the UE and the current operating frequency. In non-gap-assisted scenarios, the UE is able to carry out such measurements without measurement gaps. In gap-assisted scenarios, the UE cannot be assumed to be able to carry out such measurements without measurement gaps.

### Antenna Port Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability. Each TCI-State contains parameters for configuring a quasi co-location relationship between one or two downlink reference signals and the DM-RS ports of the PDSCH. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS is given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {average delay, Doppler shift}; QCL-TypeD: {Spatial Rx parameter}.

The UE receives an activation command used to map up to 8 TCI states to the codepoints of the DCI field ‘Transmission Configuration Indication’. When the HARQ-ACK corresponding to the PDSCH carrying the activation command is transmitted in slot n, the indicated mapping between TCI states and codepoints of the DCI field ‘Transmission Configuration Indication’ should be applied starting from slot n+3Nₛₗₒₜ^{subframe,μ}+1. After the UE receives the higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If tci-PresentInDCI is not configured for the CORESET scheduling the PDSCH or the PDSCH is scheduled by a DCI format 10, for determining PDSCH antenna port quasi co-location, the UE assumes that the TCI state for the PDSCH is identical to the TCI state applied for the CORESET used for the PDCCH transmission.

If the tci-PresentInDCI is set as ‘enabled’, when the PDSCH is scheduled by DCI format 1_1, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold Threshold-Sched-Offset, where the threshold is based on reported UE capability.

For both the cases when tci-PresentInDCI is set to ‘enabled’ and tci-PresentInDCI is not configured, if the offset between the reception of the DL DCI and the corresponding PDSCH is less than the threshold Threshold-Sched-Offset, the UE may assume that the DM-RS ports of PDSCH of a serving cell are quasi co-located with the RS(s) in the TCI state with respect to the QCL parameter(s) used for PDCCH quasi co-location indication of the lowest CORESET-ID in the latest slot in which one or more CORESETs within the active BWP of the serving cell are configured for the UE. If none of configured TCI states contains ‘QCL-TypeD’, the UE shall obtain the other QCL assumptions from the indicated TCI states for its scheduled PDSCH irrespective of the time offset between the reception of the DL DCI and the corresponding PDSCH.

For a periodic CSI-RS resource in a NZP-CSI-RS-ResourceSet configured with higher layer parameter trs-Info, the UE shall expect that a TCI-State indicates one of the following quasi-colocation type(s):
‘QCL-TypeC’ with an SS/PBCH block and, when applicable, ‘QCL-TypeD’ with the same SS/PBCH block, or
‘QCL-TypeC’ with an SS/PBCH block and, when applicable, ‘QCL-TypeD’ with a CSI-RS resource in an NZP-CSI-RS-ResourceSet configured with higher layer parameter repetition, or

For an aperiodic CSI-RS resource in a NZP-CSI-RS-ResourceSet configured with higher layer parameter trs-Info, the UE shall expect that a TCI-State indicates ‘QCL-TypeA’ with a periodic CSI-RS resource in a NZP-CSI-RS-ResourceSet configured with higher layer parameter trs-Info and, when applicable, ‘QCL-TypeD’ with the same periodic CSI-RS resource.

For a CSI-RS resource in a NZP-CSI-RS-ResourceSet configured without higher layer parameter trs-Info and without the higher layer parameter repetition, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with an SS/PBCH block, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in a NZP-CSI-RS-ResourceSet configured with higher layer parameter repetition, or
‘QCL-TypeB’ with a CSI-RS resource in a NZP-CSI-RS-ResourceSet configured with higher layer parameter trs-Info when ‘QCL-TypeD’ is not applicable.

For a CSI-RS resource in a NZP-CSI-RS-ResourceSet configured with higher layer parameter repetition, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in a NZP-CSI-RS-ResourceSet configured with higher layer parameter repetition, or
‘QCL-TypeC’ with an SS/PBCH block and, when applicable, ‘QCL-TypeD’ with the same SS/PBCH block.

For the DM-RS of PDCCH, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’with a CSI-RS resource in an NZP-CSI-RS-ResourceSet configured with higher layer parameter repetition, or
‘QCL-TypeA’ with a CSI-RS resource in a NZP-CSI-RS-ResourceSet configured without higher layer parameter trs-Info and without higher layer parameter repetition, when ‘QCL-TypeD’ is not applicable.

For the DM-RS of PDSCH, the UE shall expect that a TCI-State indicates one of the following quasi co-location type(s):
‘QCL-TypeA’ with a CSI-RS resource in a NZP-CSI-RS-ResourceSet configured with higher layer parameter trs-Info and, when applicable, ‘QCL-TypeD’ with the same CSI-RS resource, or
‘QCL-TypeA’ with a CSI-RS resource in a NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or
QCL-TypeA’ with CSI-RS resource in a NZP-CSI-RS-ResourceSet configured without higher layer parameter trs-Info and without repetition and, when applicable, ‘QCL-TypeD’ with the same CSI-RS resource.

### Beam Failure Recovery Procedures

The UE assesses the downlink link quality of a serving cell based on the reference signal in the set q̅₀ as specified herein in order to detect beam failure instance. The RS resources in the set q̅₀ can be periodic CSI-RS resources and/or SSBs. UE is not required to perform beam failure detection outside the active DL BWP. On each RS resource in the set q̅₀, the UE estimates the radio link quality and compares it to the threshold Q_{out_LR} for the purpose of accessing downlink radio link quality of the serving cell.

The threshold Q_{out_LR} is defined as the level at which the downlink radio level link cannot be reliably received and shall correspond to the BLERₒᵤₜ block error rate of a hypothetical PDCCH transmission. For SSB based beam failure detection, Q_{out_LR_SSB} is derived based on the hypothetical PDCCH transmission parameters listed in Table B.1-1. For CSI-RS based beam failure detection, Q_{out_LR_CSI-RS} is derived based on the hypothetical PDCCH transmission parameters listed in Table B.1-2.

TABLE B.1-1
PDCCH transmission parameters for beam failure instance

| Attribute | Value for BLER |
|---|---|
| DCI format | 1-0 |
| Number of control OFDM | Same as the number of symbols of |
| symbols | RMSI CORESET |
| Aggregation level (CCE) | 8 |
| Ratio of hypothetical | 0 dB |
| PDCCH RE energy to | |
| average SSS RE energy | |
| Ratio of hypothetical | 0 dB |
| PDCCH DMRS energy to | |
| average SSS RE energy | |
| Bandwidth (MHz) | Same as the number of PRBs of |
| | RMSI CORESET |
| Sub-carrier spacing (kHz) | Same as the SCS of RMSI |
| | CORESET |
| DMRS precoder | REG bundle size |
| granularity | |
| REG bundle size | 6 |
| CP length | Same as the CP length of RMSI |
| | CORESET |
| Mapping from REG to | Distributed |
| CCE | |

TABLE B.1-2
PDCCH transmission parameters for beam failure instance

| Attribute | Value for BLER |
|---|---|
| DCI format | 1-0 |
| Number of control OFDM | Same as the number of symbols of |
| symbols | CORESET QCLed with respective |
| | CSI-RS for BFD |
| Aggregation level (CCE) | 8 |
| Ratio of hypothetical | 0 dB |
| PDCCH RE energy to | |
| average CSI-RS RE energy | |
| Ratio of hypothetical | 0 dB |
| PDCCH DMRS energy to | |
| average CSI-RS RE energy | |
| Bandwidth (MHz) | Same as the number of PRBs of |
| | CORESET QCLed with respective |
| | CSI-RS for BFD |
| Sub-carrier spacing (kHz) | Same as the SCS of CORESET |
| | QCLed with respective CSI-RS |
| | for BFD |
| DMRS precoder | REG bundle size |
| granularity | |
| REG bundle size | 6 |
| CP length | Same as the CP length of |
| | CORESET QCLed with respective |
| | CSI-RS for BFD |
| Mapping from REG to | Distributed |
| CCE | |

The UE performs L1-RSRP measurements based on the reference signal in the set q̅₁ as specified herein in order to detect candidate beam. The RS resources in the set q̅₁ can be periodic CSI-RS resources and/or SSBs. UE is not required to perform candidate beam detection outside the active DL BWP. On each RS resource in the set q̅₁, the UE performs L1-RSRP measurements and compare it to the threshold Q_{in_LR} for the purpose of selecting new beam(s) for beam failure recovery. The threshold Q_{in_LR} corresponds to the value of higher layer parameter candidateBeamThreshold.

As alluded to previously, the UE is provided, for a serving cell, with a set q̅₀ of periodic CSI-RS resource configuration indexes by higher layer parameter failureDetectionResources and with a set q̅₁ of periodic CSI-RS resource configuration indexes and/or SS/PBCH block indexes by higher layer parameter candidateBeamRSList for radio link quality measurements on the serving cell. If the UE is not provided with higher layer parameterfailureDetectionResources, the UE determines the set q̅₀ to include periodic CSI-RS resource configuration indexes with same values as the RS indexes in the RS sets indicated by higher layer parameter TCI-states for respective control resource sets that the UE uses for monitoring PDCCH. The UE expects the set q̅₀ to include up to two RS indexes and, if there are two RS indexes in a TCI state, the set q̅₀ includes RS indexes with QCL-TypeD configuration for the corresponding TCI states. The UE expects single port RS in the set q̅₀. The thresholds Q_{out,LR} and Q_{in,LR} correspond to the default value of higher layer parameter rlmInSyncOutOfSyncThreshold for Qₒᵤₜ, and to the value provided by higher layer parameter rsrp-ThresholdSSB, respectively.

The physical layer in the UE assesses the radio link quality according to the set q̅₀ of resource configurations against the threshold Q_{out,LR}. For the set q̅₀, the UE assesses the radio link quality only according to periodic CSI-RS resource configurations or SS/PBCH blocks that are quasi co-located with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by higher layer parameter powerControlOffsetSS.

The physical layer in the UE provides an indication to higher layers when the radio link quality for all corresponding resource configurations in the set \hat{q}₀ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations and/or SS/PBCH blocks in the set go that the UE uses to assess the radio link quality and 2 msec.

Upon request from higher layers, the UE p.rovides to higher layers the periodic CSI-RS configuration indexes and/or SS/PBCH block indexes from the set q̅₁ and the corresponding L1-RSRP measurements that are larger than or equal to the Q_{in,LR} thresholdUpon request from higher layers, the UE provides to higher layers the periodic CSI-RS configuration indexes and/or SS/PBCH block indexes from the set q̅₁ and the corresponding L1-RSRP measurements that are larger than or equal to the Q_{in,LR} threshold.

The UE can be provided with a control resource set through a link to a search space set provided by higher layer parameter recoverySearchSpaceId for monitoring PDCCH in the control resource set. If the UE is provided higher layer parameter recoverySearchSpaceId, the UE does not expect to be provided another search space set for monitoring PDCCH in the control resource set associated with the search space set provided by recoverySearchSpaceId.

The UE may receive by higher layer parameter PRACH-ResourceDedicatedBFR, a configuration for PRACH transmission. For PRACH transmission in slot n and according to antenna port quasi co-location parameters associated with periodic CSI-RS resource configuration or with SS/PBCH block associated with index q_{new} provided by higher layers, the UE monitors PDCCH in a search space set provided by higher layer parameter recoverySearchSpaceId for detection of a DCI format with CRC scrambled by C-RNTI or MCS-C-RNTI starting from slot n+4 within a window configured by higher layer parameter BeamFailureRecoveryConfig. For the PDCCH monitoring and for the corresponding PDSCH reception, the UE assumes the same antenna port quasi-collocation parameters as the ones associated with index q_{new} until the UE receives by higher layers an activation for a TCI state or any of the parameters TCI-StatesPDCCH-ToAddlist and/or TCI-StatesPDCCH-ToReleaseList. After the UE detects a DCI format with CRC scrambled by C-RNTI or MCS-C-RNTI in the search space set provided by recoverySearchSpaceId, the UE continues to monitor PDCCH candidates in the search space set provided by recoverySearchSpaceId until the UE receives a MAC CE activation command for a TCI state or higher layer parameters TCI-StatesPDCCH-ToAddlist and/or TCI-StatesPDCCH-ToReleaseList.

If a beam failure indication has been received by a MAC entity from lower layers, then the MAC entity starts a beam failure recovery timer (beamFailureRecoveryTimer) and initiates a Random Access procedure. If the beamFailureRecoveryTimer expires, then the MAC entity indicates a beam failure recovery request failure to upper layers. If a DL assignment or UL grant has been received (e.g., on a PDCCH addressed for a cell radio network temporary identifier (C-RNTI)), then the MAC entity may stop and reset beamFailureRecoveryTimer and consider the beam failure recovery request procedure to be successfully completed.

For SSB based beam failure detection, the UE evaluates whether the downlink radio link quality on the configured SSB resource in set q estimated over the last T_{Evaluate_BFD_SSB} [ms] period becomes worse than the threshold Q_{out_LR_SSB} within T_{Evaluate_BFD_SSB} [ms] period. The value of T_{Evaluate_BFD_SSB} is defined in Table B.2-1 for FR1. The value of T_{Evaluate_BFD_SSB} is defined in Table B.2-2 for FR2 with N=1, if UE is not provided higher layer parameter failureDetectionResource and UE is provided by higher layer parameter TCI-state for PDCCH SSB that has QCL-TypeD, or if the SSB configured for BFD is QCL-Type D with DM-RS for PDCCH and the QCL association is known to UE, or if the SSB configured for BFD is QCL-Type D and TDMed to CSI-RS resources configured for L1-RSRP reporting and the QCL association is known to UE, and a CSI report with L1-RSRP measurement for the SSB configured for BFD has been made within [TBD] ms.

For FR1, P=1/(1−T_{SSB}/MGRP), when in the monitored cell there are measurement gaps configured for intra-frequency, inter-frequency or inter-RAT measurements, which are overlapping with some but not all occasions of the SSB; and P=1 when in the monitored cell there are no measurement gaps overlapping with any occasion of the SSB.

For FR2, P=1/(1−T_{SSB}/T_{SMTCperiod}), when BFD-RS is not overlapped with measurement gap and BFD-RS is partially overlapped with SMTC occasion (T_{SSB}<T_{SMTCperiod}). P is P_{sharing factor}, when BFD-RS is not overlapped with measurement gap and BFD-RS is fully overlapped with SMTC period (T_{SSB}=T_{SMTCperiod}). P is 1/(1−T_{SSB}/MGRP−T_{SSB}/T_{SMTCperiod}), when BFD-RS is partially overlapped with measurement gap and BFD-RS is partially overlapped with SMTC occasion (T_{SSB}<T_{SMTCperiod}) and SMTC occasion is not overlapped with measurement gap and T_{SMTCperiod}≠MGRP or T_{SMTCperiod}=MGRP and T_{SSB}<0.5*T_{SMTCperiod}. P is 1/(1−T_{SSB}/MGRP)*P_{sharing factor}, when BFD-RS is partially overlapped with measurement gap and BFD-RS is partially overlapped with SMTC occasion (T_{SSB}<T_{SMTCperiod}) and SMTC occasion is not overlapped with measurement gap and T_{SMTCperiod}=MGRP and T_{SSB}=0.5*T_{SMTCperiod}. P is 1/{1−T_{SSB}/min (T_{SMTCperiod},MGRP)}, when BFD-RS is partially overlapped with measurement gap (T_{SSB}<MGRP) and BFD-RS is partially overlapped with SMTC occasion (T_{SSB}<T_{SMTCperiod}) and SMTC occasion is partially or fully overlapped with measurement gap. P is 1/(1−T_{SSB}/MGRP)*P_{sharing factor}, when BFD-RS is partially overlapped with measurement gap and BFD-RS is fully overlapped with SMTC occasion (T_{SSB}=T_{SMTCperiod}) and SMTC occasion is partially overlapped with measurement gap (T_{SMTCperiod}<MGRP). P_{sharing factor}=3.

If the high layer signaling of smtc2 is configured, T_{SMTCperiod} corresponds to the value of higher layer parameter smtc2; Otherwise T_{SMTCperiod} corresponds to the value of higher layer parameter smtc1. Longer evaluation period would be expected if the combination of BFD-RS, SMTC occasion and measurement gap configurations does not meet pervious conditions.

TABLE B.2-1
Evaluation period TEvaluate_BFD_SSB for FR1

| Configuration | T_{Evaluate}_{_{—}}_{BFD}_{_{—}}_{SSB} (ms) |
|---|---|
| non-DRX | max([50], ceil(5*P)*T_{SSB}) |
| DRX cycle ≤320 ms | max([50], ceil(7.5*P)*max(T_{DRX}, T_{SSB})) |
| DRX cycle >320 ms | ceil(5*P)*T_{DRX} |

Note:
T_{SSB} is the periodicity of SSB in the set q̅₀. T_{DRX} is the DRX cycle length.

TABLE B.2-2
Evaluation period TEvaluate_BFD_out for FR2

| Configuration | T_{Evaluate}_{_{—}}_{BFD}_{_{—}}_{SSB} (ms) |
|---|---|
| non-DRX | max([50], ceil(5*P*N)*T_{SSB}) |
| DRX cycle ≤320 ms | max([50], ceil(7.5*P*N)*max(T_{DRX}, T_{SSB})) |
| DRX cycle >320 ms | ceil(5*P*N)*T_{DRX} |

Note:
T_{SSB} is the periodicity of SSB in the set q̅₀. T_{DRX} is the DRX cycle length.

For CSI-RS based beam failure detection, the UE evaluates whether the downlink radio link quality on the configured CSI-RS resource in set q̅₀ estimated over the last T_{Evaluate_BFD_CSI-RS} [ms] period becomes worse than the threshold Q_{out_LR_CSI-RS} within T_{Evaluate_BFD_CSI-RS} [ms] period. The value of T_{Evaluate_BFD_CSI-RS} is defined in Table B.2-3 for FR1. The value of T_{Evaluate_BFD_CSI-RS} is defined in Table B.2-4 for FR2 with N=1, if UE is not provided higher layer parameter RadioLinkMonitoringRS and UE is provided by higher layer parameter TCI-state for PDCCH CSI-RS that has QCL-TypeD, or if the CSI-RS configured for BFD is QCL-Type D with DM-RS for PDCCH and the QCL association is known to UE, or if the CSI-RS resource configured for BFD is QCL-Type D and TDMed to CSI-RS resources configured for L1-RSRP reporting or SSBs configured for L1-RSRP reporting, all CSI-RS resources configured for BFD are mutually TDMed, and the QCL association is known to UE and a CSI report with L1-RSRP measurement for the CSI-RS configured for BFD has been made within [TBD] ms.

For FR1, P=1/(1−T_{CSI-RS}/MGRP), when in the monitored cell there are measurement gaps configured for intra-frequency, inter-frequency or inter-RAT measurements, which are overlapping with some but not all occasions of the CSI-RS; and P=1 when in the monitored cell there are no measurement gaps overlapping with any occasion of the CSI-RS.

For FR2, P=1, when BFD-RS is not overlapped with measurement gap and also not overlapped with SMTC occasion. P=1/(1−T_{CSI-RS}/MGRP), when BFD-RS is partially overlapped with measurement gap and BFD-RS is not overlapped with SMTC occasion (T_{CSI-RS}<MGRP) P=1/(1−T_{CSI-RS}/T_{SMTCperiod}), when BFD-RS is not overlapped with measurement gap and BFD-RS is partially overlapped with SMTC occasion (T_{CSI-RS}<T_{SMTCperiod}). P is P_{sharing factor}, when BFD-RS is not overlapped with measurement gap and BFD-RS is fully overlapped with SMTC occasion (T_{CSI-RS}=T_{SMTCperiod}). P is 1/(1−T_{CSI-RS}/MGRP−T_{CSI-RS}/T_{SMTCperiod}), when BFD-RS is partially overlapped with measurement gap and BFD-RS is partially overlapped with SMTC occasion (T_{CSI-RS}<T_{SMTCperiod}) and SMTC occasion is not overlapped with measurement gap and T_{SMTCperiod}≠MGRP or T_{SMTCperiod}=MGRP and T_{CSI-RS}<0.5*T_{SMTCperiod}. P is 1/(1−T_{CSI-RS}/MGRP)*P_{sharing factor}, when BFD-RS is partially overlapped with measurement gap and BFD-RS is partially overlapped with SMTC occasion (T_{CSI-RS}<T_{SMTCperiod}) and SMTC occasion is not overlapped with measurement gap and T_{SMTCperiod}=MGRP and T_{CSI-RS}=0.5*T_{SMTCperiod}. P is 1/{1−T_{CSI-RS}/min (T_{SMTCperiod},MGRP)}, when BFD-RS is partially overlapped with measurement gap (T_{CSI-RS}<MGRP) and BFD-RS is partially overlapped with SMTC occasion (T_{CSI-RS}<T_{SMTCperiod}) and SMTC occasion is partially or fully overlapped with measurement gap. P is 1/(1−T_{CSI-RS}/MGRP)*P_{sharing factor}, when BFD-RS is partially overlapped with measurement gap and BFD-RS is fully overlapped with SMTC occasion (T_{CSI-RS}=T_{SMTCperiod}) and SMTC occasion is partially overlapped with measurement gap (T_{SMTCperiod}<MGRP). P_{sharing factor} is 3.

If the high layer signaling of smtc2 is configured, T_{SMTCperiod} corresponds to the value of higher layer parameter smtc2; Otherwise T_{SMTCperiod} corresponds to the value of higher layer parameter smtc1. Longer evaluation period would be expected if the combination of BFD-RS, SMTC occasion and measurement gap configurations does not meet pervious conditions. The values of M_{BFD} used in Table B.2-3 and Table B.2-4 are defined as M_{BFD}=10, if the CSI-RS resource configured for BFD is transmitted with Density=3.

TABLE B.2-3
Evaluation period TEvaluate_BFD_CSI-RS for FR1

| Configuration | T_{Evaluate}_{_{—}}_{BFD}_{_{—}}_{CSI-RS} (ms) |
|---|---|
| non-DRX | max([50], [M_{BFD} *P] * T_{CSI-RS}) |
| DRX cycle ≤320 ms | max([50], [1.5 × M_{BFD} *P]*max(T_{DRX}, T_{CSI-RS})) |
| DRX cycle >320 ms | [M_{BFD}*P] * T_{DRX} |

Note:
T_{CSI-RS} is the periodicity of CSI-RS resource in the set q̅₀. T_{DRX} is the DRX cycle length.

TABLE B.2-4
Evaluation period TEvaluate_BFD_CSI-RS for FR2

| Configuration | T_{Evaluate}_{_{—}}_{BFD}_{_{—}}_{CSI-RS} (ms) |
|---|---|
| non-DRX | max([50], [M_{BFD} *P*N] * T_{CSI-RS}) |
| DRX cycle ≤320 ms | max([50], [1.5 × M_{BFD}*P*N]*max(T_{DRX}, |
| | T_{CSI-RS})) |
| DRX cycle >320 ms | [M_{BFD} *P*N] * T_{DRX} |

Note:
T_{CSI-RS} is the periodicity of CSI-RS resource in the set q̅₀. T_{DRX} is the DRX cycle length.

### Scheduling Restrictions

In some embodiments, scheduling availability restrictions may apply when the UE is performing beam failure detection. For example, there are no scheduling restrictions due to beam failure detection performed on SSB configured as BFD-RS with the same SCS as PDSCH/PDCCH in FR1. When the UE supports simultaneousRxDataSSB-DiffNumerology there are no restrictions on scheduling availability due to beam failure detection based on SSB as BFD-RS. However, when the UE does not support simultaneousRxDataSSB-DiffNumerology the following restrictions apply due to beam failure detection based on SSB configured as BFD-RS: the UE is not expected to transmit PUCCH/PUSCH or receive PDCCH/PDSCH on SSB symbols to be measured for beam failure detection.

The following scheduling restrictions apply due to beam failure detection based on CSI-RS as BFD-RS: The UE is not expected to transmit PUCCH/PUSCH or receive PDCCH/PDSCH on CSI-RS symbols to be measured for beam failure detection.’ When intra-band carrier aggregation in FR1 is configured, the scheduling restrictions apply to all SCells that are aggregated in the same band as the PCell or PSCell. When inter-band carrier aggregation within FR1 is configured, there are no scheduling restrictions on FR1 serving cell(s) configured in other bands than the bands in which PCell or PSCell is configured.

The following scheduling restriction applies due to beam failure detection on an FR2 PCell and/or PSCell: If UE is not provided higher layer parameter failureDetectionResources and UE is provided by higher layer parameter TCI-state for PDCCH SSB/CSI-RS that has QCL-Type D, or if the SSB/CSI-RS for BFD is QCL-Type D with DM-RS for PDCCH. There are no scheduling restrictions due to beam failure detection performed with same SCS as PDSCH/PDCCH. Otherwise, the UE is not expected to transmit PUCCH/PUSCH or receive PDCCH/PDSCH on BFD-RS symbols to be measured for beam failure detection, except for RMSI PDCCH/PDSCH and PDCCH/PDSCH which is not required to be received by RRC_CONNECTED mode UE.

When intra-band carrier aggregation is configured, the following scheduling restrictions apply to all SCells configured in the same band as the PCell and/or PSCell on which beam failure is detected. For the case where no RSs are provided for BFD, or where BFD-RS is explicitly configured and is QCLed with active TCI state for PDCCH/PDSCH. There are no scheduling restrictions due to beam failure detection performed with a same SCS as PDSCH/PDCCH. When performing beam failure detection with a different SCS than PDSCH/PDCCH, for UEs which support simultaneousRxDataSSB-DiffNumerology there are no restrictions on scheduling availability due to beam failure detection. For UEs which do not support simultaneousRxDataSSB-DiffNumerology the UE is not expected to transmit PUCCH/PUSCH or receive PDCCH/PDSCH on SSB symbols to be measured for beam failure detection. For the case where BFD-RS is explicitly configured and is not QCLed with active TCI state for PDCCH/PDSCH. The UE is not expected to transmit PUCCH/PUSCH or receive PDCCH/PDSCH on BFD-RS symbols to be measured for beam failure detection.

There are no scheduling restrictions on FR1 serving cell(s) due to beam failure detection performed on FR2 serving PCell and/or PSCell. There are no scheduling restrictions on FR2 serving cell(s) due to beam failure detection performed on FR1 serving PCell and/or PSCell.

### Radio Link Monitoring (RLM) Aspects

Radio Link Monitoring (RLM) refers to mechanisms used by the UE (e.g., UE 301 of FIG. 3) for monitoring the downlink radio link quality of a primary cell for the purpose of indicating out-of-sync/in-sync status to higher layers. The UE is not required to monitor the downlink radio link quality in DL BWPs other than the active DL BWP on the primary cell.

If the UE is configured with an SCG, and the parameter rlf-TimersAndConstants is provided by the higher layers and is not set to release, the downlink radio link quality of the PSCell of the SCG is monitored by the UE for the purpose of indicating out-of-sync/in-sync status to higher layers. The UE is not required to monitor the downlink radio link quality in DL BWPs other than the active DL BWP on the PSCell.

The UE can be configured for each DL BWP of an SpCell with a set of resource indexes, through a corresponding set of higher layer parameters RadioLinkMonitoringRS, for radio link monitoring by higher layer parameterfailureDetectionResources. The UE is provided by higher layer parameter RadioLinkMonitoringRS, with either a CSI-RS resource configuration index, by higher layer parameter csi-RS-Index, or a SS/PBCH block index, by higher layer parameter ssb-Index. The UE can be configured with up to N_{LR-RM} RadioLinkMonitoringRS for link recovery procedures, as discussed infra, and radio link monitoring. From the N_{LR-RM} RadioLinkMonitoringRS, up to N_{RLM} RadioLinkMonitoringRS can be used for radio link monitoring depending on a maximum number L of candidate SS/PBCH blocks per half frame, and up to two RadioLinkMonitoringRS can be used for link recovery procedures.

If the UE is not provided higher layer parameter RadioLinkMonitoringRS and the UE is provided by higher layer parameter TCI-state for PDCCH one or more RSs that include one or more of a CSI-RS and/or a SS/PBCH block
the UE uses for radio link monitoring the RS provided for the active TCI state for PDCCH if the active TCI state for PDCCH includes only one RS
if the active TCI state for PDCCH includes two RS, the UE expects that one RS has QCL-TypeD and the UE uses the one RS for radio link monitoring; the UE does not expect both RS to have QCL-TypeD
the UE is not required to use for radio link monitoring an aperiodic RS

The UE is not expected to use more than N_{RLM} RadioLinkMonitoringRS for radio link monitoring when the UE is not provided higher layer parameter RadioLinkMonitoringRS.

Values of N_{LR-RLM} and N_{RLM} for different values of L are given in Table RLM-1.

TABLE RLM-1
N_{LR-RLM} and N_{RLM} as a function of maximum
number L of SS/PBCH blocks per half frame

| L | N_{LR-RLM} | N_{RLM} |
|---|---|---|
| 4 | 2 | 2 |
| 8 | 6 | 4 |
| 64 | 8 | 8 |

For a CSI-RS resource configuration, the higher layer parameter powerControlOffsetSS is not applicable and a UE expects to be provided only ‘No CDM’ from higher layer parameter cdm-Type, only ‘1’ and ‘3’ from higher layer parameter density, and only ‘1 port’ from higher layer parameter nrofPorts.

In non-DRX mode operation, the physical layer in the UE assesses once per indication period the radio link quality, evaluated over the previous time period against thresholds (Qₒᵤₜ and Qᵢₙ) configured by higher layer parameter rlmInSyncOutOfSyncThreshold. The UE determines the indication period as the maximum between the shortest periodicity for radio link monitoring resources and 10 msec.

In DRX mode operation, the physical layer in the UE assesses once per indication period the radio link quality, evaluated over the previous time period, against thresholds (Qₒᵤₜ and Qᵢₙ) provided by higher layer parameter rlmInSyncOutOfSyncThreshold. The UE determines the indication period as the maximum between the shortest periodicity for radio link monitoring resources and the DRX period.

The physical layer in the UE indicates, in frames where the radio link quality is assessed, out-of-sync to higher layers when the radio link quality is worse than the threshold Qₒᵤₜ for all resources in the set of resources for radio link monitoring. When the radio link quality is better than the threshold Qᵢₙ for any resource in the set of resources for radio link monitoring, the physical layer in the UE indicates, in frames where the radio link quality is assessed, in-sync to higher layers.

The UE is to monitor the downlink link quality based on the reference signal in the configured RLM-RS resource(s) in order to detect the downlink radio link quality of the PCell and PSCell. The configured RLM-RS resources can be all SSBs, or all CSI-RSs, or a mix of SSBs and CSI-RSs. UE is not required to perform RLM outside the active DL BWP. The Reference Signal for RLM (RLM-RS) resource is a resource out of the set of resources configured for RLM by higher layer parameter RLM-RS-List.

On each RLM-RS resource, the UE is to estimate the downlink radio link quality and compare it to the thresholds Qₒᵤₜ and Qᵢₙ for the purpose of monitoring downlink radio link quality of the cell.

The threshold Qₒᵤₜ is defined as the level at which the downlink radio link cannot be reliably received and is to correspond to the out-of-sync block error rate (BLERₒᵤₜ) as defined in Table RLM.1-1. For SSB based radio link monitoring, Qₒᵤₜ SSB is derived based on the hypothetical PDCCH transmission parameters listed in Table RLM.2-1. For CSI-RS based radio link monitoring, Q_{out_CSI-RS} is derived based on the hypothetical PDCCH transmission parameters listed in Table RLM.3-1.

The threshold Qᵢₙ is defined as the level at which the downlink radio link quality can be significantly more reliably received than at Qₒᵤₜ and is to correspond to the in-sync block error rate (BLERᵢₙ) as defined in Table RLM.1-1. For SSB based radio link monitoring, Q_{in_SSB} is derived based on the hypothetical PDCCH transmission parameters listed in Table RLM.2-2. For CSI-RS based radio link monitoring, Q_{in_CSI-RS} is derived based on the hypothetical PDCCH transmission parameters listed in Table RLM.3-2.

The out-of-sync block error rate (BLERₒᵤₜ) and in-sync block error rate (BLERᵢₙ) are determined from the network configuration via parameter RLM-IS-OOS-thresholdConfig or lmInSyncOutOfSyncThreshold signalled by higher layers. The network can configure one of the two pairs of out-of-sync and in-sync block error rates which are shown in Table RLM.1-1. When UE is not configured with RLM-IS-OOS-thresholdConfig from the network, UE determines out-of-sync and in-sync block error rates from Configuration #0 in Table RLM.1-1 as default.

TABLE RLM.1-1
Out-of-sync and in-sync block error rates

| Configuration | BLERₒᵤₜ | BLERᵢₙ |
|---|---|---|
| 0 | 10% | 2% |
| 1 | TBD | TBD |

UE is to be able to monitor up to X_{RLM-RS} RLM-RS resources of the same or different types in each corresponding carrier frequency range, where X_{RLM-RS} is specified in Table RLM.1-2, and meet the requirements as specified below.

TABLE RLM.1-2
Maximum number of RLM-RS resources XRLM-RS

| Maximum number of RLM-RS | Carrier frequency range of |
|---|---|
| resources, X_{RLM-RS} | PCell/PSCell |
| 2 | FR1, ≤3 GHz |
| 4 | FR1, >3 GHz |
| 8 | FR2 |

### Requirements for SSB Based Radio Link Monitoring

Each SSB based RLM-RS resource is configured for a PCell and/or a PSCell provided that the SSB configured for RLM are actually transmitted within UE active DL BWP during the entire evaluation period specified below.

TABLE RLM.2-1
PDCCH transmission parameters for out-of-sync

| | Value for | Value for |
|---|---|---|
| Attribute | BLER pair#0 | BLER pair#1 |
| DCI format | 1-0 | TBD |
| Number of control | Same as the number of symbols | |
| OFDM symbols | of RMSI CORESET | |
| Aggregation level (CCE) | 8 | |
| Ratio of hypothetical | 4 dB | |
| PDCCH RE energy to | | |
| average SSS RE energy | | |
| Ratio of hypothetical | 4 dB | |
| PDCCH DMRS energy | | |
| to average SSS RE | | |
| energy | | |
| Bandwidth (MHz) | Same as the number of PRBs of | |
| | RMSI CORESET | |
| Sub-carrier spacing | Same as the SCS of RMSI | |
| (kHz) | CORESET | |
| DMRS precoder | REG bundle size | |
| granularity | | |
| REG bundle size | 6 | |
| CP length | Same as the CP length of RMSI | |
| | CORESET | |
| Mapping from REG to | Distributed | |
| CCE | | |

TABLE RLM.2-2
PDCCH transmission parameters for in-sync

| | Value for | Value for |
|---|---|---|
| Attribute | BLER pair#0 | BLER pair#1 |
| DCI payload size | 1-0 | TBD |
| Number of control | Same as the number of symbols | |
| OFDM symbols | of RMSI CORESET | |
| Aggregation level (CCE) | 4 | |
| Ratio of hypothetical | 0 dB | |
| PDCCH RE energy to | | |
| average SSS RE energy | | |
| Ratio of hypothetical | 0 dB | |
| PDCCH DMRS energy | | |
| to average SSS RE | | |
| energy | | |
| Bandwidth (MHz) | Same as the number of PRBs of | |
| | RMSI CORESET | |
| Sub-carrier spacing | Same as the SCS of RMSI | |
| (kHz) | CORESET | |
| DMRS precoder | REG bundle size | |
| granularity | | |
| REG bundle size | 6 | |
| CP length | Same as the CP length of RMSI | |
| | CORESET | |
| Mapping from REG to | Distributed | |
| CCE | | |

### Requirements for CSI-RS Based Radio Link Monitoring

Each CSI-RS based RLM-RS resource is configured for a PCell and/or a PSCell provided that the CSI-RS configured for RLM are actually transmitted within UE active DL BWP during the entire evaluation period specified below.

TABLE RLM.3-1
PDCCH transmission parameters for out-of-sync

| | Value for | Value for |
|---|---|---|
| Attribute | BLER pair#0 | BLER pair#1 |
| DCI format | 1-0 | TBD |
| Number of control | Same as the number of symbols | |
| OFDM symbols | of CORESET QCLed with | |
| | respective CSI-RS for RLM | |
| Aggregation level (CCE) | 8 | |
| Ratio of hypothetical | 4 dB | |
| PDCCH RE energy to | | |
| average CSI-RS RE | | |
| energy | | |
| Ratio of hypothetical | 4 dB | |
| PDCCH DMRS energy | | |
| to average CSI-RS RE | | |
| energy | | |
| Bandwidth (MHz) | Same as the number of PRBs | |
| | of CORESET QCLed with | |
| | respective CSI-RS for RLM | |
| Sub-carrier spacing | Same as the SCS of CORESET | |
| (kHz) | QCLed with respective CSI-RS | |
| | for RLM | |
| DMRS precoder | REG bundle size | |
| granularity | | |
| REG bundle size | 6 | |
| CP length | Same as the CP length of | |
| | CORESET QCLed with | |
| | respective CSI-RS for RLM | |
| Mapping from REG to | Distributed | |
| CCE | | |

TABLE RLM.3-2
PDCCH transmission parameters for in-sync

| | Value for | Value for |
|---|---|---|
| Attribute | BLER pair#0 | BLER pair#1 |
| DCI payload size | 1-0 | TBD |
| Number of control | Same as the number of symbols | |
| OFDM symbols | of CORESET QCLed with | |
| | respective CSI-RS for RLM | |
| Aggregation level (CCE) | 4 | |
| Ratio of hypothetical | 0 dB | |
| PDCCH RE energy to | | |
| average CSI-RS RE | | |
| energy | | |
| Ratio of hypothetical | [0]dB | |
| PDCCH DMRS energy | | |
| to average CSI-RS RE | | |
| energy | | |
| Bandwidth (MHz) | Same as the number of PRBs | |
| | of CORESET QCLed with | |
| | respective CSI-RS for RLM | |
| Sub-carrier spacing | Same as the SCS of CORESET | |
| (kHz) | QCLed with respective CSI-RS | |
| | for RLM | |
| DMRS precoder | REG bundle size | |
| granularity | | |
| REG bundle size | 6 | |
| CP length | Same as the CP length of | |
| | CORESET QCLed with | |
| | respective CSI-RS for RLM | |
| Mapping from REG to | Distributed | |
| CCE | | |

CORESET is used as reference when CSI-RS is QCL-ed with multiple CORESETs. In some embodiments, the UE is to perform RLM and if so which CORESET is used as reference, when CSI-RS is not QCL-ed with any CORESET.

### Minimum Requirements at Transitions

When the UE transitions between DRX and non-DRX or when DRX cycle periodicity changes, for each RLM-RS resource, for a duration of time equal to the evaluation period corresponding to the second mode after the transition occurs, the UE shall use an evaluation period that is no less than the minimum of evaluation period corresponding to the first mode and the second mode. Subsequent to this duration, the UE shall use an evaluation period corresponding to the second mode for each RLM-RS resource. This requirement shall be applied to both out-of-sync evaluation and in-sync evaluation of the monitored cell.

When the UE transitions from a first configuration of RLM-RS resources to a second configuration of RLM-RS resources that is different from the first configuration, for each RLM-RS resource present in the second configuration, for a duration of time equal to the evaluation period corresponding to the second configuration after the transition occurs, the UE shall use an evaluation period that is no less than the minimum of evaluation periods corresponding to the first configuration and the second configuration. Subsequent to this duration, the UE shall use an evaluation period corresponding to the second configuration for each RLM-RS resource present in the second configuration. This requirement shall be applied to both out-of-sync evaluation and in-sync evaluation of the monitored cell.

### Minimum Requirements for UE Turning Off Transmitter

The transmitter power of the UE in the monitored cell shall be turned off within 40 ms after expiry of T310 timer.

### Minimum Requirement for L1 Indication

When the downlink radio link quality on all the configured RLM-RS resources is worse than Qₒᵤₜ, Layer 1 of the UE is to send an out-of-sync indication for the cell to the higher layers. A Layer 3 filter is to be applied to the out-of-sync indications.

When the downlink radio link quality on at least one of the configured RLM-RS resources is better than Qᵢₙ, Layer 1 of the UE is to send an in-sync indication for the cell to the higher layers. A Layer 3 filter is to be applied to the in-sync indications.

The out-of-sync and in-sync evaluations for the configured RLM-RS resources is to be performed. Two successive indications from Layer 1 is to be separated by at least T_{Indication_interval}.

When DRX is not used T_{Indication_interval} is max(10 ms, T_{RLM-RS,M}), where

T_{RLM,M} is the shortest periodicity of all configured RLM-RS resources for the monitored cell, which corresponds to T_{SSB} if the RLM-RS resource is SSB, or T_{CSI-RS} if the RLM-RS resource is CSI-RS.

In case DRX is used, T_{Indication} interval is max(10 ms, 1.5*DRX_cycle_length, 1.5*T_{RLM-RS,M}) if DRX cycle_length is less than or equal to 320 ms, and T_{Indication_interval} is DRX_cycle_length if DRX cycle_length is greater than 320 ms. Upon start of T310 timer as specified in TS 38.331 [2], the UE shall monitor the configured RLM-RS resources for recovery using the evaluation period and Layer 1 indication interval corresponding to the non-DRX mode until the expiry or stop of T310 timer.

### Scheduling Availability of UE During Radio Link Monitoring

When the reference signal to be measured for RLM has different subcarrier spacing than PDSCH/PDCCH and on frequency range FR2, there are restrictions on the scheduling availability as described below.

Scheduling Availability of UE Performing Radio Link Monitoring with a Same Subcarrier Spacing as PDSCH/PDCCH on FR1

There are no scheduling restrictions due to radio link monitoring performed with a same subcarrier spacing as PDSCH/PDCCH on FR1.

Scheduling Availability of UE Performing Radio Link Monitoring with a Different Subcarrier Spacing than PDSCH/PDCCH on FR1

For UE which support simultaneousRxDataSSB-DiffNumerology [14] there are no restrictions on scheduling availability due to radio link monitoring based on SSB as RLM-RS. For UE which do not support simultaneousRxDataSSB-DiffNumerology [14] the following restrictions apply due to radio link monitoring based on SSB as RLM-RS. The UE is not expected to transmit PUCCH/PUSCH or receive PDCCH/PDSCH on SSB symbols to be measured for radio link monitoring.

When intra-band carrier aggregation is performed, the scheduling restrictions apply to all serving cells on the band due to radio link monitoring performed on FR1 serving PCell or PSCell in the same band. When inter-band carrier aggregation within FR1 is performed, there are no scheduling restrictions on FR1 serving cell(s) in the bands due to radio link monitoring performed on FR1 serving PCell or PSCell in different bands.

### Scheduling Availability of UE Performing Radio Link Monitoring on FR2

The following scheduling restriction applies due to radio link monitoring on an FR2 serving PCell and/or PSCell.

If UE is not provided high layer parameter RadioLinkMonitoringRS and UE is provided by higher layer parameter TC-state for PDCCH SSB/CSI-RS that has QCL-Type D, or if the SSB/CSI-RS configured for RLM is QCL-Type D with DM-RS for PDCCH. There are no scheduling restrictions due to radio link monitoring performed with a same subcarrier spacing as PDSCH/PDCCH. Otherwise, the UE is not expected to transmit PUCCH/PUSCH or receive PDCCH/PDSCH on RLM-RS symbols to be measured for radio link monitoring, except for RMSI PDCCH/PDSCH and PDCCH/PDSCH which is not required to be received by RRC_CONNECTED mode UE.

When intra-band carrier aggregation is performed, for other serving cells on the band than FR2 serving PCell or PSCell in the same band, the following scheduling restriction applies due to radio link monitoring on an FR2 serving PCell and/or PSCell. If the RLM-RS is type-D QCLed with active TCI state for PDCCH/PDSCH, and N=1 applies for the RLM-RS as specified in section 8.1.2.2 if the RLM-RS is SSB if the RLM-RS is CSI-RS. There are no scheduling restrictions due to radio link monitoring performed with a same subcarrier spacing as PDSCH/PDCCH. When performing radio link monitoring with a different subcarrier spacing than PDSCH/PDCCH, for UE which support simultaneousRxDataSSB-DiffNumerology there are no restrictions on scheduling availability due to radio link monitoring. For UE which do not support simultaneousRxDataSSB-DiffNumerology the UE is not expected to transmit PUCCH/PUSCH or receive PDCCH/PDSCH on SSB symbols to be measured for radio link monitoring. Otherwise, the UE is not expected to transmit PUCCH/PUSCH or receive PDCCH/PDSCH on RLM-RS symbols to be measured for radio link monitoring.

### Scheduling Availability of UE Performing Radio Link Monitoring on FR1 or FR2 in Case of FR1-FR2 Inter-Band CA

There are no scheduling restrictions on FR1 serving cell(s) due to radio link monitoring performed on FR2 serving PCell and/or PSCell.

There are no scheduling restrictions on FR2 serving cell(s) due to radio link monitoring performed on FR1 serving PCell and/or PSCell.

### Link Recovery Procedures

The UE assesses the downlink link quality of a serving cell based on the reference signal in the set q̅₀ in order to detect beam failure instance. The RS resources in the set q̅₀ can be periodic CSI-RS resources and/or SSBs. The UE is not required to perform beam failure detection outside the active DL BWP. On each RS resource in the set q̅₀, the UE shall estimate the radio link quality and compare it to the threshold Q_{out_LR} for the purpose of accessing downlink radio link quality of the serving cell.

The threshold Q_{out_LR} is defined as the level at which the downlink radio level link cannot be reliably received and shall correspond to the BLERₒᵤₜ block error rate of a hypothetical PDCCH transmission. For SSB based beam failure detection, Q_{out_LR_SSB} is derived based on the hypothetical PDCCH transmission parameters listed elsewhere. For CSI-RS based beam failure detection, Q_{out_LR_CSI-RS} is derived based on the hypothetical PDCCH transmission parameters listed elsewhere.

The UE performs L1-RSRP measurements based on the reference signal in the set q̅₁. in order to detect candidate beam. The RS resources in the set q̅₁ can be periodic CSI-RS resources and/or SSBs. The UE is not required to perform candidate beam detection outside the active DL BWP.

On each RS resource in the set q̅₀ the UE shall perform L1-RSRP measurements and compare it to the threshold Q_{in_LR} for the purpose of selecting new beam(s) for beam failure recovery. The threshold Q_{in_LR} corresponds to the value of higher layer parameter candidateBeamThreshold.

In some embodiments, the set q̅₀ of periodic CSI-RS resource configuration indexes is indicated by the higher layer parameterfailureDetectionResources and with a set q̅₁ of periodic CSI-RS resource configuration indexes and/or SS/PBCH block indexes by higher layer parameter candidateBeamRSList for radio link quality measurements on the serving cell. If the UE is not provided with higher layer parameter failureDetectionResources, the UE determines the set q̅₀ to include SS/PBCH block indexes and periodic CSI-RS resource configuration indexes with same values as the RS indexes in the RS sets indicated by the TCI states for respective control resource sets that the UE uses for monitoring PDCCH. The UE expects the set q̅₀ to include up to two RS indexes and, if there are two RS indexes, the set q̅₀ includes only RS indexes with QCL-TypeD configuration for the corresponding TCI states. The UE expects single port RS in the set q̅₀.

The threshold Q_{out,LR} corresponds to the default value of higher layer parameter rlmInSyncOutOfSyncThreshold and to the value provided by higher layer parameter rsrp-ThresholdSSB, respectively.

The physical layer in the UE assesses the radio link quality according to the set q̅₀ of resource configurations against the threshold Q_{out,LR}. For the set q̅₀, the UE assesses the radio link quality only according to periodic CSI-RS resource configurations or SS/PBCH blocks that are quasi co-located, as described in, with the DM-RS of PDCCH receptions monitored by the UE. The UE applies the Q_{in,LR} threshold to the L1-RSRP measurement obtained from a SS/PBCH block. The UE applies the Q_{in,LR} threshold to the L1-RSRP measurement obtained for a CSI-RS resource after scaling a respective CSI-RS reception power with a value provided by higher layer parameter powerControlOffsetSS.

The physical layer in the UE provides an indication to higher layers when the radio link quality for all corresponding resource configurations in the set q̅₀ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity of periodic CSI-RS configurations or SS/PBCH blocks in the set q̅₀ that the UE uses to assess the radio link quality and 2 msec.

Upon request from higher layers, the UE provides to higher layers the periodic CSI-RS configuration indexes and/or SS/PBCH block indexes from the set q and the corresponding L1-RSRP measurements that are larger than or equal to the corresponding thresholds.

The UE may be provided with a CORESET through a link to a search space set provided by higher layer parameter recoverySearchSpaceId for monitoring PDCCH in the control resource set. If the UE is provided higher layer parameter recoverySearchSpaceId, the UE does not expect to be provided another search space set for monitoring PDCCH in the control resource set associated with the search space set provided by recoverySearchSpaceId.

The UE may receive by higher layer parameter PRACH-ResourceDedicatedBFR, a configuration for PRACH transmission. For PRACH transmission in slot n and according to antenna port quasi co-location parameters associated with periodic CSI-RS configuration or SS/PBCH block with index q_{new} provided by higher layers, the UE monitors PDCCH in a search space provided by higher layer parameter recoverySearchSpaceId for detection of a DCI format with CRC scrambled by C-RNTI starting from slot n+4 within a window configured by higher layer parameter BeamFailureRecoveryConfig. For the PDCCH monitoring and for the corresponding PDSCH reception, the UE assumes the same antenna port quasi-collocation parameters with index q_{new} until the UE receives by higher layers an activation for a TCI state or any of the parameters TCI-StatesPDCCH-ToAddlist and/or TCI-StatesPDCCH-ToReleaseList. After the UE detects a DCI format with CRC scrambled by C-RNTI in the search space provided by recoverySearchSpaceId, the UE monitors PDCCH candidates in the search space provided by recoverySearchSpaceId until the UE receives a MAC CE activation command for a TCI state or higher layer parameters TCI-StatesPDCCH-ToAddlist and/or TCI-StatesPDCCH-ToReleaseList.

If the UE is not provided a control resource set for a search space set provided recoverySearchSpaceId or if the UE is not provided recoverySearchSpaceId, the UE does not expect to receive a PDCCH order triggering a PRACH transmission.

### Systems and Implementations

FIG. 3 illustrates an example architecture of a system 300 of a network, in accordance with various embodiments. The following description is provided for an example system 300 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 3, the system 300 includes UE 301a and UE 301b (collectively referred to as “UEs 301” or “UE 301”). In this example, UEs 301 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 301 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 301 may be configured to connect, for example, communicatively couple, with an or RAN 310. In embodiments, the RAN 310 may be an NG RAN or a 5G RAN, an E-UTRAN, or a legacy RAN, such as a UTRAN or GERAN. As used herein, the term “NG RAN” or the like may refer to a RAN 310 that operates in an NR or 5G system 300, and the term “E-UTRAN” or the like may refer to a RAN 310 that operates in an LTE or 4G system 300. The UEs 301 utilize connections (or channels) 303 and 304, respectively, each of which comprises a physical communications interface or layer (discussed in further detail below).

In this example, the connections 303 and 304 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 301 may directly exchange communication data via a ProSe interface 305. The ProSe interface 305 may alternatively be referred to as a SL interface 305 and may comprise one or more logical channels, including but not limited to a PSCCH, a PSSCH, a PSDCH, and a PSBCH.

The UE 301b is shown to be configured to access an AP 306 (also referred to as “WLAN node 306,” “WLAN 306,” “WLAN Termination 306,” “WT 306” or the like) via connection 307. The connection 307 can comprise a local wireless connection, such as a connection consistent with any IEEE 802.11 protocol, wherein the AP 306 would comprise a wireless fidelity (Wi-Fi®) router. In this example, the AP 306 is shown to be connected to the Internet without connecting to the core network of the wireless system (described in further detail below). In various embodiments, the UE 301b, RAN 310, and AP 306 may be configured to utilize LWA operation and/or LWIP operation. The LWA operation may involve the UE 301b in RRC_CONNECTED being configured by a RAN node 311a-b to utilize radio resources of LTE and WLAN. LWIP operation may involve the UE 301b using WLAN radio resources (e.g., connection 307) via IPsec protocol tunneling to authenticate and encrypt packets (e.g., IP packets) sent over the connection 307. IPsec tunneling may include encapsulating the entirety of original IP packets and adding a new packet header, thereby protecting the original header of the IP packets.

The RAN 310 can include one or more AN nodes or RAN nodes 311a and 311b (collectively referred to as “RAN nodes 311” or “RAN node 311”) that enable the connections 303 and 304. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 311 that operates in an NR or 5G system 300 (e.g., a gNB), and the term “E-UTRAN node” or the like may refer to a RAN node 311 that operates in an LTE or 4G system 300 (e.g., an eNB). According to various embodiments, the RAN nodes 311 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

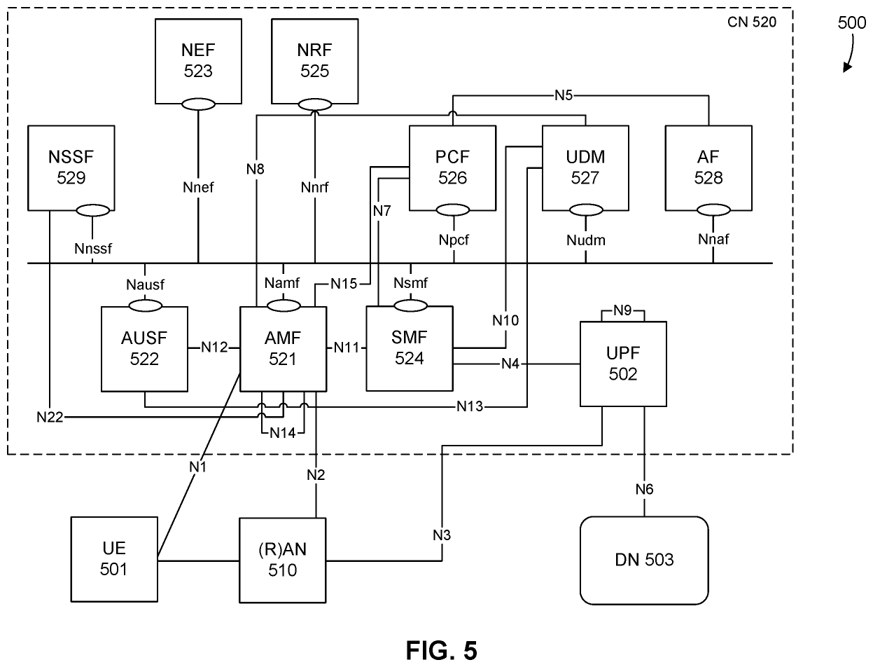

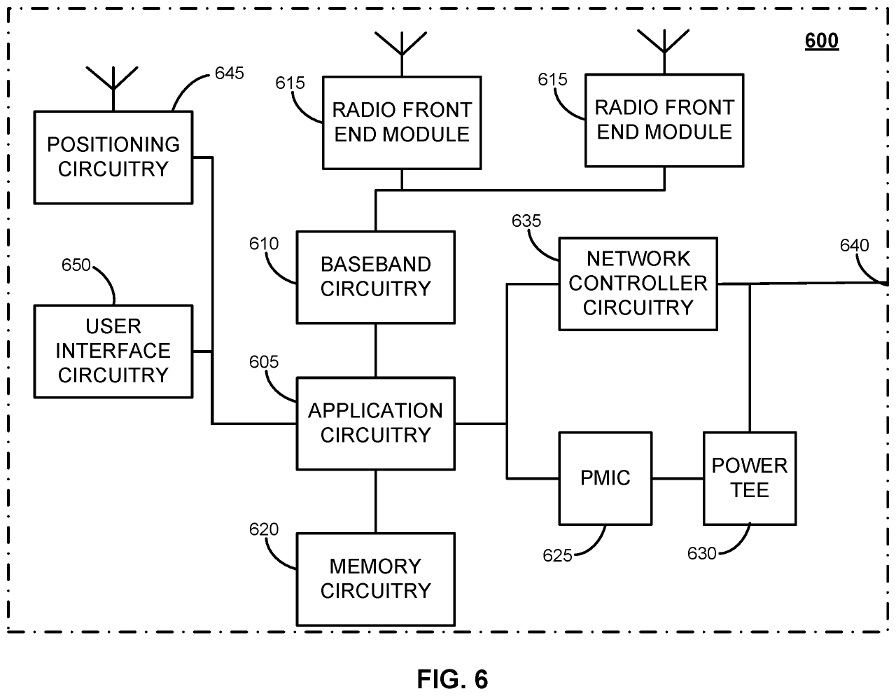

In some embodiments, all or parts of the RAN nodes 311 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 311; a MAC/PHY split wherein RRC, PDCP, RLC, and MAC layers are operated by the CRAN/vBBUP and the PHY layer is operated by individual RAN nodes 311; or a “lower PHY” split wherein RRC, PDCP, RLC, MAC layers and upper portions of the PHY layer are operated by the CRAN/vBBUP and lower portions of the PHY layer are operated by individual RAN nodes 311. This virtualized framework allows the freed-up processor cores of the RAN nodes 311 to perform other virtualized applications. In some implementations, an individual RAN node 311 may represent individual gNB-DUs that are connected to a gNB-CU via individual F1 interfaces (not shown by FIG. 3). In these implementations, the gNB-DUs may include one or more remote radio heads or RFEMs (see, e.g., FIG. 6), and the gNB-CU may be operated by a server that is located in the RAN 310 (not shown) or by a server pool in a similar manner as the CRAN/vBBUP. Additionally or alternatively, one or more of the RAN nodes 311 may be next generation eNBs (ng-eNBs), which are RAN nodes that provide E-UTRA user plane and control plane protocol terminations toward the UEs 301, and are connected to a 5GC (e.g., CN 520 of FIG. 5) via an NG interface (discussed infra).

In V2X scenarios one or more of the RAN nodes 311 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 301 (vUEs 301). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 311 can terminate the air interface protocol and can be the first point of contact for the UEs 301. In some embodiments, any of the RAN nodes 311 can fulfill various logical functions for the RAN 310 including, but not limited to, radio network controller (RNC) functions such as radio bearer management, uplink and downlink dynamic radio resource management and data packet scheduling, and mobility management.

In embodiments, the UEs 301 can be configured to communicate using OFDM communication signals with each other or with any of the RAN nodes 311 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 311 to the UEs 301, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 301 and the RAN nodes 311 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 301 and the RAN nodes 311 may operate using LAA, eLAA, and/or feLAA mechanisms. In these implementations, the UEs 301 and the RAN nodes 311 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (e.g., UEs 301, RAN nodes 311, etc.) senses a medium (e.g., a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 301, AP 306, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (s); however, the size of the CWS and a MCOT (e.g., a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 301 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 301. The PDCCH carries information about the transport format and resource allocations related to the PDSCH channel, among other things. It may also inform the UEs 301 about the transport format, resource allocation, and HARQ information related to the uplink shared channel. Typically, downlink scheduling (assigning control and shared channel resource blocks to the UE 301b within a cell) may be performed at any of the RAN nodes 311 based on channel quality information fed back from any of the UEs 301. The downlink resource assignment information may be sent on the PDCCH used for (e.g., assigned to) each of the UEs 301.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

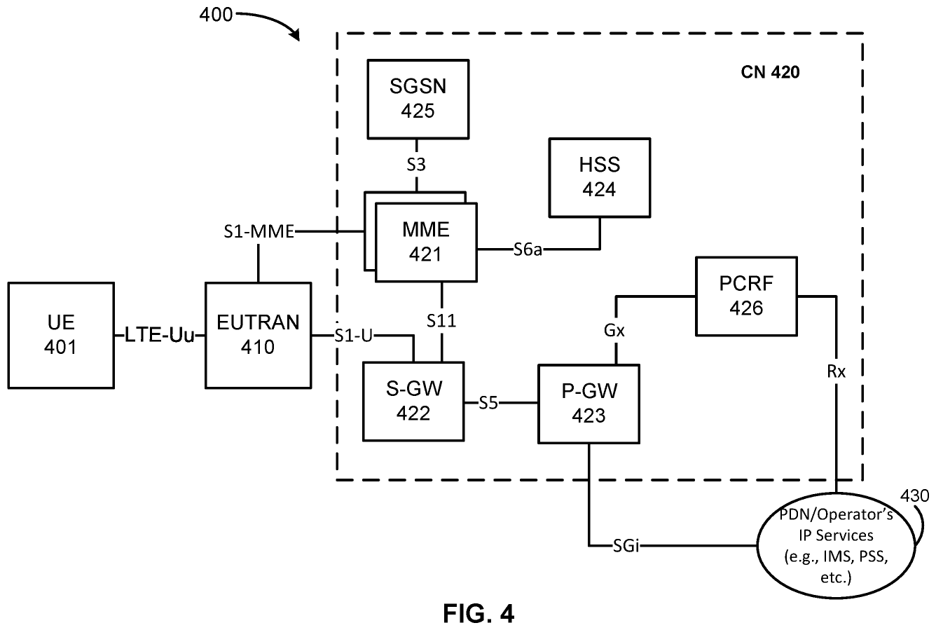

The RAN nodes 311 may be configured to communicate with one another via interface 312. In embodiments where the system 300 is an LTE system (e.g., when CN 320 is an EPC 420 as in FIG. 4), the interface 312 may be an X2 interface 312. The X2 interface may be defined between two or more RAN nodes 311 (e.g., two or more eNBs and the like) that connect to EPC 320, and/or between two eNBs connecting to EPC 320. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 301 from an SeNB for user data; information of PDCP PDUs that were not delivered to a UE 301; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 300 is a 5G or NR system (e.g., when CN 320 is an 5GC 520 as in FIG. 5), the interface 312 may be an Xn interface 312. The Xn interface is defined between two or more RAN nodes 311 (e.g., two or more gNBs and the like) that connect to 5GC 320, between a RAN node 311 (e.g., a gNB) connecting to 5GC 320 and an eNB, and/or between two eNBs connecting to 5GC 320. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 301 in a connected mode (e.g., CM-CONNECTED) including functionality to manage the UE mobility for connected mode between one or more RAN nodes 311. The mobility support may include context transfer from an old (source) serving RAN node 311 to new (target) serving RAN node 311; and control of user plane tunnels between old (source) serving RAN node 311 to new (target) serving RAN node 311. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 310 is shown to be communicatively coupled to a core network—in this embodiment, core network (CN) 320. The CN 320 may comprise a plurality of network elements 322, which are configured to offer various data and telecommunications services to customers/subscribers (e.g., users of UEs 301) who are connected to the CN 320 via the RAN 310. The components of the CN 320 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 320 may be referred to as a network slice, and a logical instantiation of a portion of the CN 320 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 330 may be an element offering applications that use IP bearer resources with the core network (e.g., UMTS PS domain, LTE PS data services, etc.). The application server 330 can also be configured to support one or more communication services (e.g., VoIP sessions, PTT sessions, group communication sessions, social networking services, etc.) for the UEs 301 via the EPC 320.

In embodiments, the CN 320 may be a 5GC (referred to as “5GC 320” or the like), and the RAN 310 may be connected with the CN 320 via an NG interface 313. In embodiments, the NG interface 313 may be split into two parts, an NG user plane (NG-U) interface 314, which carries traffic data between the RAN nodes 311 and a UPF, and the S1 control plane (NG-C) interface 315, which is a signaling interface between the RAN nodes 311 and AMFs. Embodiments where the CN 320 is a 5GC 320 are discussed in more detail with regard to FIG. 5.

In embodiments, the CN 320 may be a 5G CN (referred to as “5GC 320” or the like), while in other embodiments, the CN 320 may be an EPC). Where CN 320 is an EPC (referred to as “EPC 320” or the like), the RAN 310 may be connected with the CN 320 via an S1 interface 313. In embodiments, the S1 interface 313 may be split into two parts, an S1 user plane (S1-U) interface 314, which carries traffic data between the RAN nodes 311 and the S-GW, and the S1-MME interface 315, which is a signaling interface between the RAN nodes 311 and MMEs. An example architecture wherein the CN 320 is an EPC 320 is shown by FIG. 4.

FIG. 4 illustrates an example architecture of a system 400 including a first CN 420, in accordance with various embodiments. In this example, system 400 may implement the LTE standard wherein the CN 420 is an EPC 420 that corresponds with CN 320 of FIG. 3. Additionally, the UE 401 may be the same or similar as the UEs 301 of FIG. 3, and the E-UTRAN 410 may be a RAN that is the same or similar to the RAN 310 of FIG. 3, and which may include RAN nodes 311 discussed previously. The CN 420 may comprise MMEs 421, an S-GW 422, a P-GW 423, a HSS 424, and a SGSN 425.

The MMEs 421 may be similar in function to the control plane of legacy SGSN, and may implement MM functions to keep track of the current location of a UE 401. The MMEs 421 may perform various MM procedures to manage mobility aspects in access such as gateway selection and tracking area list management. MM (also referred to as “EPS MM” or “EMM” in E-UTRAN systems) may refer to all applicable procedures, methods, data storage, etc. that are used to maintain knowledge about a present location of the UE 401, provide user identity confidentiality, and/or perform other like services to users/subscribers. Each UE 401 and the MME 421 may include an MM or EMM sublayer, and an MM context may be established in the UE 401 and the MME 421 when an attach procedure is successfully completed. The MM context may be a data structure or database object that stores MM-related information of the UE 401. The MMEs 421 may be coupled with the HSS 424 via an S6a reference point, coupled with the SGSN 425 via an S3 reference point, and coupled with the S-GW 422 via an S11 reference point.

The SGSN 425 may be a node that serves the UE 401 by tracking the location of an individual UE 401 and performing security functions. In addition, the SGSN 425 may perform Inter-EPC node signaling for mobility between 2G/3G and E-UTRAN 3GPP access networks; PDN and S-GW selection as specified by the MMEs 421; handling of UE 401 time zone functions as specified by the MMEs 421; and MME selection for handovers to E-UTRAN 3GPP access network. The S3 reference point between the MMEs 421 and the SGSN 425 may enable user and bearer information exchange for inter-3GPP access network mobility in idle and/or active states.

The HSS 424 may comprise a database for network users, including subscription-related information to support the network entities' handling of communication sessions. The EPC 420 may comprise one or several HSSs 424, depending on the number of mobile subscribers, on the capacity of the equipment, on the organization of the network, etc. For example, the HSS 424 can provide support for routing/roaming, authentication, authorization, naming/addressing resolution, location dependencies, etc. An S6a reference point between the HSS 424 and the MMEs 421 may enable transfer of subscription and authentication data for authenticating/authorizing user access to the EPC 420 between HSS 424 and the MMEs 421.

The S-GW 422 may terminate the S1 interface 313 (“S1-U” in FIG. 4) toward the RAN 410, and routes data packets between the RAN 410 and the EPC 420. In addition, the S-GW 422 may be a local mobility anchor point for inter-RAN node handovers and also may provide an anchor for inter-3GPP mobility. Other responsibilities may include lawful intercept, charging, and some policy enforcement. The S11 reference point between the S-GW 422 and the MMEs 421 may provide a control plane between the MMEs 421 and the S-GW 422. The S-GW 422 may be coupled with the P-GW 423 via an S5 reference point.

The P-GW 423 may terminate an SGi interface toward a PDN 430. The P-GW 423 may route data packets between the EPC 420 and external networks such as a network including the application server 330 (alternatively referred to as an “AF”) via an IP interface 325 (see e.g., FIG. 3). In embodiments, the P-GW 423 may be communicatively coupled to an application server (application server 330 of FIG. 3 or PDN 430 in FIG. 4) via an IP communications interface 325 (see, e.g., FIG. 3). The S5 reference point between the P-GW 423 and the S-GW 422 may provide user plane tunneling and tunnel management between the P-GW 423 and the S-GW 422. The S5 reference point may also be used for S-GW 422 relocation due to UE 401 mobility and if the S-GW 422 needs to connect to a non-collocated P-GW 423 for the required PDN connectivity. The P-GW 423 may further include a node for policy enforcement and charging data collection (e.g., PCEF (not shown)). Additionally, the SGi reference point between the P-GW 423 and the packet data network (PDN) 430 may be an operator external public, a private PDN, or an intra operator packet data network, for example, for provision of IMS services. The P-GW 423 may be coupled with a PCRF 426 via a Gx reference point.

PCRF 426 is the policy and charging control element of the EPC 420. In a non-roaming scenario, there may be a single PCRF 426 in the Home Public Land Mobile Network (HPLMN) associated with a UE 401's Internet Protocol Connectivity Access Network (IP-CAN) session. In a roaming scenario with local breakout of traffic, there may be two PCRFs associated with a UE 401's IP-CAN session, a Home PCRF (H-PCRF) within an HPLMN and a Visited PCRF (V-PCRF) within a Visited Public Land Mobile Network (VPLMN). The PCRF 426 may be communicatively coupled to the application server 430 via the P-GW 423. The application server 430 may signal the PCRF 426 to indicate a new service flow and select the appropriate QoS and charging parameters. The PCRF 426 may provision this rule into a PCEF (not shown) with the appropriate TFT and QCI, which commences the QoS and charging as specified by the application server 430. The Gx reference point between the PCRF 426 and the P-GW 423 may allow for the transfer of QoS policy and charging rules from the PCRF 426 to PCEF in the P-GW 423. An Rx reference point may reside between the PDN 430 (or “AF 430”) and the PCRF 426.

FIG. 5 illustrates an architecture of a system 500 including a second CN 520 in accordance with various embodiments. The system 500 is shown to include a UE 501, which may be the same or similar to the UEs 301 and UE 401 discussed previously; a (R)AN 510, which may be the same or similar to the RAN 310 and RAN 410 discussed previously, and which may include RAN nodes 311 discussed previously; and a DN 503, which may be, for example, operator services, Internet access or 3rd party services; and a 5GC 520. The 5GC 520 may include an AUSF 522; an AMF 521; a SMF 524; a NEF 523; a PCF 526; a NRF 525; a UDM 527; an AF 528; a UPF 502; and a NSSF 529.

The UPF 502 may act as an anchor point for intra-RAT and inter-RAT mobility, an external PDU session point of interconnect to DN 503, and a branching point to support multi-homed PDU session. The UPF 502 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 502 may include an uplink classifier to support routing traffic flows to a data network. The DN 503 may represent various network operator services, Internet access, or third party services. DN 503 may include, or be similar to, application server 330 discussed previously. The UPF 502 may interact with the SMF 524 via an N4 reference point between the SMF 524 and the UPF 502.

The AUSF 522 may store data for authentication of UE 501 and handle authentication-related functionality. The AUSF 522 may facilitate a common authentication framework for various access types. The AUSF 522 may communicate with the AMF 521 via an N12 reference point between the AMF 521 and the AUSF 522; and may communicate with the UDM 527 via an N13 reference point between the UDM 527 and the AUSF 522. Additionally, the AUSF 522 may exhibit an Nausf service-based interface.

The AMF 521 may be responsible for registration management (e.g., for registering UE 501, etc.), connection management, reachability management, mobility management, and lawful interception of AMF-related events, and access authentication and authorization. The AMF 521 may be a termination point for the an N11 reference point between the AMF 521 and the SMF 524. The AMF 521 may provide transport for SM messages between the UE 501 and the SMF 524, and act as a transparent proxy for routing SM messages. AMF 521 may also provide transport for SMS messages between UE 501 and an SMSF (not shown by FIG. 5). AMF 521 may act as SEAF, which may include interaction with the AUSF 522 and the UE 501, receipt of an intermediate key that was established as a result of the UE 501 authentication process. Where USIM based authentication is used, the AMF 521 may retrieve the security material from the AUSF 522. AMF 521 may also include a SCM function, which receives a key from the SEA that it uses to derive access-network specific keys. Furthermore, AMF 521 may be a termination point of a RAN CP interface, which may include or be an N2 reference point between the (R)AN 510 and the AMF 521; and the AMF 521 may be a termination point of NAS (N1) signalling, and perform NAS ciphering and integrity protection.

AMF 521 may also support NAS signalling with a UE 501 over an N3 IWF interface. The N3IWF may be used to provide access to untrusted entities. N3IWF may be a termination point for the N2 interface between the (R)AN 510 and the AMF 521 for the control plane, and may be a termination point for the N3 reference point between the (R)AN 510 and the UPF 502 for the user plane. As such, the AMF 521 may handle N2 signalling from the SMF 524 and the AMF 521 for PDU sessions and QoS, encapsulate/de-encapsulate packets for IPSec and N3 tunnelling, mark N3 user-plane packets in the uplink, and enforce QoS corresponding to N3 packet marking taking into account QoS requirements associated with such marking received over N2. N3IWF may also relay uplink and downlink control-plane NAS signalling between the UE 501 and AMF 521 via an N1 reference point between the UE 501 and the AMF 521, and relay uplink and downlink user-plane packets between the UE 501 and UPF 502. The N3IWF also provides mechanisms for IPsec tunnel establishment with the UE 501. The AMF 521 may exhibit an Namf service-based interface, and may be a termination point for an N14 reference point between two AMFs 521 and an N17 reference point between the AMF 521 and a 5G-EIR (not shown by FIG. 5).

The UE 501 may need to register with the AMF 521 in order to receive network services. RM is used to register or deregister the UE 501 with the network (e.g., AMF 521), and establish a UE context in the network (e.g., AMF 521). The UE 501 may operate in an RM-REGISTERED state or an RM-DEREGISTERED state. In the RM-DEREGISTERED state, the UE 501 is not registered with the network, and the UE context in AMF 521 holds no valid location or routing information for the UE 501 so the UE 501 is not reachable by the AMF 521. In the RM-REGISTERED state, the UE 501 is registered with the network, and the UE context in AMF 521 may hold a valid location or routing information for the UE 501 so the UE 501 is reachable by the AMF 521. In the RM-REGISTERED state, the UE 501 may perform mobility Registration Update procedures, perform periodic Registration Update procedures triggered by expiration of the periodic update timer (e.g., to notify the network that the UE 501 is still active), and perform a Registration Update procedure to update UE capability information or to re-negotiate protocol parameters with the network, among others.

The AMF 521 may store one or more RM contexts for the UE 501, where each RM context is associated with a specific access to the network. The RM context may be a data structure, database object, etc. that indicates or stores, inter alia, a registration state per access type and the periodic update timer. The AMF 521 may also store a 5GC MM context that may be the same or similar to the (E)MM context discussed previously. In various embodiments, the AMF 521 may store a CE mode B Restriction parameter of the UE 501 in an associated MM context or RM context. The AMF 521 may also derive the value, when needed, from the UE's usage setting parameter already stored in the UE context (and/or MM/RM context).

CM may be used to establish and release a signaling connection between the UE 501 and the AMF 521 over the N1 interface. The signaling connection is used to enable NAS signaling exchange between the UE 501 and the CN 520, and comprises both the signaling connection between the UE and the AN (e.g., RRC connection or UE-N3IWF connection for non-3GPP access) and the N2 connection for the UE 501 between the AN (e.g., RAN 510) and the AMF 521. The UE 501 may operate in one of two CM states, CM-IDLE mode or CM-CONNECTED mode. When the UE 501 is operating in the CM-IDLE state/mode, the UE 501 may have no NAS signaling connection established with the AMF 521 over the N1 interface, and there may be (R)AN 510 signaling connection (e.g., N2 and/or N3 connections) for the UE 501. When the UE 501 is operating in the CM-CONNECTED state/mode, the UE 501 may have an established NAS signaling connection with the AMF 521 over the N1 interface, and there may be a (R)AN 510 signaling connection (e.g., N2 and/or N3 connections) for the UE 501. Establishment of an N2 connection between the (R)AN 510 and the AMF 521 may cause the UE 501 to transition from CM-IDLE mode to CM-CONNECTED mode, and the UE 501 may transition from the CM-CONNECTED mode to the CM-IDLE mode when N2 signaling between the (R)AN 510 and the AMF 521 is released.

The SMF 524 may be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to management of a PDU session, and a PDU session or “session” may refer to a PDU connectivity service that provides or enables the exchange of PDUs between a UE 501 and a data network (DN) 503 identified by a Data Network Name (DNN). PDU sessions may be established upon UE 501 request, modified upon UE 501 and 5GC 520 request, and released upon UE 501 and 5GC 520 request using NAS SM signaling exchanged over the N1 reference point between the UE 501 and the SMF 524. Upon request from an application server, the 5GC 520 may trigger a specific application in the UE 501. In response to receipt of the trigger message, the UE 501 may pass the trigger message (or relevant parts/information of the trigger message) to one or more identified applications in the UE 501. The identified application(s) in the UE 501 may establish a PDU session to a specific DNN. The SMF 524 may check whether the UE 501 requests are compliant with user subscription information associated with the UE 501. In this regard, the SMF 524 may retrieve and/or request to receive update notifications on SMF 524 level subscription data from the UDM 527.

The SMF 524 may include the following roaming functionality: handling local enforcement to apply QoS SLAs (VPLMN); charging data collection and charging interface (VPLMN); lawful intercept (in VPLMN for SM events and interface to LI system); and support for interaction with external DN for transport of signalling for PDU session authorization/authentication by external DN. An N16 reference point between two SMFs 524 may be included in the system 500, which may be between another SMF 524 in a visited network and the SMF 524 in the home network in roaming scenarios. Additionally, the SMF 524 may exhibit the Nsmf service-based interface.

The NEF 523 may provide means for securely exposing the services and capabilities provided by 3GPP network functions for third party, internal exposure/re-exposure, Application Functions (e.g., AF 528), edge computing or fog computing systems, etc. In such embodiments, the NEF 523 may authenticate, authorize, and/or throttle the AFs. NEF 523 may also translate information exchanged with the AF 528 and information exchanged with internal network functions. For example, the NEF 523 may translate between an AF-Service-Identifier and an internal 5GC information. NEF 523 may also receive information from other network functions (NFs) based on exposed capabilities of other network functions. This information may be stored at the NEF 523 as structured data, or at a data storage NF using standardized interfaces. The stored information can then be re-exposed by the NEF 523 to other NFs and AFs, and/or used for other purposes such as analytics. Additionally, the NEF 523 may exhibit an Nnef service-based interface.

The NRF 525 may support service discovery functions, receive NF discovery requests from NF instances, and provide the information of the discovered NF instances to the NF instances. NRF 525 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 525 may exhibit the Nnrf service-based interface.

The PCF 526 may provide policy rules to control plane function(s) to enforce them, and may also support unified policy framework to govern network behaviour. The PCF 526 may also implement an FE to access subscription information relevant for policy decisions in a UDR of the UDM 527. The PCF 526 may communicate with the AMF 521 via an N15 reference point between the PCF 526 and the AMF 521, which may include a PCF 526 in a visited network and the AMF 521 in case of roaming scenarios. The PCF 526 may communicate with the AF 528 via an N5 reference point between the PCF 526 and the AF 528; and with the SMF 524 via an N7 reference point between the PCF 526 and the SMF 524. The system 500 and/or CN 520 may also include an N24 reference point between the PCF 526 (in the home network) and a PCF 526 in a visited network. Additionally, the PCF 526 may exhibit an Npcf service-based interface.

The UDM 527 may handle subscription-related information to support the network entities' handling of communication sessions, and may store subscription data of UE 501. For example, subscription data may be communicated between the UDM 527 and the AMF 521 via an N8 reference point between the UDM 527 and the AMF. The UDM 527 may include two parts, an application FE and a UDR (the FE and UDR are not shown by FIG. 5). The UDR may store subscription data and policy data for the UDM 527 and the PCF 526, and/or structured data for exposure and application data (including PFDs for application detection, application request information for multiple UEs 501) for the NEF 523. The Nudr service-based interface may be exhibited by the UDR 221 to allow the UDM 527, PCF 526, and NEF 523 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 524 via an N10 reference point between the UDM 527 and the SMF 524. UDM 527 may also support SMS management, wherein an SMS-FE implements the similar application logic as discussed previously. Additionally, the UDM 527 may exhibit the Nudm service-based interface.

The AF 528 may provide application influence on traffic routing, provide access to the NCE, and interact with the policy framework for policy control. The NCE may be a mechanism that allows the 5GC 520 and AF 528 to provide information to each other via NEF 523, which may be used for edge computing implementations. In such implementations, the network operator and third party services may be hosted close to the UE 501 access point of attachment to achieve an efficient service delivery through the reduced end-to-end latency and load on the transport network. For edge computing implementations, the 5GC may select a UPF 502 close to the UE 501 and execute traffic steering from the UPF 502 to DN 503 via the N6 interface. This may be based on the UE subscription data, UE location, and information provided by the AF 528. In this way, the AF 528 may influence UPF (re)selection and traffic routing. Based on operator deployment, when AF 528 is considered to be a trusted entity, the network operator may permit AF 528 to interact directly with relevant NFs. Additionally, the AF 528 may exhibit an Naf service-based interface.

The NSSF 529 may select a set of network slice instances serving the UE 501. The NSSF 529 may also determine allowed NSSAI and the mapping to the subscribed S-NSSAIs, if needed. The NSSF 529 may also determine the AMF set to be used to serve the UE 501, or a list of candidate AMF(s) 521 based on a suitable configuration and possibly by querying the NRF 525. The selection of a set of network slice instances for the UE 501 may be triggered by the AMF 521 with which the UE 501 is registered by interacting with the NSSF 529, which may lead to a change of AMF 521. The NSSF 529 may interact with the AMF 521 via an N22 reference point between AMF 521 and NSSF 529; and may communicate with another NSSF 529 in a visited network via an N31 reference point (not shown by FIG. 5). Additionally, the NSSF 529 may exhibit an Nnssf service-based interface.

As discussed previously, the CN 520 may include an SMSF, which may be responsible for SMS subscription checking and verification, and relaying SM messages to/from the UE 501 to/from other entities, such as an SMS-GMSC/IWMSC/SMS-router. The SMS may also interact with AMF 521 and UDM 527 for a notification procedure that the UE 501 is available for SMS transfer (e.g., set a UE not reachable flag, and notifying UDM 527 when UE 501 is available for SMS).

The CN 120 may also include other elements that are not shown by FIG. 5, such as a Data Storage system/architecture, a 5G-EIR, a SEPP, and the like. The Data Storage system may include a SDSF, an UDSF, and/or the like. Any NF may store and retrieve unstructured data into/from the UDSF (e.g., UE contexts), via N18 reference point between any NF and the UDSF (not shown by FIG. 5). Individual NFs may share a UDSF for storing their respective unstructured data or individual NFs may each have their own UDSF located at or near the individual NFs. Additionally, the UDSF may exhibit an Nudsf service-based interface (not shown by FIG. 5). The 5G-EIR may be an NF that checks the status of PEI for determining whether particular equipment/entities are blacklisted from the network; and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 5 for clarity. In one example, the CN 520 may include an Nx interface, which is an inter-CN interface between the MME (e.g., MME 421) and the AMF 521 in order to enable interworking between CN 520 and CN 420. Other example interfaces/reference points may include an N5g-EIR service-based interface exhibited by a 5G-EIR, an N27 reference point between the NRF in the visited network and the NRF in the home network; and an N31 reference point between the NSSF in the visited network and the NSSF in the home network.

FIG. 6 illustrates an example of infrastructure equipment 600 in accordance with various embodiments. The infrastructure equipment 600 (or “system 600”) may be implemented as a base station, radio head, RAN node such as the RAN nodes 311 and/or AP 306 shown and described previously, application server(s) 330, and/or any other element/device discussed herein. In other examples, the system 600 could be implemented in or by a UE.

The system 600 includes application circuitry 605, baseband circuitry 610, one or more radio front end modules (RFEMs) 615, memory circuitry 620, power management integrated circuitry (PMIC) 625, power tee circuitry 630, network controller circuitry 635, network interface connector 640, satellite positioning circuitry 645, and user interface 650. In some embodiments, the device 600 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 605 includes circuitry such as, but not limited to one or more processors (or processor cores), cache memory, and one or more of low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 605 may be coupled with or may include memory/storage elements and may be configured to execute instructions stored in the memory/storage to enable various applications or operating systems to run on the system 600. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 605 may comprise, or may be, a special-purpose processor/controller to operate according to the various embodiments herein. As examples, the processor(s) of application circuitry 605 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 600 may not utilize application circuitry 605, and instead may include a special-purpose processor/controller to process IP data received from an EPC or 5GC, for example.

In some implementations, the application circuitry 605 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 605 may comprise logic blocks or logic fabric, and other interconnected resources that may be programmed to perform various functions, such as the procedures, methods, functions, etc. of the various embodiments discussed herein. In such embodiments, the circuitry of application circuitry 605 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 610 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 610 are discussed infra with regard to FIG. XT.

User interface circuitry 650 may include one or more user interfaces designed to enable user interaction with the system 600 or peripheral component interfaces designed to enable peripheral component interaction with the system 600. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

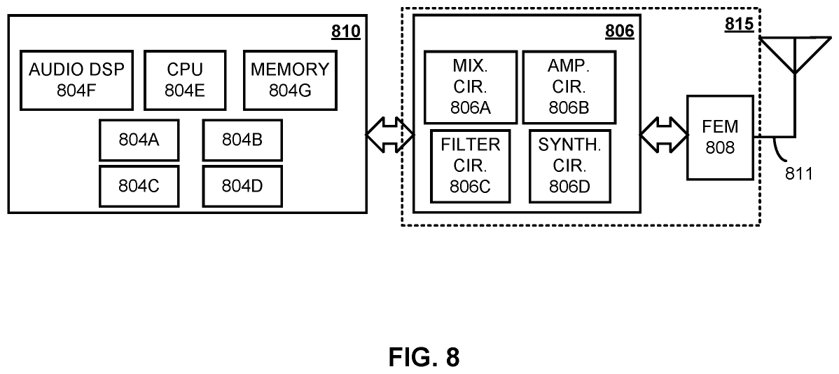

The radio front end modules (RFEMs) 615 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 811 of FIG. 8 infra), and the RFEM may be connected to multiple antennas. In alternative implementations, both mmWave and sub-mmWave radio functions may be implemented in the same physical RFEM 615, which incorporates both mmWave antennas and sub-mmWave.

The memory circuitry 620 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 620 may be implemented as one or more of solder down packaged integrated circuits, socketed memory modules and plug-in memory cards.

The PMIC 625 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 630 may provide for electrical power drawn from a network cable to provide both power supply and data connectivity to the infrastructure equipment 600 using a single cable.

The network controller circuitry 635 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 600 via network interface connector 640 using a physical connection, which may be electrical (commonly referred to as a “copper interconnect”), optical, or wireless. The network controller circuitry 635 may include one or more dedicated processors and/or FPGAs to communicate using one or more of the aforementioned protocols. In some implementations, the network controller circuitry 635 may include multiple controllers to provide connectivity to other networks using the same or different protocols.

The positioning circuitry 645 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 645 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 645 may include a Micro-Technology for Positioning, Navigation, and Timing (Micro-PNT) IC that uses a master timing clock to perform position tracking/estimation without GNSS assistance. The positioning circuitry 645 may also be part of, or interact with, the baseband circuitry 610 and/or RFEMs 615 to communicate with the nodes and components of the positioning network. The positioning circuitry 645 may also provide position data and/or time data to the application circuitry 605, which may use the data to synchronize operations with various infrastructure (e.g., RAN nodes 311, etc.), or the like.

The components shown by FIG. 6 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I²C interface, an SPI interface, point to point interfaces, and a power bus, among others.

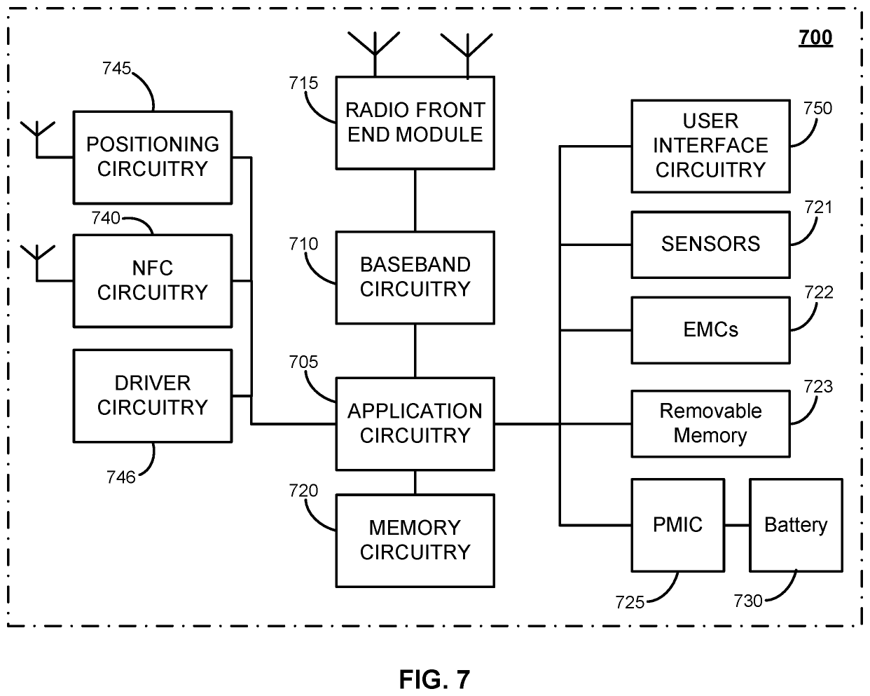

FIG. 7 illustrates an example of a platform 700 (or “device 700”) in accordance with various embodiments. In embodiments, the computer platform 700 may be suitable for use as UEs 301, 401, 502, application servers 330, and/or any other element/device discussed herein. The platform 700 may include any combinations of the components shown in the example. The components of platform 700 may be implemented as integrated circuits (ICs), portions thereof, discrete electronic devices, or other modules, logic, hardware, software, firmware, or a combination thereof adapted in the computer platform 700, or as components otherwise incorporated within a chassis of a larger system. The block diagram of FIG. 7 is intended to show a high level view of components of the computer platform 700. However, some of the components shown may be omitted, additional components may be present, and different arrangement of the components shown may occur in other implementations.

Application circuitry 705 includes circuitry such as, but not limited to one or more processors (or processor cores), cache memory, and one or more of LDOs, interrupt controllers, serial interfaces such as SPI, I²C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 705 may be coupled with or may include memory/storage elements and may be configured to execute instructions stored in the memory/storage to enable various applications or operating systems to run on the system 700. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 605 may comprise, or may be, a special-purpose processor/controller to operate according to the various embodiments herein.

As examples, the processor(s) of application circuitry 705 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 705 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 705 may be a part of a system on a chip (SoC) in which the application circuitry 705 and other components are formed into a single integrated circuit, or a single package, such as the Edison™ or Galileo™ SoC boards from Intel® Corporation.

Additionally or alternatively, application circuitry 705 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 705 may comprise logic blocks or logic fabric, and other interconnected resources that may be programmed to perform various functions, such as the procedures, methods, functions, etc. of the various embodiments discussed herein. In such embodiments, the circuitry of application circuitry 705 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 710 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 710 are discussed infra with regard to FIG. 8.

The RFEMs 715 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 811 of FIG. 8 infra), and the RFEM may be connected to multiple antennas. In alternative implementations, both mmWave and sub-mmWave radio functions may be implemented in the same physical RFEM 715, which incorporates both mmWave antennas and sub-mmWave.

The memory circuitry 720 may include any number and type of memory devices used to provide for a given amount of system memory. As examples, the memory circuitry 720 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 720 may be developed in accordance with a Joint Electron Devices Engineering Council (JEDEC) low power double data rate (LPDDR)-based design, such as LPDDR2, LPDDR3, LPDDR4, or the like. Memory circuitry 720 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 720 may be on-die memory or registers associated with the application circuitry 705. To provide for persistent storage of information such as data, applications, operating systems and so forth, memory circuitry 720 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 700 may incorporate the three-dimensional (3D) cross-point (XPOINT) memories from Intel® and Micron®.

Removable memory circuitry 723 may include devices, circuitry, enclosures/housings, ports or receptacles, etc. used to couple portable data storage devices with the platform 700. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 700 may also include interface circuitry (not shown) that is used to connect external devices with the platform 700. The external devices connected to the platform 700 via the interface circuitry include sensor circuitry 721 and electro-mechanical components (EMCs) 722, as well as removable memory devices coupled to removable memory circuitry 723.

The sensor circuitry 721 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 722 include devices, modules, or subsystems whose purpose is to enable platform 700 to change its state, position, and/or orientation, or move or control a mechanism or (sub)system. Additionally, EMCs 722 may be configured to generate and send messages/signalling to other components of the platform 700 to indicate a current state of the EMCs 722. Examples of the EMCs 722 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 700 is configured to operate one or more EMCs 722 based on one or more captured events and/or instructions or control signals received from a service provider and/or various clients.

In some implementations, the interface circuitry may connect the platform 700 with positioning circuitry 745. The positioning circuitry 745 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 745 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 745 may include a Micro-PNT IC that uses a master timing clock to perform position tracking/estimation without GNSS assistance. The positioning circuitry 745 may also be part of, or interact with, the baseband circuitry 610 and/or RFEMs 715 to communicate with the nodes and components of the positioning network. The positioning circuitry 745 may also provide position data and/or time data to the application circuitry 705, which may use the data to synchronize operations with various infrastructure (e.g., radio base stations), for turn-by-turn navigation applications, or the like

In some implementations, the interface circuitry may connect the platform 700 with Near-Field Communication (NFC) circuitry 740. NFC circuitry 740 is configured to provide contactless, short-range communications based on radio frequency identification (RFID) standards, wherein magnetic field induction is used to enable communication between NFC circuitry 740 and NFC-enabled devices external to the platform 700 (e.g., an “NFC touchpoint”). NFC circuitry 740 comprises an NFC controller coupled with an antenna element and a processor coupled with the NFC controller. The NFC controller may be a chip/IC providing NFC functionalities to the NFC circuitry 740 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 740, or initiate data transfer between the NFC circuitry 740 and another active NFC device (e.g., a smartphone or an NFC-enabled POS terminal) that is proximate to the platform 700.

The driver circuitry 746 may include software and hardware elements that operate to control particular devices that are embedded in the platform 700, attached to the platform 700, or otherwise communicatively coupled with the platform 700. The driver circuitry 746 may include individual drivers allowing other components of the platform 700 to interact with or control various input/output (I/O) devices that may be present within, or connected to, the platform 700. For example, driver circuitry 746 may include a display driver to control and allow access to a display device, a touchscreen driver to control and allow access to a touchscreen interface of the platform 700, sensor drivers to obtain sensor readings of sensor circuitry 721 and control and allow access to sensor circuitry 721, EMC drivers to obtain actuator positions of the EMCs 722 and/or control and allow access to the EMCs 722, a camera driver to control and allow access to an embedded image capture device, audio drivers to control and allow access to one or more audio devices.

The power management integrated circuitry (PMIC) 725 (also referred to as “power management circuitry 725”) may manage power provided to various components of the platform 700. In particular, with respect to the baseband circuitry 710, the PMIC 725 may control power-source selection, voltage scaling, battery charging, or DC-to-DC conversion. The PMIC 725 may often be included when the platform 700 is capable of being powered by a battery 730, for example, when the device is included in a UE 301, 401, 502.

In some embodiments, the PMIC 725 may control, or otherwise be part of, various power saving mechanisms of the platform 700. For example, if the platform 700 is in an RRC_Connected state, where it is still connected to the RAN node as it expects to receive traffic shortly, then it may enter a state known as Discontinuous Reception Mode (DRX) after a period of inactivity. During this state, the platform 700 may power down for brief intervals of time and thus save power. If there is no data traffic activity for an extended period of time, then the platform 700 may transition off to an RRC_Idle state, where it disconnects from the network and does not perform operations such as channel quality feedback, handover, etc. The platform 700 goes into a very low power state and it performs paging where again it periodically wakes up to listen to the network and then powers down again. The platform 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 730 may power the platform 700, although in some examples the platform 700 may be mounted deployed in a fixed location, and may have a power supply coupled to an electrical grid. The battery 730 may be a lithium ion battery, a metal-air battery, such as a zinc-air battery, an aluminum-air battery, a lithium-air battery, and the like. In some implementations, such as in V2X applications, the battery 730 may be a typical lead-acid automotive battery.

In some implementations, the battery 730 may be a “smart battery,” which includes or is coupled with a Battery Management System (BMS) or battery monitoring integrated circuitry. The BMS may be included in the platform 700 to track the state of charge (SoCh) of the battery 730. The BMS may be used to monitor other parameters of the battery 730 to provide failure predictions, such as the state of health (SoH) and the state of function (SoF) of the battery 730. The BMS may communicate the information of the battery 730 to the application circuitry 705 or other components of the platform 700. The BMS may also include an analog-to-digital (ADC) convertor that allows the application circuitry 705 to directly monitor the voltage of the battery 730 or the current flow from the battery 730. The battery parameters may be used to determine actions that the platform 700 may perform, such as transmission frequency, network operation, sensing frequency, and the like.

A power block, or other power supply coupled to an electrical grid may be coupled with the BMS to charge the battery 730. In some examples, the power block 725 may be replaced with a wireless power receiver to obtain the power wirelessly, for example, through a loop antenna in the computer platform 700. In these examples, a wireless battery charging circuit may be included in the BMS. The specific charging circuits chosen may depend on the size of the battery 730, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 750 includes various input/output (I/O) devices present within, or connected to, the platform 700, and includes one or more user interfaces designed to enable user interaction with the platform 700 and/or peripheral component interfaces designed to enable peripheral component interaction with the platform 700. The user interface circuitry 750 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 700. The output device circuitry may also include speakers or other audio emitting devices, printer(s), and/or the like. In some embodiments, the sensor circuitry 721 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 700 may communicate with one another using a suitable bus or interconnect (IX) technology, which may include any number of technologies, including ISA, EISA, PCI, PCIx, PCIe, a Time-Trigger Protocol (TTP) system, a FlexRay system, or any number of other technologies. The bus/IX may be a proprietary bus/IX, for example, used in a SoC based system. Other bus/IX systems may be included, such as an I²C interface, an SPI interface, point-to-point interfaces, and a power bus, among others.

FIG. 8 illustrates example components of baseband circuitry 810 and radio front end modules (RFEM) 815 in accordance with various embodiments. The baseband circuitry 810 corresponds to the baseband circuitry 610 and 710 of FIGS. 6 and 7, respectively. The RFEM 815 corresponds to the RFEM 615 and 715 of FIGS. 6 and 7, respectively. As shown, the RFEMs 815 may include Radio Frequency (RF) circuitry 806, front-end module (FEM) circuitry 808, antenna array 811 coupled together at least as shown.

The baseband circuitry 810 includes circuitry and/or control logic configured to carry out various radio/network protocol and radio control functions that enable communication with one or more radio networks via the RF circuitry 806. The radio control functions may include, but are not limited to, signal modulation/demodulation, encoding/decoding, radio frequency shifting, etc. In some embodiments, modulation/demodulation circuitry of the baseband circuitry 810 may include Fast-Fourier Transform (FFT), precoding, or constellation mapping/demapping functionality. In some embodiments, encoding/decoding circuitry of the baseband circuitry 810 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 810 is configured to process baseband signals received from a receive signal path of the RF circuitry 806 and to generate baseband signals for a transmit signal path of the RF circuitry 806. The baseband circuitry 810 is configured to interface with application circuitry 605/705 (see FIGS. 6 and 7) for generation and processing of the baseband signals and for controlling operations of the RF circuitry 806. The baseband circuitry 810 may handle various radio control functions.

The aforementioned circuitry and/or control logic of the baseband circuitry 810 may include one or more single or multi-core processors. For example, the one or more processors may include a 3G baseband processor 804A, a 4G/LTE baseband processor 804B, a 5G/NR baseband processor 804C, or some other baseband processor(s) 804D for other existing generations, generations in development or to be developed in the future (e.g., sixth generation (6G), etc.). In other embodiments, some or all of the functionality of baseband processors 804A-D may be included in modules stored in the memory 804G and executed via a Central Processing Unit (CPU) 804E. In other embodiments, some or all of the functionality of baseband processors 804A-D may be provided as hardware accelerators (e.g., FPGAs, ASICs, etc.) loaded with the appropriate bit streams or logic blocks stored in respective memory cells. In various embodiments, the memory 804G may store program code of a real-time OS (RTOS), which when executed by the CPU 804E (or other baseband processor), is to cause the CPU 804E (or other baseband processor) to manage resources of the baseband circuitry 810, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 810 includes one or more audio digital signal processor(s) (DSP) 804F. The audio DSP(s) 804F include elements for compression/decompression and echo cancellation and may include other suitable processing elements in other embodiments.

In some embodiments, each of the processors 804A-804E include respective memory interfaces to send/receive data to/from the memory 804G. The baseband circuitry 810 may further include one or more interfaces to communicatively couple to other circuitries/devices, such as an interface to send/receive data to/from memory external to the baseband circuitry 810; an application circuitry interface to send/receive data to/from the application circuitry 605/705 of FIG. 6-XT); an RF circuitry interface to send/receive data to/from RF circuitry 806 of FIG. XT; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 725.

In alternate embodiments (which may be combined with the above described embodiments), baseband circuitry 810 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 810 may include protocol processing circuitry with one or more instances of control circuitry (not shown) to provide control functions for the digital baseband circuitry and/or radio frequency circuitry (e.g., the radio front end modules 815).

Although not shown by FIG. 8, in some embodiments, the baseband circuitry 810 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 810 and/or RF circuitry 806 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 810 and/or RF circuitry 806 are part of a Wi-Fi communication system. In the second example, the protocol processing circuitry would operate Wi-Fi MAC and logical link control (LLC) functions. The protocol processing circuitry may include one or more memory structures (e.g., 804G) to store program code and data for operating the protocol functions, as well as one or more processing cores to execute the program code and perform various operations using the data. The baseband circuitry 810 may also support radio communications for more than one wireless protocol.

The various hardware elements of the baseband circuitry 810 discussed herein may be implemented, for example, as a solder-down substrate including one or more integrated circuits (ICs), a single packaged IC soldered to a main circuit board or a multi-chip module containing two or more ICs. In one example, the components of the baseband circuitry 810 may be suitably combined in a single chip or chipset, or disposed on a same circuit board. In another example, some or all of the constituent components of the baseband circuitry 810 and RF circuitry 806 may be implemented together such as, for example, a system on a chip (SoC) or System-in-Package (SiP). In another example, some or all of the constituent components of the baseband circuitry 810 may be implemented as a separate SoC that is communicatively coupled with and RF circuitry 806 (or multiple instances of RF circuitry 806). In yet another example, some or all of the constituent components of the baseband circuitry 810 and the application circuitry 605/705 may be implemented together as individual SoCs mounted to a same circuit board (e.g., a “multi-chip package”).

In some embodiments, the baseband circuitry 810 may provide for communication compatible with one or more radio technologies. For example, in some embodiments, the baseband circuitry 810 may support communication with an E-UTRAN or other WMAN, a WLAN, a WPAN. Embodiments in which the baseband circuitry 810 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path, which may include circuitry to down-convert RF signals received from the FEM circuitry 808 and provide baseband signals to the baseband circuitry 810. RF circuitry 806 may also include a transmit signal path, which may include circuitry to up-convert baseband signals provided by the baseband circuitry 810 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 810 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 810 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a of the transmit signal path may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 810 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a requirement. Divider control input may be provided by either the baseband circuitry 810 or the application circuitry 605/705 depending on the desired output frequency. In some embodiments, a divider control input (e.g., N) may be determined from a look-up table based on a channel indicated by the application circuitry 605/705.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path, which may include circuitry configured to operate on RF signals received from antenna array 811, amplify the received signals and provide the amplified versions of the received signals to the RF circuitry 806 for further processing. FEM circuitry 808 may also include a transmit signal path, which may include circuitry configured to amplify signals for transmission provided by the RF circuitry 806 for transmission by one or more of antenna elements of antenna array 811. In various embodiments, the amplification through the transmit or receive signal paths may be done solely in the RF circuitry 806, solely in the FEM circuitry 808, or in both the RF circuitry 806 and the FEM circuitry 808.

In some embodiments, the FEM circuitry 808 may include a TX/RX switch to switch between transmit mode and receive mode operation. The FEM circuitry 808 may include a receive signal path and a transmit signal path. The receive signal path of the FEM circuitry 808 may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission by one or more antenna elements of the antenna array 811.

The antenna array 811 comprises one or more antenna elements, each of which is configured convert electrical signals into radio waves to travel through the air and to convert received radio waves into electrical signals. For example, digital baseband signals provided by the baseband circuitry 810 is converted into analog RF signals (e.g., modulated waveform) that will be amplified and transmitted via the antenna elements of the antenna array 811 including one or more antenna elements (not shown). The antenna elements may be omnidirectional, direction, or a combination thereof. The antenna elements may be formed in a multitude of arranges as are known and/or discussed herein. The antenna array 811 may comprise microstrip antennas or printed antennas that are fabricated on the surface of one or more printed circuit boards. The antenna array 811 may be formed in as a patch of metal foil (e.g., a patch antenna) in a variety of shapes, and may be coupled with the RF circuitry 806 and/or FEM circuitry 808 using metal transmission lines or the like.

Processors of the application circuitry 605/705 and processors of the baseband circuitry 810 may be used to execute elements of one or more instances of a protocol stack. For example, processors of the baseband circuitry 810, alone or in combination, may be used execute Layer 3, Layer 2, or Layer 1 functionality, while processors of the application circuitry 605/705 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

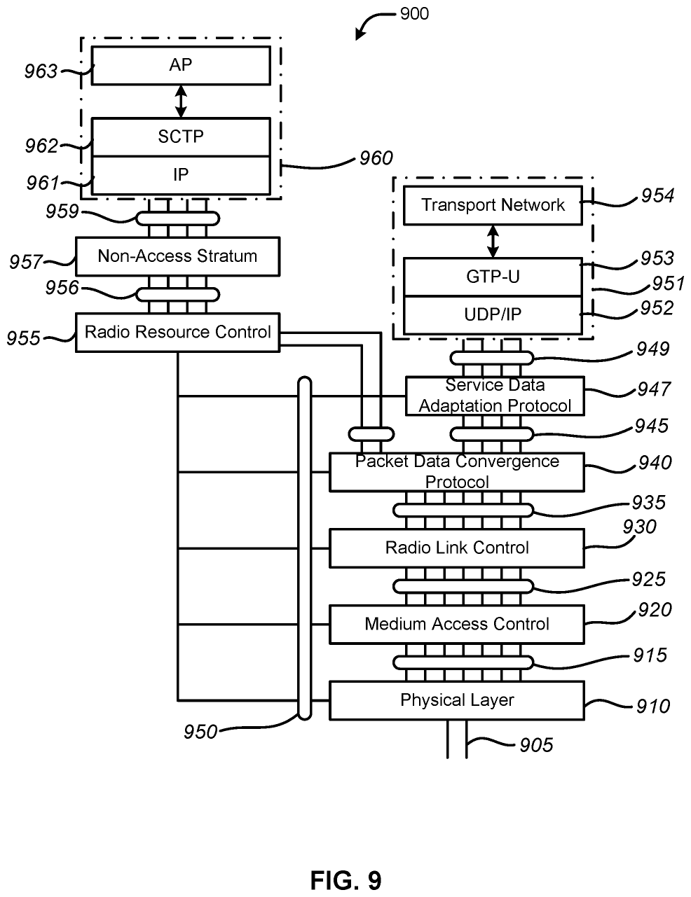

FIG. 9 illustrates various protocol functions that may be implemented in a wireless communication device according to various embodiments. In particular, FIG. 9 includes an arrangement 900 showing interconnections between various protocol layers/entities. The following description of FIG. 9 is provided for various protocol layers/entities that operate in conjunction with the 5G/NR system standards and LTE system standards, but some or all of the aspects of FIG. 9 may be applicable to other wireless communication network systems as well.

The protocol layers of arrangement 900 may include one or more of PHY 910, MAC 920, RLC 930, PDCP 940, SDAP 947, RRC 955, and NAS layer 957, in addition to other higher layer functions not illustrated. The protocol layers may include one or more service access points (e.g., items 959, 956, 950, 949, 945, 935, 925, and 915 in FIG. 9) that may provide communication between two or more protocol layers.

The PHY 910 may transmit and receive physical layer signals 905 that may be received from or transmitted to one or more other communication devices. The physical layer signals 905 may comprise one or more physical channels, such as those discussed herein. The PHY 910 may further perform link adaptation or adaptive modulation and coding (AMC), power control, cell search (e.g., for initial synchronization and handover purposes), and other measurements used by higher layers, such as the RRC 955. The PHY 910 may still further perform error detection on the transport channels, forward error correction (FEC) coding/decoding of the transport channels, modulation/demodulation of physical channels, interleaving, rate matching, mapping onto physical channels, and MIMO antenna processing. In embodiments, an instance of PHY 910 may process requests from and provide indications to an instance of MAC 920 via one or more PHY-SAP 915. According to some embodiments, requests and indications communicated via PHY-SAP 915 may comprise one or more transport channels.

Instance(s) of MAC 920 may process requests from, and provide indications to, an instance of RLC 930 via one or more MAC-SAPs 925. These requests and indications communicated via the MAC-SAP 925 may comprise one or more logical channels. The MAC 920 performs mapping between the logical channels and transport channels, multiplexing of MAC SDUs from one or more logical channels onto TBs to be delivered to PHY 910 via the transport channels, de-multiplexing MAC SDUs to one or more logical channels from TBs delivered from the PHY 910 via transport channels, multiplexing MAC SDUs onto TBs, scheduling information reporting, error correction through HARQ, and logical channel prioritization.

The MAC 920 handles the following transport channels:
Broadcast Channel (BCH);
Downlink Shared Channel(s) (DL-SCH);
Paging Channel (PCH);
Uplink Shared Channel(s) (UL-SCH);
Random Access Channel(s) (RACH).

When the UE 301 is configured with SCG, two MAC 920 entities are configured to the UE 301: one for the MCG and one for the SCG. The functions of the different MAC 920 entities in the UE 301 operate independently unless otherwise specified. The timers and parameters used in each MAC 920 entity are configured independently unless otherwise specified. The Serving Cells, C-RNTI, radio bearers, logical channels, upper and lower layer entities, LCGs, and HARQ entities considered by each MAC entity refer to those mapped to that MAC entity unless otherwise specified. If the MAC 920 entity is configured with one or more SCells, there are multiple DL-SCH and there may be multiple UL-SCH as well as multiple RACH per MAC entity; one DL-SCH, one UL-SCH, and one RACH on the SpCell, one DL-SCH, zero or one UL-SCH and zero or one RACH for each SCell. If the MAC 920 entity is not configured with any SCell, there is one DL-SCH, one UL-SCH, and one RACH per MAC MAC 920 entity.

According to various embodiments, a MAC CE is used to dynamically activate/deactivate candidate beams for BFR per uplink BWP. In these embodiments, the BFR candidate beam Activation/Deactivation for BWP-specific MAC CE is identified by a MAC PDU subheader with a new LCID. Such a MAC CE may have the fields as discussed supra, and may have a format as shown by FIG. 1 supra. The network can activate/deactivate the candidate beams for BFR of the UE 301 in a particular BWP by sending the above MAC CE to the UE 301. The new set of activated candidate beams becomes valid at x slots after the UE 301 sends HARQ-ACK to the network for acknowledging the PDSCH carrying the MAC CE.

Semi-Persistent Scheduling (SPS) is configured by RRC 955 per Serving Cell and per BWP. Activation and deactivation of the DL SPS are independent among the Serving Cells. For the DL SPS, a DL assignment is provided by PDCCH, and stored or cleared based on L1 signalling indicating SPS activation or deactivation. RRC 955 configures the following parameters when SPS is configured:
cs-RNTI: CS-RNTI for activation, deactivation, and retransmission;
nrofHARQ-Processes: the number of configured HARQ processes for SPS;
periodicity: periodicity of configured downlink assignment for SPS.

When SPS is released by upper layers, all the corresponding configurations are released. After a downlink assignment is configured for SPS, the MAC entity shall consider sequentially that the N^{th} downlink assignment occurs in the slot for which:

(numberOfSlotsPerFrame×SFN+slot number in the frame)=[(numberOfSlotsPerFrame×SFN_{start time}+slot_{start time})+N×periodicity×numberOfSlotsPerFrame/10]modulo(1024×numberOfSlotsPerFrame)

where SFN_{start time} and slot_{start time} are the SFN and slot, respectively, of the first transmission of PDSCH where the configured downlink assignment was (re-)initialised.

There are two types of transmission without dynamic grant: configured grant Type 1 where an uplink grant is provided by RRC, and stored as configured uplink grant; and configured grant Type 2 where an uplink grant is provided by PDCCH, and stored or cleared as configured uplink grant based on L1 signalling indicating configured uplink grant activation or deactivation.

Type 1 and Type 2 are configured by RRC 955 per Serving Cell and per BWP. Multiple configurations can be active simultaneously only on different Serving Cells. For Type 2, activation and deactivation are independent among the Serving Cells. For the same Serving Cell, the MAC 920 entity is configured with either Type 1 or Type 2. RRC 955 configures the following parameters when the configured grant Type 1 is configured:
cs-RNTI: CS-RNTI for retransmission;
periodicity: periodicity of the configured grant Type 1;
timeDomainOffset: Offset of a resource with respect to SFN=0 in time domain;
timeDomainAllocation: Allocation of configured uplink grant in time domain which contains startSymbolAndLength (i.e. SLIV in TS 38.214);
nrofHARQ-Processes: the number of HARQ processes for configured grant.

RRC 920 configures the following parameters when the configured grant Type 2 is configured:
cs-RNTI: CS-RNTI for activation, deactivation, and retransmission;
periodicity: periodicity of the configured grant Type 2;
nrofHARQ-Processes: the number of HARQ processes for configured grant.

Upon configuration of a configured grant Type 1 for a Serving Cell by upper layers, the MAC 920 entity is to:
1> store the uplink grant provided by upper layers as a configured uplink grant for the indicated Serving Cell;
1> initialise or re-initialise the configured uplink grant to start in the symbol according to timeDomainOffset and S (derived from SLIV as specified in TS 38.214 [7]), and to reoccur with periodicity.

After an uplink grant is configured for a configured grant Type 1, the MAC 920 entity considers that the uplink grant recurs associated with each symbol for which:

[(SFN×numberOfSlotsPerFrame×numberOfSymbolsPerSlot)+(slot number in the frame×numberOfSymbolsPerSlot)+symbol number in the slot]=(timeDomainOffset×numberOfSymbolsPerSlot+S+N×periodicity)modulo (1024×numberOfSlotsPerFrame×numberOfSymbolsPerSlot), for all N>=0.

After an uplink grant is configured for a configured grant Type 2, the MAC entity shall consider that the uplink grant recurs associated with each symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity]modulo(1024×numberOfSlotsPerFrame×numberOfSymbolsPerSlot), for all N>=0.
where SFN_{start time}, slot_{start time}, and symbol_{start time} are the SFN, slot, and symbol, respectively, of the first transmission opportunity of PUSCH where the configured uplink grant was (re-)initialised.

When a configured uplink grant is released by upper layers, all the corresponding configurations shall be released and all corresponding uplink grants shall be cleared. The MAC 920 entity is to:
1> if the configured uplink grant confirmation has been triggered and not cancelled; and
1> if the MAC entity has UL resources allocated for new transmission:
   2> instruct the Multiplexing and Assembly procedure to generate an Configured Grant Confirmation MAC CE;
   2> cancel the triggered configured uplink grant confirmation.

For a configured grant Type 2, the MAC 920 entity clears the configured uplink grant immediately after first transmission of Configured Grant Confirmation MAC CE triggered by the configured uplink grant deactivation. Retransmissions except for repetition of configured uplink grants use uplink grants addressed to CS-RNTI.

If the MAC 920 entity is configured with one or more SCells, the network may activate and deactivate the configured SCells. Upon configuration of an SCell, the SCell is deactivated. The configured SCell(s) is activated and deactivated by: receiving the SCell Activation/Deactivation MAC CE; and configuring sCellDeactivationTimer timer per configured SCell (except the SCell configured with PUCCH, if any): the associated SCell is deactivated upon its expiry. The MAC 920 entity, for each configured SCell, is to:
1> if an SCell Activation/Deactivation MAC CE is received activating the SCell:
   2> activate the SCell according to the timing defined in TS 38.213; i.e. apply normal SCell operation including:
      3> SRS transmissions on the SCell;
      3> CSI reporting for the SCell;
      3> PDCCH monitoring on the SCell;
      3> PDCCH monitoring for the SCell;
      3> PUCCH transmissions on the SCell, if configured.
   2> if the SCell was deactivated prior to receiving this SCell Activation/Deactivation MAC CE:
      3> activate the DL BWP and UL BWP indicated by firstActiveDownlinkBWP-Id and firstActiveUplinkBWP-Id respectively;
   2> start or restart the sCellDeactivationTimer associated with the SCell according to the timing defined in TS 38.213;
   2> (re-)initialize any suspended configured uplink grants of configured grant Type 1 associated with this SCell according to the stored configuration, if any, and to start in the symbol;
   2> trigger Power Headroom (PHR).
1> else if an SCell Activation/Deactivation MAC CE is received deactivating the SCell; or
1> if the sCellDeactivationTimer associated with the activated SCell expires:
   2> deactivate the SCell according to the timing defined in TS 38.213;
   2> stop the sCellDeactivationTimer associated with the SCell;
   2> stop the bwp-InactivityTimer associated with the SCell;
   2> deactivate any active BWP associated with the SCell;
   2> clear any configured downlink assignment and any configured uplink grant Type 2 associated with the SCell respectively;
   2> clear any PUSCH resource for semi-persistent CSI reporting associated with the SCell;
   2> suspend any configured uplink grant Type 1 associated with the SCell;
   2> flush all HARQ buffers associated with the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant or received in a configured downlink assignment:
   2> restart the sCellDeactivationTimer associated with the SCell.
1> if the SCell is deactivated:
   2> not transmit SRS on the SCell;
   2> not report CSI for the SCell;
   2> not transmit on UL-SCH on the SCell;
   2> not transmit on RACH on the SCell;
   2> not monitor the PDCCH on the SCell;
   2> not monitor the PDCCH for the SCell;
   2> not transmit PUCCH on the SCell.

HARQ feedback for the MAC PDU containing SCell Activation/Deactivation MAC CE is not impacted by PCell, PSCell and PUCCH SCell interruptions due to SCell activation/deactivation in TS 38.133. When SCell is deactivated, the ongoing Random Access procedure on the SCell, if any, is aborted.

A Serving Cell may be configured with one or multiple BWPs, and the maximum number of BWP per Serving Cell is specified in TS 38.213. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC 920 signalling, or by the MAC 920 entity itself upon initiation of Random Access procedure. Upon RRC (re-)configuration of firstActiveDownlinkBWP-Id and/or firstActiveUplinkBWP-Id for SpCell or activation of an SCell, the DL BWP and/or UL BWP indicated byfirstActiveDownlinkBWP-Id and/or firstActiveUplinkBWP-Id respectively (as specified in TS 38.331) is active without receiving PDCCH indicating a downlink assignment or an uplink grant. The active BWP for a Serving Cell is indicated by either RRC 955 or PDCCH (as specified in TS 38.213). For unpaired spectrum, a DL BWP is paired with a UL BWP, and BWP switching is common for both UL and DL. For each activated Serving Cell configured with a BWP, the MAC 920 entity is to:
1> if a BWP is activated:
   2> transmit on UL-SCH on the BWP;
   2> transmit on RACH on the BWP, if PRACH occasions are configured;
   2> monitor the PDCCH on the BWP;
   2> transmit PUCCH on the BWP, if configured;
   2> report CSI for the BWP;
   2> transmit SRS on the BWP, if configured;
   2> receive DL-SCH on the BWP;
   2> (re-)initialize any suspended configured uplink grants of configured grant Type 1 on the active BWP according to the stored configuration, if any, and to start in the symbol.
1> if a BWP is deactivated:
   2> not transmit on UL-SCH on the BWP;
   2> not transmit on RACH on the BWP;
   2> not monitor the PDCCH on the BWP;
   2> not transmit PUCCH on the BWP;
   2> not report CSI for the BWP;
   2> not transmit SRS on the BWP;
   2> not receive DL-SCH on the BWP;
   2> clear any configured downlink assignment and configured uplink grant of configured grant Type 2 on the BWP;
   2> suspend any configured uplink grant of configured grant Type 1 on the inactive BWP.

Upon initiation of the Random Access procedure on a Serving Cell, after the selection of carrier for performing Random Access procedure, the MAC 920 entity, for the selected carrier of the Serving Cell, is to:
1> if PRACH occasions are not configured for the active UL BWP:
   2> switch the active UL BWP to BWP indicated by initialUplinkBWP;
   2> if the Serving Cell is a SpCell:
      3> switch the active DL BWP to BWP indicated by initialDownlinkBWP.
1> else:
   2> if the Serving Cell is a SpCell:
      3> if the active DL BWP does not have the same bwp-Id as the active UL BWP:
         4> switch the active DL BWP to the DL BWP with the same bwp-Id as the active UL BWP.
1> stop the bwp-InactivityTimer associated with the active DL BWP of this Serving Cell, if running.
1> if the Serving Cell is SCell:
   2> stop the bwp-InactivityTimer associated with the active DL BWP of SpCell, if running.
1> perform the Random Access procedure on the active DL BWP of SpCell and active UL BWP of this Serving Cell.

If the MAC 920 entity receives a PDCCH for BWP switching of a Serving Cell, the MAC 920 entity is to:
1> if there is no ongoing Random Access procedure associated with this Serving Cell; or
1> if the ongoing Random Access procedure associated with this Serving Cell is successfully completed upon reception of this PDCCH addressed to C-RNTI:
   2> perform BWP switching to a BWP indicated by the PDCCH.

If the MAC 920 entity receives a PDCCH for BWP switching for a Serving Cell while a Random Access procedure associated with that Serving Cell is ongoing in the MAC entity, it is up to UE 301 implementation whether to switch BWP or ignore the PDCCH for BWP switching, except for the PDCCH reception for BWP switching addressed to the C-RNTI for successful Random Access procedure completion in which case the UE 301 is to perform BWP switching to a BWP indicated by the PDCCH. Upon reception of the PDCCH for BWP switching other than successful contention resolution, if the MAC 920 entity decides to perform BWP switching, the MAC 920 entity is to stop the ongoing Random Access procedure and initiate a Random Access procedure after performing the BWP switching; if the MAC 920 decides to ignore the PDCCH for BWP switching, the MAC 920 entity is to continue with the ongoing Random Access procedure on the Serving Cell.

Upon reception of RRC (re-)configuration for BWP switching for a Serving Cell while a Random Access procedure associated with that Serving Cell is ongoing in the MAC 920 entity, the MAC 920 entity is to stop the ongoing Random Access procedure and initiate a Random Access procedure after performing the BWP switching.

The MAC 920 entity, for each activated Serving Cell configured with bwp-InactivityTimer, is to:
1> if the defaultDownlinkBWP-Id is configured, and the active DL BWP is not the BWP indicated by the defaultDownlinkBWP-Id; or
1> if the defaultDownlinkBWP-Id is not configured, and the active DL BWP is not the initialDownlinkBWP:
   2> if a PDCCH addressed to C-RNTI or CS-RNTI indicating downlink assignment or uplink grant is received on the active BWP; or
   2> if a PDCCH addressed to C-RNTI or CS-RNTI indicating downlink assignment or uplink grant is received for the active BWP; or
   2> if a MAC PDU is transmitted in a configured uplink grant or received in a configured downlink assignment:
      3> if there is no ongoing Random Access procedure associated with this Serving Cell; or
      3> if the ongoing Random Access procedure associated with this Serving Cell is successfully completed upon reception of this PDCCH addressed to C-RNTI:
         4> start or restart the bwp-Inactivity Timer associated with the active DL BWP.
   2> if the bwp-Inactivity Timer associated with the active DL BWP expires:
      3> if the defaultDownlinkBWP-Id is configured:
         4> perform BWP switching to a BWP indicated by the defaultDownlinkBWP-Id.
      3> else:
         4> perform BWP switching to the initialDownlinkBWP.

If a Random Access procedure is initiated on an SCell, both this SCell and the SpCell are associated with this Random Access procedure.
1> if a PDCCH for BWP switching is received, and the MAC entity switches the active DL BWP:
   2> if the defaultDownlinkBWP-Id is configured, and the MAC entity switches to the DL BWP which is not indicated by the defaultDownlinkBWP-Id, or
   2> if the defaultDownlinkBWP-Id is not configured, and the MAC entity switches to the DL BWP which is not the initialDownlinkBWP:
      3> start or restart the bwp-InactivityTimer associated with the active DL BWP.

The MAC 920 includes a HARQ entity for each Serving Cell with configured uplink (including the case when it is configured with supplementaryUplink), which maintains a number of parallel HARQ processes. Each HARQ process supports one TB. Each HARQ process is associated with a HARQ process identifier. For UL transmission with UL grant in RA Response, HARQ process identifier 0 is used. When the MAC 920 entity is configured with pusch-AggregationFactor >1, the parameter pusch-AggregationFactor provides the number of transmissions of a TB within a bundle of the dynamic grant. After the initial transmission, pusch-AggregationFactor−1 HARQ retransmissions follow within a bundle. When the MAC 920 entity is configured with repK>1, the parameter repK provides the number of transmissions of a TB within a bundle of the configured uplink grant. After the initial transmission, HARQ retransmissions follow within a bundle. For both dynamic grant and configured uplink grant, bundling operation relies on the HARQ entity for invoking the same HARQ process for each transmission that is part of the same bundle. Within a bundle, HARQ retransmissions are triggered without waiting for feedback from previous transmission according to pusch-AggregationFactor for a dynamic grant and repK for a configured uplink grant, respectively. Each transmission within a bundle is a separate uplink grant after the initial uplink grant within a bundle is delivered to the HARQ entity. Each HARQ process is associated with a HARQ buffer. New transmissions are performed on the resource and with the MCS indicated on either PDCCH, Random Access Response, or RRC. Retransmissions are performed on the resource and, if provided, with the MCS indicated on PDCCH, or on the same resource and with the same MCS as was used for last made transmission attempt within a bundle.

Instance(s) of RLC 930 may process requests from and provide indications to an instance of PDCP 940 via one or more radio link control service access points (RLC-SAP) 935. These requests and indications communicated via RLC-SAP 935 may comprise one or more RLC channels. The RLC 930 may operate in a plurality of modes of operation, including: Transparent Mode (TM), Unacknowledged Mode (UM), and Acknowledged Mode (AM). The RLC 930 may execute transfer of upper layer protocol data units (PDUs), error correction through automatic repeat request (ARQ) for AM data transfers, and concatenation, segmentation and reassembly of RLC SDUs for UM and AM data transfers. The RLC 930 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 940 may process requests from and provide indications to instance(s) of RRC 955 and/or instance(s) of SDAP 947 via one or more packet data convergence protocol service access points (PDCP-SAP) 945. These requests and indications communicated via PDCP-SAP 945 may comprise one or more radio bearers. The PDCP 940 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

Instance(s) of SDAP 947 may process requests from and provide indications to one or more higher layer protocol entities via one or more SDAP-SAP 949. These requests and indications communicated via SDAP-SAP 949 may comprise one or more QoS flows. The SDAP 947 may map QoS flows to DRBs, and vice versa, and may also mark QFIs in DL and UL packets. A single SDAP entity 947 may be configured for an individual PDU session. In the UL direction, the NG-RAN 310 may control the mapping of QoS Flows to DRB(s) in two different ways, reflective mapping or explicit mapping. For reflective mapping, the SDAP 947 of a UE 301 may monitor the QFIs of the DL packets for each DRB, and may apply the same mapping for packets flowing in the UL direction. For a DRB, the SDAP 947 of the UE 301 may map the UL packets belonging to the QoS flows(s) corresponding to the QoS flow ID(s) and PDU session observed in the DL packets for that DRB. To enable reflective mapping, the NG-RAN 510 may mark DL packets over the Uu interface with a QoS flow ID. The explicit mapping may involve the RRC 955 configuring the SDAP 947 with an explicit QoS flow to DRB mapping rule, which may be stored and followed by the SDAP 947. In embodiments, the SDAP 947 may only be used in NR implementations and may not be used in LTE implementations.

The RRC 955 may configure, via one or more management service access points (M-SAP), aspects of one or more protocol layers, which may include one or more instances of PHY 910, MAC 920, RLC 930, PDCP 940 and SDAP 947. In embodiments, an instance of RRC 955 may process requests from and provide indications to one or more NAS entities 957 via one or more RRC-SAPs 956. The main services and functions of the RRC 955 may include broadcast of system information (e.g., included in MIBs or SIBs related to the NAS), broadcast of system information related to the access stratum (AS), paging, establishment, maintenance and release of an RRC connection between the UE 301 and RAN 310 (e.g., RRC connection paging, RRC connection establishment, RRC connection modification, and RRC connection release), establishment, configuration, maintenance and release of point to point Radio Bearers, security functions including key management, inter-RAT mobility, and measurement configuration for UE measurement reporting. The MIBs and SIBs may comprise one or more IEs, which may each comprise individual data fields or data structures.

The NAS 957 may form the highest stratum of the control plane between the UE 301 and the AMF 521. The NAS 957 may support the mobility of the UEs 301 and the session management procedures to establish and maintain IP connectivity between the UE 301 and a P-GW in LTE systems.

According to various embodiments, one or more protocol entities of arrangement 900 may be implemented in UEs 301, RAN nodes 311, AMF 521 in NR implementations or MME 421 in LTE implementations, UPF 502 in NR implementations or S-GW 422 and P-GW 423 in LTE implementations, or the like to be used for control plane or user plane communications protocol stack between the aforementioned devices. In such embodiments, one or more protocol entities that may be implemented in one or more of UE 301, gNB 311, AMF 521, etc. may communicate with a respective peer protocol entity that may be implemented in or on another device using the services of respective lower layer protocol entities to perform such communication. In some embodiments, a gNB-CU of the gNB 311 may host the RRC 955, SDAP 947, and PDCP 940 of the gNB that controls the operation of one or more gNB-DUs, and the gNB-DUs of the gNB 311 may each host the RLC 930, MAC 920, and PHY 910 of the gNB 311.

In a first example, a control plane protocol stack may comprise, in order from highest layer to lowest layer, NAS 957, RRC 955, PDCP 940, RLC 930, MAC 920, and PHY 910. In this example, upper layers 960 may be built on top of the NAS 957, which includes an IP layer 961, an SCTP 962, and an application layer signaling protocol (AP) 963.

In NR implementations, the AP 963 may be an NG application protocol layer (NGAP or NG-AP) 963 for the NG interface 313 defined between the NG-RAN node 311 and the AMF 521, or the AP 963 may be an Xn application protocol layer (XnAP or Xn-AP) 963 for the Xn interface 312 that is defined between two or more RAN nodes 311.

The NG-AP 963 may support the functions of the NG interface 313 and may comprise Elementary Procedures (EPs). An NG-AP EP may be a unit of interaction between the NG-RAN node 311 and the AMF 521. The NG-AP 963 services may comprise two groups: UE-associated services (e.g., services related to a UE 301) and non-UE-associated services (e.g., services related to the whole NG interface instance between the NG-RAN node 311 and AMF 521). These services may include functions including, but not limited to: a paging function for the sending of paging requests to NG-RAN nodes 311 involved in a particular paging area; a UE context management function for allowing the AMF 521 to establish, modify, and/or release a UE context in the AMF 521 and the NG-RAN node 311; a mobility function for UEs 301 in ECM-CONNECTED mode for intra-system HOs to support mobility within NG-RAN and inter-system HOs to support mobility from/to EPS systems; a NAS Signaling Transport function for transporting or rerouting NAS messages between UE 301 and AMF 521; a NAS node selection function for determining an association between the AMF 521 and the UE 301; NG interface management function(s) for setting up the NG interface and monitoring for errors over the NG interface; a warning message transmission function for providing means to transfer warning messages via NG interface or cancel ongoing broadcast of warning messages; a Configuration Transfer function for requesting and transferring of RAN configuration information (e.g., SON information, performance measurement (PM) data, etc.) between two RAN nodes 311 via CN 320; and/or other like functions.

The XnAP 963 may support the functions of the Xn interface 312 and may comprise XnAP basic mobility procedures and XnAP global procedures. The XnAP basic mobility procedures may comprise procedures used to handle UE mobility within the NG RAN 311 (or E-UTRAN 410), such as handover preparation and cancellation procedures, SN Status Transfer procedures, UE context retrieval and UE context release procedures, RAN paging procedures, dual connectivity related procedures, and the like. The XnAP global procedures may comprise procedures that are not related to a specific UE 301, such as Xn interface setup and reset procedures, NG-RAN update procedures, cell activation procedures, and the like.

In LTE implementations, the AP 963 may be an S1 Application Protocol layer (S1-AP) 963 for the S1 interface 313 defined between an E-UTRAN node 311 and an MME, or the AP 963 may be an X2 application protocol layer (X2AP or X2-AP) 963 for the X2 interface 312 that is defined between two or more E-UTRAN nodes 311.

The S1 Application Protocol layer (S1-AP) 963 may support the functions of the S1 interface, and similar to the NG-AP discussed previously, the S1-AP may comprise S1-AP EPs. An S1-AP EP may be a unit of interaction between the E-UTRAN node 311 and an MME 421 within an LTE CN 320. The S1-AP 963 services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The X2AP 963 may support the functions of the X2 interface 312 and may comprise X2AP basic mobility procedures and X2AP global procedures. The X2AP basic mobility procedures may comprise procedures used to handle UE mobility within the E-UTRAN 320, such as handover preparation and cancellation procedures, SN Status Transfer procedures, UE context retrieval and UE context release procedures, RAN paging procedures, dual connectivity related procedures, and the like. The X2AP global procedures may comprise procedures that are not related to a specific UE 301, such as X2 interface setup and reset procedures, load indication procedures, error indication procedures, cell activation procedures, and the like.

The SCTP layer (alternatively referred to as the SCTP/IP layer) 962 may provide guaranteed delivery of application layer messages (e.g., NGAP or XnAP messages in NR implementations, or S1-AP or X2AP messages in LTE implementations). The SCTP 962 may ensure reliable delivery of signaling messages between the RAN node 311 and the AMF 521/MME 421 based, in part, on the IP protocol, supported by the IP 961. The Internet Protocol layer (IP) 961 may be used to perform packet addressing and routing functionality. In some implementations the IP layer 961 may use point-to-point transmission to deliver and convey PDUs. In this regard, the RAN node 311 may comprise L2 and L1 layer communication links (e.g., wired or wireless) with the MME/AMF to exchange information.

In a second example, a user plane protocol stack may comprise, in order from highest layer to lowest layer, SDAP 947, PDCP 940, RLC 930, MAC 920, and PHY 910. The user plane protocol stack may be used for communication between the UE 301, the RAN node 311, and UPF 502 in NR implementations or an S-GW 422 and P-GW 423 in LTE implementations. In this example, upper layers 951 may be built on top of the SDAP 947, and may include a user datagram protocol (UDP) and IP security layer (UDP/IP) 952, a General Packet Radio Service (GPRS) Tunneling Protocol for the user plane layer (GTP-U) 953, and a User Plane PDU layer (UP PDU) 963.

The transport network layer 954 (also referred to as a “transport layer”) may be built on IP transport, and the GTP-U 953 may be used on top of the UDP/IP layer 952 (comprising a UDP layer and IP layer) to carry user plane PDUs (UP-PDUs). The IP layer (also referred to as the “Internet layer”) may be used to perform packet addressing and routing functionality. The IP layer may assign IP addresses to user data packets in any of IPv4, IPv6, or PPP formats, for example.

The GTP-U 953 may be used for carrying user data within the GPRS core network and between the radio access network and the core network. The user data transported can be packets in any of IPv4, IPv6, or PPP formats, for example. The UDP/IP 952 may provide checksums for data integrity, port numbers for addressing different functions at the source and destination, and encryption and authentication on the selected data flows. The RAN node 311 and the S-GW 422 may utilize an S1-U interface to exchange user plane data via a protocol stack comprising an L1 layer (e.g., PHY 910), an L2 layer (e.g., MAC 920, RLC 930, PDCP 940, and/or SDAP 947), the UDP/IP layer 952, and the GTP-U 953. The S-GW 422 and the P-GW 423 may utilize an S5/S8a interface to exchange user plane data via a protocol stack comprising an L1 layer, an L2 layer, the UDP/IP layer 952, and the GTP-U 953. As discussed previously, NAS protocols may support the mobility of the UE 301 and the session management procedures to establish and maintain IP connectivity between the UE 301 and the P-GW 423.

Moreover, although not shown by FIG. 9, an application layer may be present above the AP 963 and/or the transport network layer 954. The application layer may be a layer in which a user of the UE 301, RAN node 311, or other network element interacts with software applications being executed, for example, by application circuitry 605 or application circuitry 705, respectively. The application layer may also provide one or more interfaces for software applications to interact with communications systems of the UE 301 or RAN node 311, such as the baseband circuitry 810. In some implementations the IP layer and/or the application layer may provide the same or similar functionality as layers 5-7, or portions thereof, of the Open Systems Interconnection (OSI) model (e.g., OSI Layer 7—the application layer, OSI Layer 6—the presentation layer, and OSI Layer 5—the session layer).

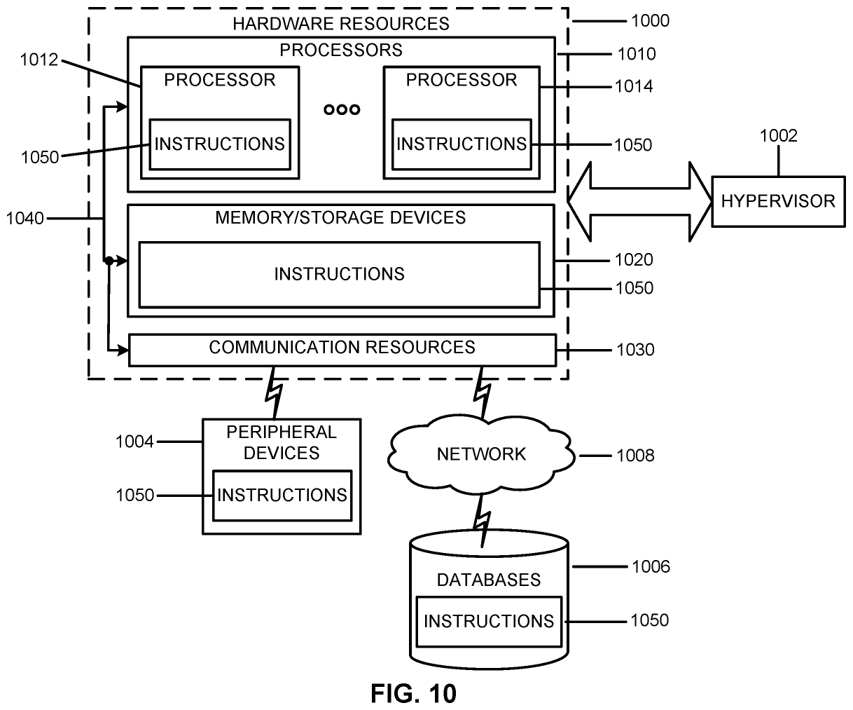

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processor(s) 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via USB), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

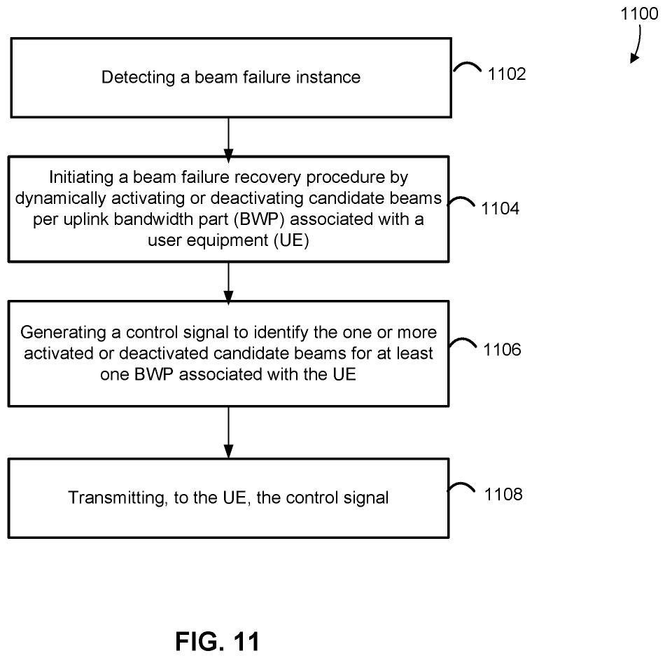

FIG. 11 illustrates a method 1100 for beam failure recovery (BFR) that can be performed by a base station or access point. According to some embodiments, method 1100 may include detecting a beam failure instance, as illustrated in step 1102. According to some aspects, method 1100 may further include initiating a beam failure recovery procedure by dynamically activating or deactivating candidate beams per uplink bandwidth part (BWP) associated with a user equipment (UE), as illustrated in step 1104.

According to some embodiments, method 1100 may further include generating a control signal to identify the one or more activated or deactivated candidate beams for at least one BWP associated with the UE, as illustrated in step 1106. Method 1100 may further include transmitting the control signal to the UE, as illustrated in step 1108.

According to other embodiments not illustrated in FIG. 11, method 1100 may further include identifying a media access control (MAC) protocol data unit (PDU) subheader with a new logical channel ID (LCID). Moreover, method 1100 may further include a control signal that is a media access (MAC) control element (CE).

According to some aspects, method 1100 may further include identifying, to the UE, a serving cell identification within the MAC CE for which the MAC CE applies. Moreover, according to some embodiments, method 1100 may further include identifying, to the UE, a BWP ID indicating an uplink (UL) BWP for which the MAC CE applies. According to some aspects, method 1100 may further include validating the set of activated candidate beams at predetermined slots in response to receiving a HARQ-ACK from the UE acknowledging the PDSCH carrying the MAC CE.

According to some embodiments, the control signal is a physical random access channel (PRACH) information element (IE). Accordingly, in some aspects, method 1100 may further include configuring, for each uplink BWP, a subset of cell-specific candidate beams by including indices of the candidate beams from an available set of candidate beams in a cell-specific uplink configuration message.

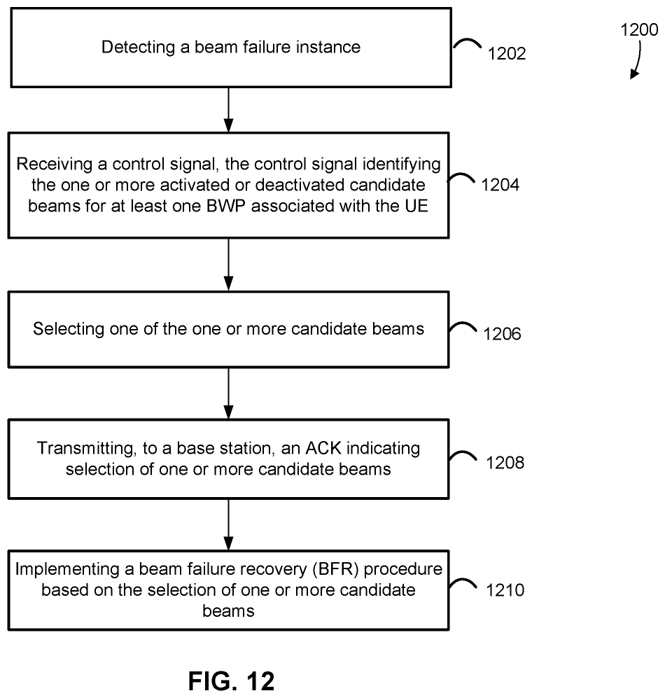

FIG. 12 illustrates a method 1200 for beam failure recovery (BFR) that can be performed by a UE. According to some embodiments, method 1200 may include detecting a beam failure instance, as illustrated in step 1202. According to some aspects, method 1200 may further include receiving a control signal, the control signal identifying the one or more activated or deactivated candidate beams for at least one BWP associated with the UE, as illustrated in step 1204. The method 1200 may further include selecting one or more of the candidate beams for beam failure recovery in step 1206. The method 1200 may further include transmitting, to a base station, an ACK indicating selection of one or more candidate beams in step 1208. The method may further include implementing a beam failure recovery (BFR) procedure based on the selection of the one or more candidate beams in step 1210.

The steps and/or functions in FIGS. 11-12 can be at least partially performed by one or more of application circuitry 605 or 705, baseband circuitry 610 or 710, and/or processors 1014.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 includes a PRACH resource configuration for BFR (PRACH-ResourceConfigBFR) that can be configured on a serving cell basis.

Example 2 includes the PRACH configuration of example 1 and/or some other examples herein, wherein the RRC configuration is as follows:

| | |
|---|---|
| UplinkConfig ::= | SEQUENCE { |

| | |
|---|---|
| initialUplinkBWP | BWP-UplinkDedicated OPTIONAL, -- Need M |

| | |
|---|---|
| uplinkBWP-ToReleaseList | SEQUENCE (SIZE (1..maxNrofBWPs)) OF BWP-Id |

OPTIONAL, -- Need N

| | |
|---|---|
| uplinkBWP-ToAddModList | SEQUENCE (SIZE (1..maxNrofBWPs)) OF BWP-Uplink |

| | |
|---|---|
| OPTIONAL, | -- Need N |

| | |
|---|---|
| firstActiveUplinkBWP-Id | BWP-Id OPTIONAL, -- Cond SyncAndCellAdd |

| | |
|---|---|
| pusch-ServingCellConfig | SetupRelease { PUSCH-ServingCellConfig } |

OPTIONAL, --

Need M

| | |
|---|---|
| carrierswitching | SetupRelease { SRS-CarrierSwitching } |

| | |
|---|---|
| OPTIONAL, | -- Need M |

| | |
|---|---|
| candidateBeamsBFR-ToAddModList | SEQUENCE SIZE(1..maxNrofCandidateBeamsPerServingCell)) |

OF PRACH-

| | |
|---|---|
| ResourceDedicatedBFR OPTIONAL, | -- Need N |

| | |
|---|---|
| candidateBeamsBFR-ToReleaseList | SEQUENCE SIZE(1..maxNrofCandidateBeamsPerServingCell)) |

OF INTEGER (1..

maxNrofCandidateBeamsPerServingCell)

OPTIONAL, --

Need N
...
}

| | |
|---|---|
| PRACH-ResourceDedicatedBFR ::= | SEQUENCE { |

| | |
|---|---|
| resourceId | INTEGER (1..maxNrofCandidateBeamsPerServingCell), |

| | |
|---|---|
| beamResourceBFR | CHOICE { |

| | |
|---|---|
| ssb | BFR-SSB-Resource, |

| | |
|---|---|
| csi-RS | BFR-CSIRS-Resource |

}

}

Example 3 includes the PRACH configuration of example 2 and/or some other examples herein, wherein the set of candidate beams for BFR, namely, candidateBeamsBFR-ToAddModList, shall be included in UplinkConfig configured per serving cell, ServingCellConfig.

Example 4 includes the PRACH configuration of example 2 and/or some other examples herein, wherein the parameter maxNrofCandidateBeamsPerServingCell defines a maximum number of candidate beams for BFR per serving cell, for example, it can be set to 128.

Example 5 includes the PRACH configuration of example 2 and/or some other examples herein, wherein the invalid candidate beams for BFR to be removed, which are identified by resourceId of each PRACH-ResourceDedicatedBFR, shall be added to the list candidateBeamsBFR-ToReleaseList.

Example 6 includes the PRACH configuration of example 2 and/or some other examples herein, wherein the resourceId of PRACH-ResourceDedicatedBFR shall be ordered uniquely over the whole serving cell.

Example 7 includes the PRACH configuration of examples 1-6 and/or some other examples herein, wherein all valid candidate beams for BFR are configured in a serving cell specific manner, wherein for each uplink BWP, the subset of cell-specific candidate beams is configured for BFR as follows

| | |
|---|---|
| BeamFailureRecoveryConfig ::= | SEQUENCE { |

...

candidateBeamRSList SEQUENCE (SIZE(1..maxNrofCandidateBeams)) OF

INTEGER

| | |
|---|---|
| (1..maxNrofCandidateBeamsPerServingCell) | OPTIONAL, |

-- Need M

...,

}

Example 8 includes the PRACH configuration of example 7 and/or some other examples herein, wherein the BeamFailureRecoveryConfig is configured per uplink BWP. Instead of being comprised of BFR beam RS resources, candidateBeamRSList is configured to include the indices of candidate beams from the set of candidate beams in cell-specific UplinkConfig.

Example 9 includes a MAC CE for dynamically activating and/or deactivating candidate beams for BFR per uplink BWP.

Example 10 includes the MAC CE of example 9 and/or some other examples herein, wherein the BFR candidate beam Activation/Deactivation for BWP-specific MAC CE is identified by a MAC PDU subheader with a new LCID.

Example 11 includes the MAC CE of examples 9-10 and/or some other examples herein, wherein the MAC CE includes a variable size comprising one or more fields from among:
a Serving Cell ID field to indicate an identity of the Serving Cell for which the MAC CE applies, wherein a length of the field is 5 bits;
a BWP ID field to indicate a UL BWP for which the MAC CE applies as the codepoint of the DCI bandwidth part indicator field, wherein a length of the BWP ID field is 2 bits;
a Tᵢ field to indicate if there is a PRACH-ResourceDedicatedBFR with resourceId i configured in candidateBeamsBFR-ToAddModList in UplinkConfig, this field indicates the activation/deactivation status of the PRACH-ResourceDedicatedBFR with resourceId i, otherwise MAC entity shall ignore the Tᵢ field, wherein the Tᵢ field is to be set to “1” to indicate that the PRACH-ResourceDedicatedBFR with resourceId i shall be activated, wherein the Tᵢ field is to be set to “0” to indicate that the PRACH-ResourceDedicatedBFR with resourceId i shall be deactivated, and wherein a maximum number of activated PRACH-ResourceDedicatedBFRs can be 16; and
an R field to include one or more reserved bits, which are to be set to “0”.

Example 12 includes the MAC CE of examples 9-11 and/or some other examples herein, wherein a network element can activate/deactivate the candidate beams for BFR of a UE in a particular BWP by sending the above MAC CE to the UE, wherein a new set of activated candidate beams becomes valid at x slots after UE sends HARQ-ACK back to network for acknowledging the PDSCH carrying the MAC CE.

Example 13 includes a method comprising:
receiving an RRC message including a PRACH resource configuration for BFR (PRACH-ResourceConfigBFR), the PRACH-ResourceConfigBFR to be configured on serving cell basis.

Example 14 includes the method of example 13 and/or some other examples herein, wherein the PRACH-ResourceConfigBFR to include a resource identifier parameter (resourceId) to include a value based on a maximum number of candidate beams per serving cell, a beam resource BFR parameter (beamResourceBFR) to indicate one of a BFR SSB resource or a BFR CSI-RS resource.

Example 15 includes the method of examples 13-14 and/or some other examples herein, wherein the method comprises identifying or causing to identify, in the RRC message, a set of candidate beams for BFR in a candidateBeamsBFR-ToAddModList IE, wherein the candidateBeamsBFR-ToAddModList IE is included in an UplinkConfig IE of the RRC message configured per serving cell, wherein each serving cell is configured via a ServingCellConfig IE in the RRC message.

Example 16 includes the method of examples 13-15 and/or some other examples herein, wherein the RRC message includes a maximum number of candidate beams per serving cell parameter (maxNrofCandidateBeamsPerServingCell), wherein the maxNrofCandidateBeamsPerServingCell defines a maximum number of candidate beams for BFR per serving cell

Example 17 includes the method of example 16 and/or some other examples herein, wherein the maxNrofCandidateBeamsPerServingCell can be set to a number from 1 to 128.

Example 18 includes the method of examples 13-17 and/or some other examples herein, wherein the method comprises identifying or causing to identify, in the RRC message, a set of invalid candidate beams for BFR to be removed in a candidateBeamsBFR-ToReleaseList IE, wherein the candidateBeamsBFR-ToReleaseList IE is to include a resourceId of each PRACH-ResourceDedicatedBFR to be removed.

Example 19 includes the method of examples 13-18 and/or some other examples herein, wherein the resourceId of PRACH-ResourceDedicatedBFR are ordered uniquely over the whole serving cell.

Example 20 includes the method of examples 13-19 and/or some other examples herein, wherein all valid candidate beams for BFR are configured in a serving cell specific manner via a beam failure recovery configuration (BeamFailureRecoveryConfig) IE in the RRC message, and wherein the method comprises: identifying or causing to identify, for each uplink BWP, a subset of cell-specific candidate beams in a candidate beam RS list (candidateBeamRSList) IE in the RRC message, wherein the candidateBeamRSList IE includes a value based on the maxNrofCandidateBeamsPerServingCell.

Example 21 includes the method of example 20 and/or some other examples herein, wherein a number of uplink BWP is indicated by a maximum number of candidate beams parameter (maxNrofCandidateBeams) in the RRC message.

Example 22 includes the PRACH configuration of examples 20-21 and/or some other examples herein, wherein the BeamFailureRecoveryConfig is configured per uplink BWP, and the candidateBeamRSList is configured to include indices of candidate beams from the set of candidate beams in cell-specific UplinkConfig.

Example 23 includes the method of examples 13-22 and/or some other examples herein, wherein the method comprises: receiving a ‘BFR candidate beam Activation/Deactivation for BWP-specific MAC CE’ over a PDSCH, the BFR candidate beam Activation/Deactivation for BWP-specific MAC CE is for dynamically activating and/or deactivating candidate beams for BFR per uplink BWP.

Example 24 includes the method of example 23 and/or some other examples herein, wherein the method comprises: determining or causing to determine that the received MAC CE is the BFR candidate beam Activation/Deactivation for BWP-specific MAC CE based on an LCID value in an LCID field of a MAC PDU subheader in the received MAC CE.

Example 25 includes the method of examples 23-24 and/or some other examples herein, wherein the BFR candidate beam Activation/Deactivation for BWP-specific MAC CE has a variable size and comprises one or more fields including:
a Serving Cell ID field to indicate an identity of the Serving Cell for which the MAC CE applies, wherein a length of the field is 5 bits;
a BWP ID field to indicate a UL BWP for which the MAC CE applies as the codepoint of the DCI bandwidth part indicator field, wherein a length of the BWP ID field is 2 bits;
a Tᵢ field to indicate if there is a PRACH-ResourceDedicatedBFR with resourceId i configured in candidateBeamsBFR-ToAddModList in the UplinkConfig, wherein this field indicates the activation/deactivation status of the PRACH-ResourceDedicatedBFR with resourceId i, otherwise MAC entity shall ignore the Tᵢ field, wherein the Tᵢ field is to be set to “1” to indicate that the PRACH-ResourceDedicatedBFR with resourceId i is to be activated, wherein the Tᵢ field is to be set to “0” to indicate that the PRACH-ResourceDedicatedBFR with resourceId i is to be deactivated; and
an R field to include one or more reserved bits, which are to be set to “0”.

Example 26 includes the method of example 25 and/or some other examples herein, wherein a maximum number of activated PRACH-ResourceDedicatedBFRs is 16.

Example 27 includes the method of examples 23-26 and/or some other examples herein, wherein the method comprises transmitting or causing to transmit HARQ-ACK feedback based on proper receipt and/or decoding of the received MAC CE, and wherein a new set of activated candidate beams indicated by the received MAC CE becomes valid at X slots after transmission of the HARQ-ACK feedback.

Example 28 includes the method of examples 13-27 and/or some other examples herein, wherein the method is to be performed by a user equipment (UE) or a radio access network (RAN) node.

Example 29 may include an apparatus comprising means to perform one or more elements of a method described in or related to any of examples 1-28, or any other method or process described herein.

Example 30 may include one or more non-transitory computer-readable media comprising instructions to cause an electronic device, upon execution of the instructions by one or more processors of the electronic device, to perform one or more elements of a method described in or related to any of examples 1-28, or any other method or process described herein.

Example 31 may include an apparatus comprising logic, modules, or circuitry to perform one or more elements of a method described in or related to any of examples 1-28, or any other method or process described herein.

Example 32 may include a method, technique, or process as described in or related to any of examples 1-28, or portions or parts thereof.

Example 33 may include an apparatus comprising: one or more processors and one or more computer-readable media comprising instructions that, when executed by the one or more processors, cause the one or more processors to perform the method, techniques, or process as described in or related to any of examples 1-28, or portions thereof.

Example 34 may include a signal as described in or related to any of examples 1-28, or portions or parts thereof.

Example 35 may include a frame, datagram, packet, PDU, and/or SDU as described in or related to any of examples 1-28, or portions or parts thereof.

Example 36 may include a method of communicating in a wireless network as shown and described herein.

Example 37 may include a system for providing wireless communication as shown and described herein.

Example 38 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

For the purposes of the present document, the following abbreviations may apply to the examples and embodiments discussed herein, but are not meant to be limiting.
3GPP Third Generation Partnership Project
4G Fourth Generation
5G Fifth Generation
5GC 5G Core network
ACK Acknowledgement
AF Application Function
AM Acknowledged Mode
AMBR Aggregate Maximum Bit Rate
AMF Access and Mobility Management Function
AN Access Network
ANR Automatic Neighbour Relation
AP Application Protocol, Antenna Port, Access Point
API Application Programming Interface
APN Access Point Name
ARP Allocation and Retention Priority
ARQ Automatic Repeat Request
AS Access Stratum
ASN.1 Abstract Syntax Notation One
AUSF Authentication Server Function
AWGN Additive White Gaussian Noise
BCH Broadcast Channel
BER Bit Error Ratio
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CFRA Contention Free Random Access
CG Cell Group
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICH Common Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator, CSI-RS Resource Indicator
C-RNTI Cell RNTI
CS Circuit Switched
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
ECCA extended clear channel assessment, extended CCA
ECCE Enhanced Control Channel Element, Enhanced CCE
ED Energy Detection
EDGE Enhanced Datarates for GSM Evolution (GSM Evolution)
EGMF Exposure Governance Management Function
EGPRS Enhanced GPRS
EIR Equipment Identity Register
eLAA enhanced Licensed Assisted Access, enhanced LAA
EM Element Manager
eMBB enhanced Mobile Broadband
eMBMS Evolved MBMS
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMA Frequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
G-RNTI GERAN Radio Network Temporary Identity
GERAN GSM EDGE RAN, GSM EDGE Radio Access Network
GGSN Gateway GPRS Support Node
GLONASS GLObal'naya NAvigatsionnaya Sputnikovaya Sistema (Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GSM Global System for Mobile Communications, Groupe Special Mobile
GTP GPRS Tunneling Protocol
GTP-U GPRS Tunnelling Protocol for User Plane
GUMMEI Globally Unique MME Identifier
GUTI Globally Unique Temporary UE Identity
HARQ Hybrid ARQ, Hybrid Automatic Repeat Request
HANDO, HO Handover
HFN HyperFrame Number
HHO Hard Handover
HLR Home Location Register
HN Home Network
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure (https is http/1.1 over SSL, i.e. port 443)
I-Block Information Block
ICCID Integrated Circuit Card Identification
ICIC Inter-Cell Interference Coordination
ID Identity, identifier
IDFT Inverse Discrete Fourier Transform
IE Information element
IEEE Institute of Electrical and Electronics Engineers
IEI Information Element Identifier
IEIDL Information Element Identifier Data Length
IETF Internet Engineering Task Force
IF Infrastructure
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
K Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LBT Listen Before Talk
LCM LifeCycle Management
LCR Low Chip Rate
LCS Location Services
LI Layer Indicator
LLC Logical Link Control, Low Layer Compatibility
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement (TSG T WG3 context)
MAC-I MAC used for data integrity of signalling messages (TSG T WG3 context)
MANO Management and Orchestration
MBMS Multimedia Broadcast and Multicast Service
MBSFN Multimedia Broadcast multicast service Single Frequency Network
MCC Mobile Country Code
MCG Master Cell Group
MCOT Maximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information, MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTC massive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non-Access Stratum layer
NCT Network Connectivity Topology
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAI Network Slice Selection Assistance Information
S-NNSAI Single-NSSAI
NSSF Network Slice Selection Function
NW Network
NWUS Narrowband wake-up signal, Narrowband WUS
NZP Non-Zero Power
O&M Operation and Maintenance
ODU2 Optical channel Data Unit—type 2
OFDM Orthogonal Frequency Division Multiplexing
OFDMA Orthogonal Frequency Division Multiple Access
OOB Out-of-band
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol, Packet Data Convergence
Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quaternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol, Service Data Adaptation Protocol layer
SDL Supplementary Downlink
SDNF Structured Data Storage Network Function
SDP Service Discovery Protocol (Bluetooth related)
SDSF Structured Data Storage Function
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB Secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
[0823]1 SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTI Semi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block, SS/PBCH Block
SSBRI SS/PBCH Block Resource Indicator, Synchronization Signal Block Resource Indicator
SSC Session and Service Continuity
SS-RSRP Synchronization Signal based Reference Signal Received Power
SS-RSRQ Synchronization Signal based Reference Signal Received Quality
SS-SINR Synchronization Signal based Signal to Noise and Interference Ratio
SSS Secondary Synchronization Signal
SST Slice/Service Types
SU-MIMO Single User MIMO
SUL Supplementary Uplink
TA Timing Advance, Tracking Area
TAC Tracking Area Code
TAG Timing Advance Group
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
UDSF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over-Internet Protocol
VPLMN Visited Public Land Mobile Network
VPN Virtual Private Network
VRB Virtual Resource Block
WiMAX Worldwide Interoperability for Microwave Access
WLAN Wireless Local Area Network
WMAN Wireless Metropolitan Area Network
WPAN Wireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein, but are not meant to be limiting.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA.

The term “Special Cell” refers to the PCell of the MCG or the PSCell of the SCG for DC operation; otherwise, the term “Special Cell” refers to the Pcell.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1. A method for beam failure recovery (BFR), the method comprising:
detecting a beam failure instance;
initiating a beam failure recovery procedure by activating or deactivating candidate beams for at least one uplink bandwidth part (BWP) associated with a user equipment (UE);
generating a control signal to identify the one or more activated or deactivated candidate beams for the at least one BWP associated with the UE; and
transmitting the control signal to the UE.

2. The method of claim 1, wherein the control signal is a media access (MAC) control element (CE).

3. The method of claim 2, wherein the one or more activated or deactivated candidate beams are identified in a media access control (MAC) protocol data unit (PDU) subheader with a new logical channel ID (LCID) in the MAC CE.

4. The method of claim 2, further comprising:
identifying, to the UE, a serving cell identification within the MAC CE for which the MAC CE applies.

5. The method of claim 2, further comprising:
identifying, to the UE, a BWP ID indicating the at least one uplink BWP for which the MAC CE applies.

6. The method of claim 2, further comprising:
validating the set of activated candidate beams at predetermined slots in response to receiving a hybrid automatic repeat request acknowledgement (HARQ-ACK) from the UE acknowledging a physical downlink shared channel (PDSCH) signal carrying the MAC CE.

7. The method of claim 1, wherein the control signal is a physical random access channel (PRACH) information element (IE).

8. The method of claim 7, further comprising:
configuring, for at least one uplink BWP, a subset of cell-specific candidate beams by including indices associated with the subset of candidate beams in a cell-specific uplink configuration message.

9. An apparatus for beam failure recovery (BFR), the apparatus comprising:
radio front end circuitry; and
processor circuitry coupled to the radio front end circuitry and configured to:
detect a beam failure instance,
initiate a beam failure recovery procedure by activating or deactivating candidate beams for at least one uplink bandwidth part (BWP) associated with a user equipment (UE),
generate a control signal to identify the one or more activated or deactivated candidate beams for the at least one BWP associated with the UE, and
transmit, using the radio front end circuitry, the control signal to the UE.

10. The apparatus of claim 9, wherein the control signal is a media access (MAC) control element (CE).

11. The apparatus of claim 10, wherein the processor circuitry is further configured to:
identify the one or more activated or deactivated candidate beams in a media access control (MAC) protocol data unit (PDU) subheader with a new logical channel ID (LCID) in the MAC CE.

12. The apparatus of claim 10, wherein the processor circuitry is further configured to:
identify, to the UE, a serving cell identification within the MAC CE for which the MAC CE applies.

13. The apparatus of claim 10, wherein the processor circuitry is further configured to:
identify, to the UE, a BWP ID indicating the at least one uplink BWP for which the MAC CE applies.

14. The apparatus of claim 10, wherein the processor circuitry is further configured to:
validate the set of activated candidate beams at predetermined slots in response to receiving a hybrid automatic repeat request acknowledgement (HARQ-ACK) from the UE acknowledging a physical downlink shared channel PDSCH signal carrying the MAC CE.

15. The apparatus of claim 9, wherein the control signal is a physical random access channel (PRACH) information element (IE).

16. The apparatus of claim 15, wherein the processor circuitry is further configured to:
configure, for the at least one uplink BWP, a subset of cell-specific candidate beams by including indices of the candidate beams in a cell-specific uplink configuration message.

17. A non-transitory computer-readable medium comprising instructions to cause an apparatus, upon execution of the instructions by one or more processors of the apparatus, to perform one or more operations, the operations comprising:
detecting a beam failure instance;
initiating a beam failure recovery procedure by activating or deactivating candidate beams for at least one uplink bandwidth part (BWP) associated with a user equipment (UE);
generating a control signal to identify the one or more activated or deactivated candidate beams for the at least one BWP associated with the UE; and
transmitting the control signal to the UE.

18. The non-transitory computer-readable medium of claim 17, wherein the control signal is a media access (MAC) control element (CE).

19. The non-transitory computer-readable medium of claim 18, the operations further comprising:
identifying the one or more candidate beams in a media access control (MAC) protocol data unit (PDU) subheader with a new logical channel ID (LCID) in the MAC CE.

20. The non-transitory computer-readable medium of claim 18, the operations further comprising:
identifying, to the UE, a serving cell identification within the MAC CE for which the MAC CE applies.
